(19) United States
(12) Patent Application Publication
(10) Pub. No.: US 2013/0338995 A1
(43) Pub. Date: Dec. 19, 2013

(54) PRACTICAL NATURAL-LANGUAGE HUMAN-MACHINE INTERFACES

(71) Applicant: Grant Street Group, Inc., Pittsburgh, PA (US)

(72) Inventors: Tim ELKINS, Fitzwilliam, NH (US); Mike SPARKS, Forest Hills, PA (US); Michael HENDRICKS, Hanna, WY (US); Rob KINYON, Dublin, OH (US); Myles C.S. HARRINGTON, Pittsburgh, PA (US); Jonathan RUBIN, Pittsburgh, PA (US)

(21) Appl. No.: 13/916,356

(22) Filed: Jun. 12, 2013

Related U.S. Application Data
(60) Provisional application No. 61/658,821, filed on Jun. 12, 2012.

(51) Int. Cl. G06F 17/28

(52) U.S. Cl. CPC G06F 17/28
USPC 704/2

(57) ABSTRACT

A computer-mediated method for automating software user activity comprises receiving an instruction having at least one predefined vernacular command that is derived from a popular human language; translating the predefined vernacular command into at least one corresponding programming command for controlling software; executing the at least one programming command; and receiving results associated with the executed programming command.

### CROSS-REFERENCE TO RELATED APPLICATIONS

This application claims the benefit of Provisional Application No. 61/658,821 filed Jun. 12, 2012, incorporated herein by reference.

### STATEMENT REGARDING FEDERALLY SPONSORED RESEARCH OR DEVELOPMENT

None

### FIELD

This technology relates to computing device interface design, and more particularly to interfaces that permit humans to interact and interface with computing and automation systems using natural languages. Still more particularly, the technology herein relates to automating interaction with web-based and other applications to provide input, testing and/or performance tools; and to interpreters, parsers and the like for interpreting natural language inputs for use in interacting with, testing, and/or automating computer interfaces.

### BACKGROUND AND SUMMARY

Whether a device is a highly useful and helpful tool or a difficult obstacle may depend on how easy it is for a human to interact with it. Devices that provide highly intuitive natural user interfaces are, generally speaking, much more useful than ones that do not. This applies to every sort of device from power tools to microwave ovens, television sets to automobiles, writing instruments to refrigerators. It applies especially to computers and computing systems because computers are complex and often cannot resolve ambiguity but instead require a high degree of certainty in the instructions they receive and process.

Despite many decades of effort, many or most non-technical people continue to find language-based computer interactions a challenge. In the early days of computing, many or most interactions with computers required the user to write instructions in specialized artificial “machine” or other highly constrained artificial programming languages the computers could interpret. This required human “programmers” to learn how to write program statements computers could understand. While such highly trained programmers could create sophisticated computer software in this fashion, most people could not. For this reason, graphical user interfaces (“GUIs”) have largely replaced the so-called “command line” interface of previous generations of computing systems. It is not an understatement to say that graphical user interfaces have brought computer interaction to millions of everyday people all around the world.

Generally speaking, a graphical user interface offers the ability to control a computing device through user manipulation of displayed virtual objects. For example, it is possible using a mouse or other pointing device to position a cursor on a displayed icon, symbol or virtual “button” and then command the computer to perform an action. Similarly, a user can “touch” a graphical object displayed on a touch screen display to activate a desired computing function, and can provide gestures or movements to provide further or different control. Because of their ease of use, such graphical user interfaces are now ubiquitous. Smartphones and other portable computing devices carried by millions of people worldwide provide touch-input based and other graphical user interfaces. Similarly, web-based applications accessible over many networks including the Internet rely on graphical user interfaces to facilitate user interaction through browsers and other means. Most users find these types of graphical user interfaces to be more intuitive and easier to use than inputting a set of text commands such as for example:

perl run_test.pl—product=Google—os=“Windows XP”—browser=“Firefox-latest”—output=“results/google-tests-20120611.html” tests/Google/search.txt tests/Google/pages.txt
or
   searchPanel.setLayout(null);
   helpcontentsTabbedpane.addTab(“Search”, searchPanel);

Despite the overwhelming success of graphical user interfaces, there continues to be a need for language- or text-based computer interaction. Some information (e.g., your name and address) is more conveniently conveyed with text. Additionally, those who write software code underlying what makes computers do what they do still typically need to be familiar with one or more specialized artificial programming languages computers (i.e., its compiler or interpreter) understands. Such computer programmers write computer programs, i.e., sets of instructions in some computer language intended to be executed on a computer to perform some task. Such computer programs typically include not just individual instructions but also flow or sequencing control that determines (sometimes conditionally) which instructions are to be executed in what order and with what data. Artificial programming languages including for example C, Perl, Java, Python, BASIC and many others are used by such software developers to communicate sets or sequences of instructions to the computer and thereby provide specifications of computations and/or algorithms. Software developers can write software in such artificial languages to precisely control sequences of tasks and computations of arbitrary complexity the computer will perform. While writing code in an artificial language offers powerful opportunities to control the computer, it is well beyond the skill and knowledge of most computer users.

Since the dawn of the computing age, people have dreamed of instructing and interacting with computers using a natural language such as vernacular English. While much work has been done in the area of Natural Language Programming, most experts believe we are still decades away from the first “thinking” machines that can pass Alan Turing's test of being mistaken for a human in a natural language interaction. Natural language could be extremely useful in automating interaction with a graphical or other user interface for a variety of purposes including but not limited to testing of web-based and other applications.

As one non-limiting example, testing and other automated functionality may need to direct or instruct a computer to automatically perform a particular precise interaction or sequence of interactions. Take for example a website design. While it is possible to manually test its functionality by providing manual inputs, more complex websites exhibit a wide range of potential behaviors responsive to user input sequences that may be very time-consuming to test. Additionally, it may be useful to repetitively automatically interact with web-based applications for testing or other purposes. Automated testing software and systems for web-based applications is now readily available. One example such software that automates web browsers is the Selenium web application tool suite available at seleniumhq.org. See Selenium Documentation Release 1.0 (Jun. 8, 2012), incorporated herein by reference. See also Selenium IDE version 2.0, Selenium Server version 2.33.0, The Internet Explorer Driver Server version 2.33.0, the Selenium Client & WebDriver Language Bindings for Java, C#, Ruby and Python, and other Selenium documentation all incorporated herein by reference.

As stated in that documentation, many, perhaps most, software applications today are written as web-based applications to be run in a web browser. The effectiveness of testing these applications varies widely among companies and organizations. In an era of highly interactive and responsive software processes, test automation is frequently becoming a requirement for software projects. Test automation means using a software tool to run repeatable tests against the application to be tested. Test automation provides responsiveness for regression testing. There are many advantages to test automation related for example to the repeatability of the tests and the speed at which the tests can be executed.

While web application and other automation is in general known, it would be highly advantageous to be able to perform such user interface automation based on a specification that is written in vernacular, plain natural language so that users not skilled in computer programming can participate.

One aspect of the example non-limiting implementation is intended to create a publicly available or other automation and/or testing application that allows anyone to develop scripts, programs and other specifications that enable automatic interaction with their own, or other application(s) by writing in their own vernacular, executing against their own, or other application(s), and receiving feedback (e.g., including but not limited to detailed reports) pertaining to the results. Example desired non-limiting features include:

| | | |
|---|---|---|
| Easy to Understand | Open API | Playlists |
| Plain English tests | Developers can run | . . . like for music, but |
| produce Plain English | their tests from the | for your tests. Playlists |
| results (plus | command line using | also let you structure |
| screenshots). | our open API. | test cases around |
| | | requirements. |
| Schedules | Test Organization | User Management |
| Schedule your tests to | Sort your tests into | Create roles with |
| run automatically and | projects, then organize | different permissions to |
| receive notifications | them further with | give each user a |
| about the results. | groups and tags. | customized Tellurium |
| | | experience. |
| Your Lingo | Simple Sharing | Variations |
| Create your own | Share your results with | Be flexible. Write one |
| custom phrases using | anyone (even non- | test that can run on |
| one or more Plain | Tellurium users). | multiple sites using |
| English commands. | Acceptance testing has | multiple test users. |
| | never been easier. | |

The example non-limiting embodiment allows anyone, regardless of development experience, to write advanced programs including but not limited to automations and tests against their own, or other application(s) and quickly understand the results.

FIGS. 1A-1B show an example non-limiting embodiment or implementation of the technology herein. In the non-limiting example shown, a woman uses a keyboard to input a vernacular plain language command “Log me in” into her computer, and a man speaks a vernacular plain language command “Check My Account” into the microphone of his smart phone or other device. These vernacular sentences or sentence fragments are looked up in a library of automation commands, which produces a computer-readable representation of one or a sequence of computer commands (e.g., a computer program). This computer-readable representation is presented to an automation system (represented here by gears but in one non-limiting example implementation actually another computing element such as a server) which executes the computer-readable representation to automate interface with an application (represented by the computer at the bottom of the page). As shown in FIG. 1B, the application returns a response which may be transformed by a transform computing block for presentation to the users in the form of plain vernacular feedback, status or other information or indication. For example, in this case, the feedback is in the form of giving the woman the message “You are logged in”, and providing an account status summary screen to the man who wanted to check his account.

One application that the example non-limiting embodiment is designed for is web-based applications (e.g., those that exist inside a browser). Beyond that, the non-limiting embodiment may have extended capabilities so it can automatically interact with (for example to test) mobile applications (e.g., iOS and Android as two non-limiting examples), and desktop applications (e.g. PDF, Microsoft Excel, Microsoft Word, etc.), for use of a desktop, handheld, distributed, or any other computing platform.

Additional non-limiting features and advantages include:
Command Matching: Automation programs may consist of or comprise a noun and a command. The nouns are the objects on the page (buttons, links, text, etc.), and the command describes what you want to do with those nouns (click them; confirm they're present, etc.). For example, assume a “Click the Submit link” statement. When it is time to run the automation, the system can look for the equivalent phrase and noun. So in this case, the system would see the “Click the” phrase and find its equivalent command in a command library in the system. A library provides a structure, and any command in one example non-limiting arrangement conforms to this structure in the library. The non-limiting library may be finite as opposed to infinite, but is also extensible and can be added to by the end user.

Similarly, the system would see the “Submit link” noun and find the equivalent command for identifying and locating nouns in the command library of the system. It is also possible to combine two or more actions into a single command. For example, “When the test user is logged in” can be equivalent to “When the Username field is ‘username’,” “When the Password field is ‘password’,” and “When the ‘Login’ button is clicked.”
Noun Matching: Noun matching includes matching elements based on their relative position, with ordinals (first, second, third, . . . last, e.g. “Click the first report link” or “Click the last Save button”) and position clauses (after, before or in another element, e.g., “in the Account History table” or “after the Modify Account link”). This feature illustrates that the system has the ability to distinguish ordinals and to confirm that specific text appears in a specific place on a web page or other user interface.
Producing Screenshots with Plain English Commands: The example non-limiting system has the ability to save screenshots of every step that is performed when automations are run. Plain English (or other natural language, e.g., German, French, Portuguese, Spanish, etc.) commands are fed into a system, so that the system will generate screenshots. This functionality is useful for anyone using plain language automation or testing. Additionally, this functionality is suitable for applications outside of testing in which the user desires to capture screenshots and document how the screenshots were created. See FIG. 17 showing how a plain English command such as “Go to grantstreet.com image; Click the About Us tab image; The About Us page will appear image” controls the system to capture three screen shots of a website.
Producing Videos with Plain English Commands: Another non-limiting embodiment of the system has the ability to create recordings of the actions that the system is performing. Preferably, the recordings including but not limited to videos are based on plain English commands, but can be based or other natural language commands. This technology is suitable for testing or any other purpose, including any application in which the user desires to make a quick recording using plain English or other natural language commands. For example, FIG. 18 shows how plain vernacular commands such as “Go to grantstreet.com; click the About Us tab; The About Us page will appear” can be used to generate a video of website navigation.
Providing Plain English Application Feedback: Another non-limiting embodiment of the system provides users feedback about the application (i.e., test results) in plain English or other natural language. The fact that the “plain English” is written in a familiar jargon that the user easily understands makes this functionality especially beneficial. See for example FIG. 19 which shows providing example non-limiting plain vernacular application feedback such as “Go to grantstreet.com PASSED; Click the About Us tab PASSED; The About Us page will Appear FAILED The About Us page does not appear”.
Creating Demos with Plain English Commands: Another non-limiting embodiment of the system has the ability to create demos of an application based on the plain English commands. The example non-limiting system runs the plain English commands and creates screenshots of each command step being performed. The commands and the screenshots are then displayed side-by-side so that a new user can click through each plain English command and view the resulting screenshot. In one example non-limiting implementation, since the automations contain the most up to date specifications for an application, a user has the ability to create up to date demos of the application quickly. See FIG. 20 which shows how the user can follow the plain vernacular Commands in the demo and view visual representations of the steps at the same time to view demos with plain vernacular commands.
Browser-in-Browser recording: Another non-limiting embodiment of the system has the ability to record browser actions from within another browser window. For example:

Have someone come to the system's website

Access a second website of interest from within the system's website

Have the system's website record the actions that they are performing with respect to the second website.

This would keep the core of the example non-limiting system as a hosted solution, since one could record tests or other interactions in any browser, regardless of whether extensions have been installed on it or not. See for example FIG. 20A which shows how Website B is accessed from within Website A. As a user performs tasks in Website B, the tasks are logged in Website A.
Converting Standard Tools to Vernacular or “Plain English”: A tool with substantial utility converts tests and other automations written for standard automation tools such as Selenium into “Plain English”. That means that the standard tool provides users with the ability to upload their existing programs, scripts, tests and other automations (or shared tests or other automations created by others) and have them translated automatically without having to recreate the originals.
Remembering Data and Reusing it later: Another non-limiting embodiment of the system does not require users to provide test or other data. Instead, the system saves data that is acquired while running the tests or other automations and reuses it later in either the same test or automation or in another test or automation.

Additional non-limiting features include:
The example non-limiting embodiment as a universal automation, testing and other interaction application that can be used by various groups within an organization (developers, system administrators, QAs, business analysts etc.).
A user-friendly set of interface techniques that can quickly gain a large community of users, wide acceptance and a high degree of usability.

Universal Application

Since two of the example non-limiting embodiment's primary benefits are its ease of use and its ability to share tests/phrases/results, it should be easy for all departments within an organization to collaborate with each other.
Developers

Developers will often prefer to write/run tests or other automations from the command line. That is where they do the bulk of their work. Requiring that they login to a web or other user interface (UI) every time they want to write/run a test or other automation may discourage them from doing so. By using a command line, developers can integrate plain English tests into other processes. The example non-limiting embodiments make it easier for developers and non-developers to collaborate, not harder.
System Administrators

System Administrators can write/run tests or other automations either from the command line or from the Web UI.

Such teams can control how the example non-limiting embodiment connects to their internal application(s). If there is a company or an industry that is very conscious of security, using an external server to access internal applications should account for security requirements:

The system can run tests or other automations using a virtual server.

The system can run tests or other automations on a carefully selected third party server.

The system can provide a method for users to run all tests or other automations locally within a user's own network.
Quality Assurance teams:

want to write/run/manage tests or other automations via the Web UI.

any tests or other automations that are written by the QA teams in the Web UI may be accessible to the developers so they can run them from the command line (and vice versa) (see FIG. 10).
Business Analysts and the general public

want to write/run/manage tests or other automations via the Web UI.

Based on the generalizations above, in order to have a universal application the example non-limiting embodiment may include:
A command line tool or product
A web UI tool or product (that can connect with the command line tool or product through the application programming interface or “API” or directly)
A way for potential users to either run their tests locally, or in another “secure” method that does not involve running tests in the “cloud”.
Can be used by developers (at the command line) and non-developers (using the web UI).

Example non-limiting systems can be used to automate software or to produce an automation or test for the software. Thus for example, the same plain language specification can be used in multiple contexts, e.g., to define a test suite for software developers and also to permit quality assurance personnel to run additional tests or other automations. Thus, the example non-limiting system can be used by a non-programmer to write the specs for an application, which can be used by a developer to write the source code for the application and which can be used to test or otherwise automate the application the programmer has developed.

Example automation including but not limited to testing can encompass a wide variety of activities including for example operating, determining the format, look and feel, spelling or other appearance-oriented aspects of a web page, web application or other user interface. As one example, one non-limiting implementation can verify the look and feel of a website for example by determining information concerning fonts used, positioning of graphical objects in terms of coordinates, spelling, and a variety of other parameters.

Example non-limiting systems can distinguish between nouns, e.g., “Click the Search Button” vs. “Click the Blue Radio Button”. In one example non-limiting implementation, it is possible to put almost anything in quotes, and the system can automatically distinguish the nouns and/or modifiers.

An example non-limiting system may but does not have to select the data to be tested within an application, it can be selected at random by the test or other automation (e.g., picking an account to run the test or other automation against within an application). For example, it is possible to save data that is encountered while running the tests and reuse it later in either the same test or another test. Additionally, in one non-limiting example, it is possible to tell the testing or automation application certain pieces of information (e.g., account number etc.). Then, when the tests or other automations are run, the example non-limiting system automatically selects and inputs the account on its own without the user having to further or explicitly specify it.

Another example non-limiting feature provides the ability to share test results with users who do not have full access to the system used to generate the testing/automation scripts. This lets people share results with clients, co-workers, compliance officers, or the community, and people in each of these groups do not need to log in to view the results.

Other application for the technology herein includes non-user interface automation such as database accesses, backend computing accesses or the like.

Automations may be run or executed either remotely or locally. It would for example be useful to have the user's browser update as a test or automation is performed. In one example implementation, a browser extension can receive real time testing or automation instructions to be performed by the local browser. This allows the automation to be driven from a remote server API to keep a local browser extension thin while nevertheless allowing the user to see the results of a remotely-executed automation in real time. The test or automation can be run locally or in the cloud. A test or automation script in vernacular can be run anywhere, so it could be run locally, remotely, or a combination. Local automated execution is very useful for debugging, and may also be useful to resolve security issues such as firewalls, corporate policies, etc. However, it is also advantageous to be able to run remotely in the cloud or making use of other resources. Such flexibility to run either remotely or locally while still providing local web browser based updates can be advantageous.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is an example non-limiting architectural block diagram;

FIGS. 1A-1B show an example non-limiting high level process;

FIGS. 2-5 show example non-limiting features for phrase shortcuts, command libraries, group sharing and phrase sharing;

FIGS. 6-8 show example text to Command conversion;

FIG. 9 shows an example non-limiting process;

FIG. 10 shows how example non-limiting groups can access in different ways;

FIG. 11 shows an example non-limiting application programming interface diagram;

FIG. 12 shows example non-limiting application programming interface functions;

FIG. 13 shows an example non-limiting web application example with a displayed in-browser automation design tool;

FIG. 14 shows example non-limiting automation collections;

FIG. 15 shows a further application programming interface example;

FIG. 16 shows example non-limiting command grammar/syntax;

FIG. 17 shows an example non-limiting screenshot capture process;

FIG. 18 shows an example non-limiting video capture process;

FIG. 19 shows example plain vernacular application feedback;

FIG. 20 shows example non-limiting viewing demonstrations with plain vernacular commands;

FIG. 20A shows example non-limiting browser-in-browser recording;

FIGS. 21-25 show example non-limiting flowcharts;

FIGS. 26A-26L show example screen shots of non-limiting user interface screens;

FIG. 27A is an example non-limiting screenshot of an automation, the running of the automation, and the results from the API;

FIG. 27B is an example non-limiting screenshot of the same automation on an internal application (website);

FIG. 27C is an example non-limiting screenshot of the same automation being added to the runner (on the right side of the page, in the “Queue” section);

FIG. 27D is an example non-limiting screenshot of some of the options when running an automation, permitting a user to choose to set a time delay for each step in the automation, and save screenshots (both of which are selected in the screenshot);

FIG. 27E is an example non-limiting screenshot of the automation in progress (the bar indicates how far along the test is);

FIG. 27F is an example non-limiting screenshot showing that the automation has finished with a pass rating of 100% (everything worked as expected);

FIG. 27G is an example non-limiting screenshot of the results of the automation. Next to each step in the process is a link (step-00x). If you click the link, it opens a screenshot that was taken during that step in the process;

FIG. 27H is an example screenshot. Notice the top of the image lists what step in the automation generated the image (in this case “Step 0001”);

FIG. 27I is an example additional screenshot taken at Step 0003 in the automation;

FIG. 27J is an example additional screenshot taken at Step 0007 in the automation; and

FIGS. 28A-28T are an additional non-limiting set of UI pages for an automation user interface.

### DETAILED DESCRIPTION OF EXAMPLE NON-LIMITING EMBODIMENTS

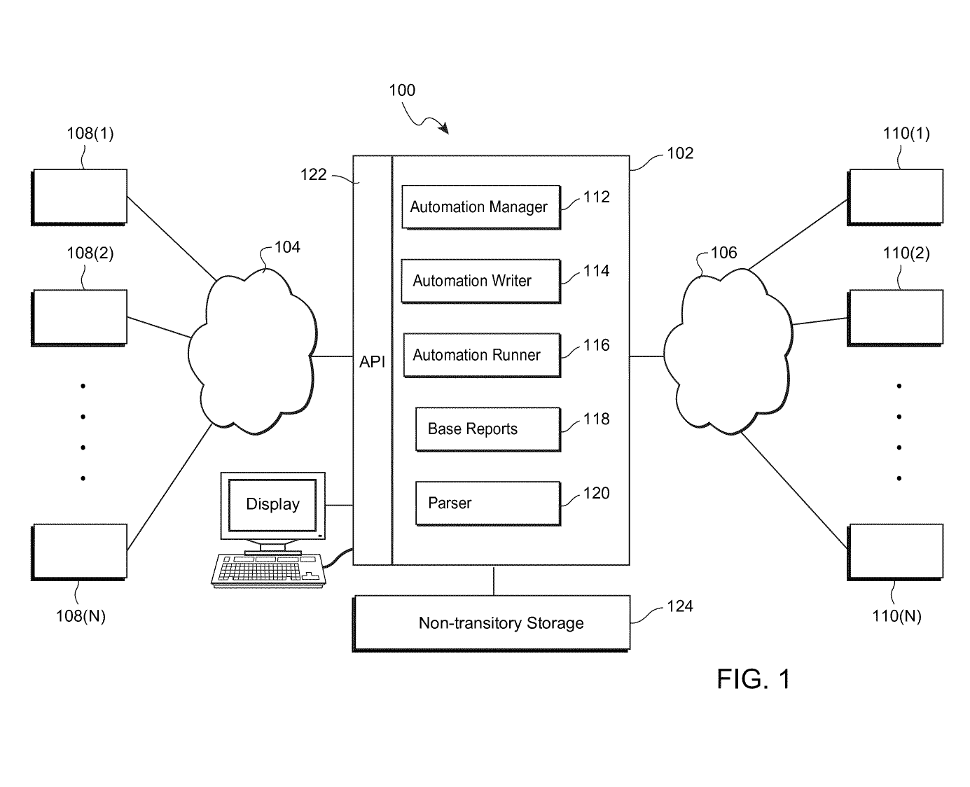

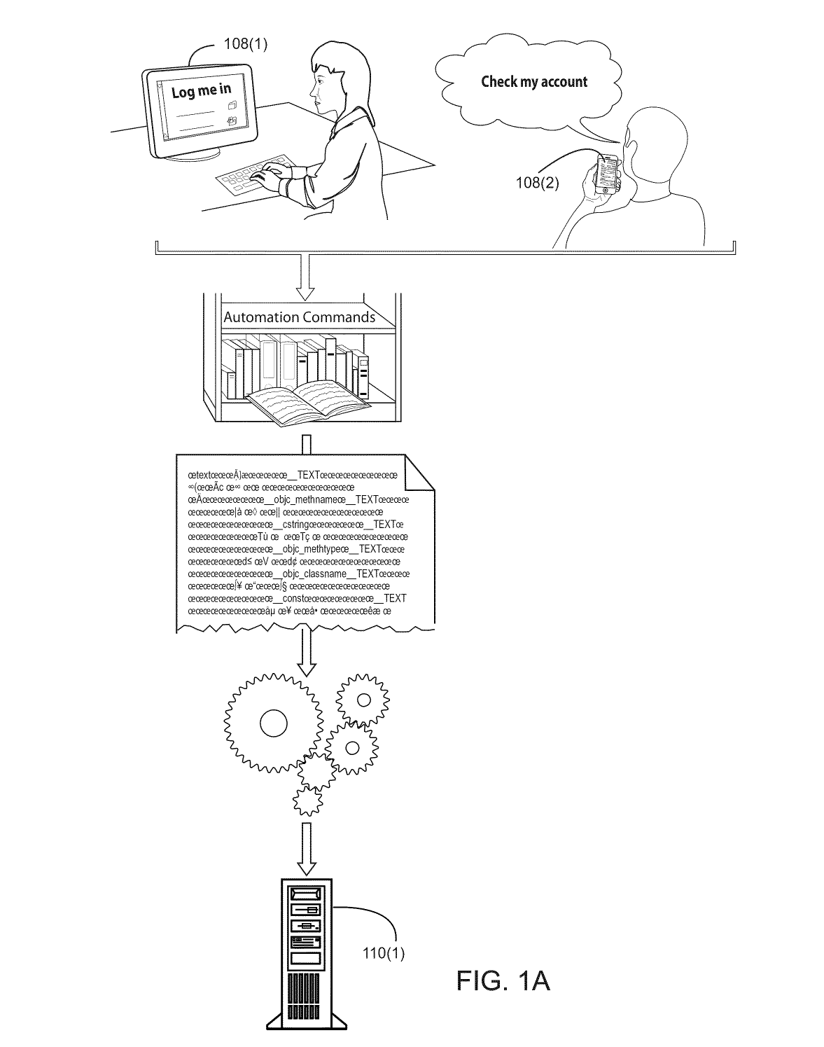

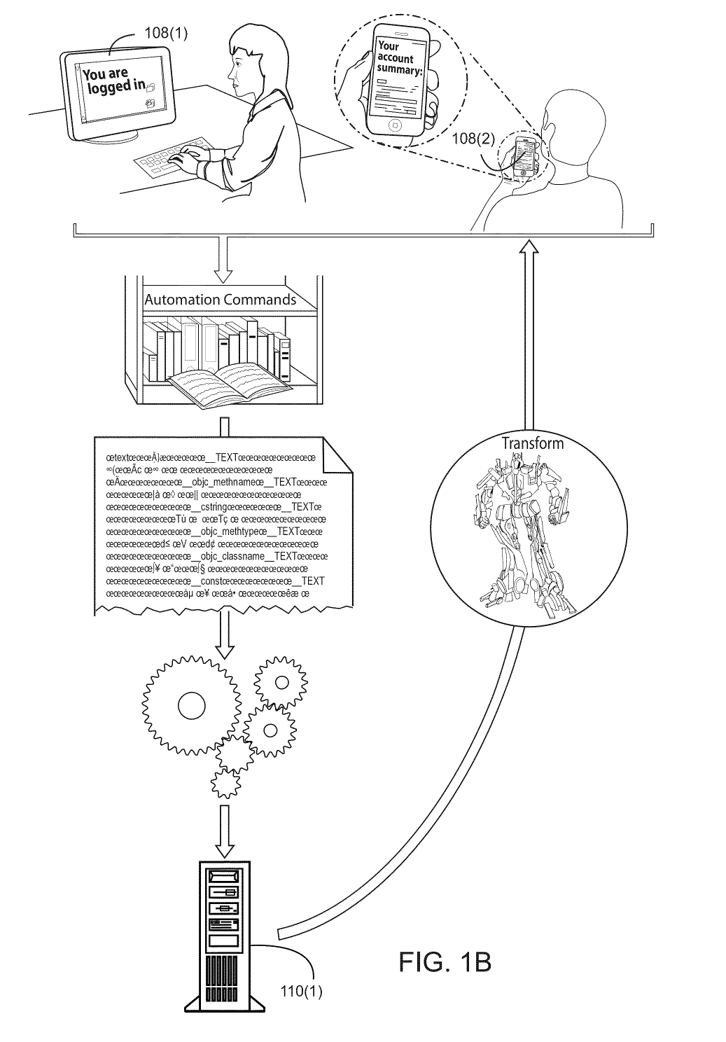

FIG. 1 shows a schematic block diagram of an example non-limiting system 100. System 100 includes a computing device 102 such as a server, a desktop computer, an embedded computer, a networked computer, a distributed computer, a single or multicore computer, or any kind of computing architecture. Computer 102 is connected directly or via network(s) 106 to one or a plurality of application computing devices 110(1), . . . 110(m) such as web servers, software servers running Selenium or other automation software, displays, storage devices, transmitters, or the like. Devices 110 can for example be web servers running web software or any computing device running any application(s).

Computer 102 can also be connected directly or via network(s) 104 (104 and 106 may be the same network or different networks) to one or a plurality of user or other devices 108(1), 108(n) such as handheld devices, desktop devices, or any other kind of computing, user interface, automation or other device. In one example non-limiting implementation, each of devices 108 is capable of accepting user input via an input device such as a touch screen, a keyboard, a microphone, a mouse, a pointing device, or any other type of interface that allows a user to input text, language and/or other information.

Computer 102 in the example non-limiting implementation takes input from device(s) 108 in the form of vernacular natural language commands or other information such as instructions; translates the input into automation commands or instructions or otherwise generates automation commands or instructions at least in part in response to the input; and outputs commands or instructions or computer programs for application to one of applications or processes 110. Such instructions can be used for purposes of automation including but not limited to testing or executing automatically on a digital computing processor, system, network or device.

In one example non-limiting implementation, computer 102 may provide functions including test/automation manager 112, test/automation writer 114, test/automation runner 116, basic reports 118, parser 120, and other functions. Computer 102 is connected to non-transitory storage 124 which stores code that, when executed by the computer, causes the computer to perform the functions of 112, 114, 116, 118, 120 and other functions (see e.g., FIGS. 1A-1B, 21-25).

While the example technology herein is broader than testing and extends to any type of automation, one advantageous illustrative example embodiment presented below for purposes of illustration comprises a testing system. Such “testing” can for example refer to or involve putting a user interface such as a web-based application user interface accessed or otherwise provided via a web browser through its paces in order to automate how a human or non-human user might interact with the user interface. Of course, since every automated or manual interaction with a web based or other application is in effect a “test” of that application, such automations can be used for any and all types of user interactions including but not limited to testing the functionality, performance and/or other aspects of the application.

There are aspects of the example non-limiting embodiment that are tools, and others that make it more than that. The “tools” in the example non-limiting embodiment include:

automation manager 112

automation writer 114

automation runner 116

Basic reports 118.

The example non-limiting manager 112 allows that:

Users can keep their automations private, share them with a group, or make them public.

Users can sort the automations based on groups, tags, or assignments.

The writer 114 permits that:

Users can write tests and other automations using “Plain Language” Commands such as English, German, Japanese, Dutch, French, Spanish or any other human language

Users can create Command shortcuts (Phrases)

Users can keep their Phrases private, share them with their group, or make them public.

The example non-limiting runner 116 provides that:

Users can run multiple automations at the same time, with multiple users, on multiple browsers/platforms

The reports 118 allow that:

Users are provided with detailed feedback pertaining to their automations

Users are provided with screenshots of every step in an automation

Users are provided with historical data of all automations and automation runs that they have ever performed.

Users can build custom reports (block 118) to access the details that are important to them.

Example Non-Limiting Web Application

A non-limiting web application implementation of the FIG. 1 system provides a web site where non-developers go to write, manage, and run tests and other automations. An example non-limiting web application includes everything listed in the core concepts, as well as additional features. Some features of a non-limiting example web application include:

Ease of use (i.e., good user interface). Users have the ability to use the site with as little training as possible (ideally none). They write and run a simple automation or test within a short time of visiting the example non-limiting embodiment website.

Speed. The site is fast. Sufficiently fast computing devices and efficiently designed software ensures there is no lag between page refreshes.

In one preferred example non-limiting implementation, most users should be able to perform all of their actions from two main pages: The test writer page, and the test management page.

The Writer 114 in the example non-limiting implementation has the following features:

It displays the webpage that the user is automated or testing and allows the user to interact with it.

It provides an area where users write their tests or other automations.

It allows users to click through the site and record their actions as Commands. Since one example embodiment implements recording as a browser extension, recording actions may not take place directly from an Editor page in one example non-limiting implementation. Other implementations may be able to do recording without extension, or use other techniques.

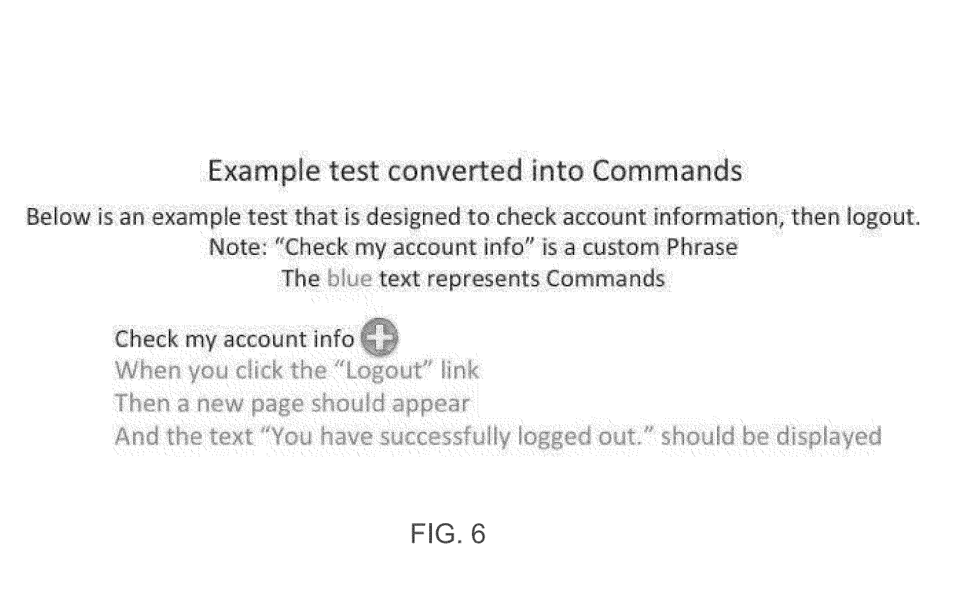

It provides Phrase suggestions for the given web page that they are viewing. These suggestions may for example be a combination of Commands, personal Phrases and shared Phrases. See FIG. 6-8.

The test management page (manager 112) may include the following features:

It may allow users to view, sort, group, tag, assign, etc. all available tests or other automations.

It may allow users to view tests and other automations based on groups, tags, status, assignment, etc.

It may allow users to run tests and other automations at any time by clicking on them.

They run single tests, groups of tests, or all tests the same way.

Likewise it may allow users to view history, audit and run any test or other automation by clicking on it. They can view results for single tests, groups of tests, or all tests.

Example User Interface Navigation

### 1. Main Page

1. Info about the product

2. Contact us info

3. Pricing info

4. Direct access to try it for free (without needing to register or login)

5. Access to bug tracker

Allows users to submit bug reports

Shows people that we are actively testing our website using the API

### 2. Login Page

1. Basic login ID and password

### 3. Registration Page

1. Team info:
1. Provides a field to specify if user is registering as part of a team or teams (such as a workplace group)
2. Allows user to specify if user is the group manager (if it is a new team). The team manager can always be changed later, but will determine who has access to the team, etc.

2. Provides a place to add the website that user wants to test (including a way of verifying that the user has access to test that site)

3. A place to enter credit card or other payment information

4. An explanation of how/when user will be charged

4. Post-login landing page
5. My Account page

1. Allows user to change any of their personal information

2. Allows user to change credit card or other payment information on file (if any)

3. Allows user to request to join specific groups (the request then sends an email to the group manager, and adds a notification on group management page)

4. Allows user to set their personal preferences (background color/image, color scheme, view preferences, etc.)

### 6. Writer/Editor

### 7. Phrase Creator

### 8. Spec Management Page

1. Group management section
Allows users to create, modify, remove groups that can be used to organize their specs
   9. Spec listing page

### 10. Runner

### 11. Reports

### 12. Team Management

1. A place to specify the credit card on file for the entire team (along with a listing of the number of users in the team and the current monthly/annual charge based on phrase subscriptions, packages, etc.)

2. A notification center where users can see who has requested to join their team

3. A management page for all users in the team
Ability to specify additional managers from this page as well

4. Managing users within a team

5. Managing who has access to which tests

### 13. Personas

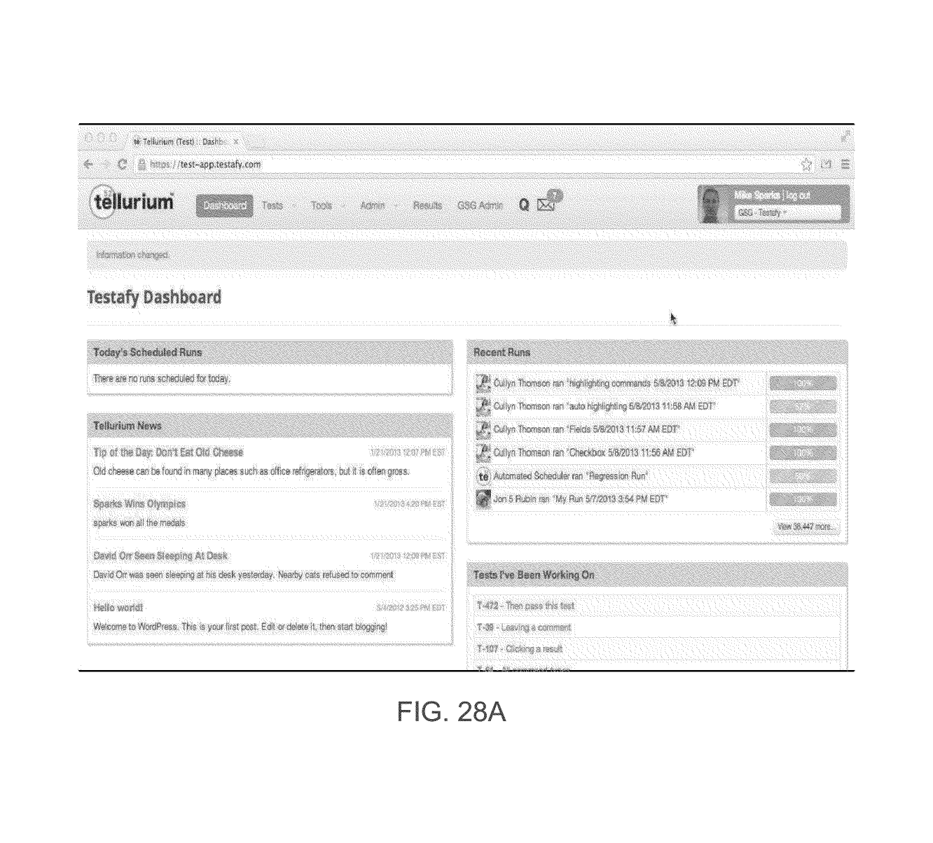

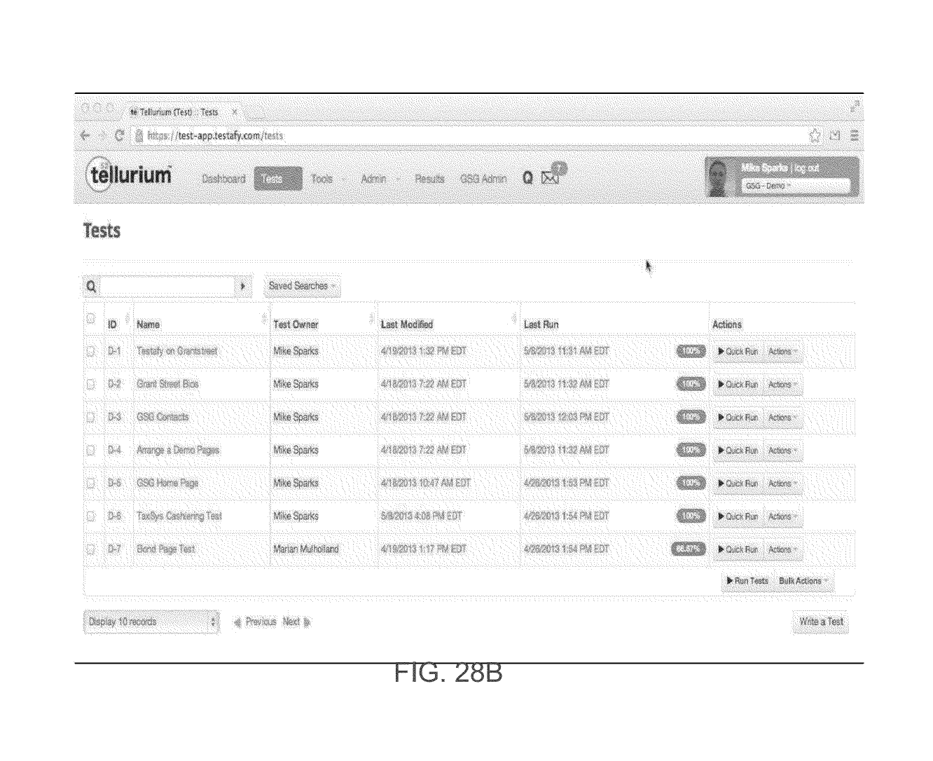

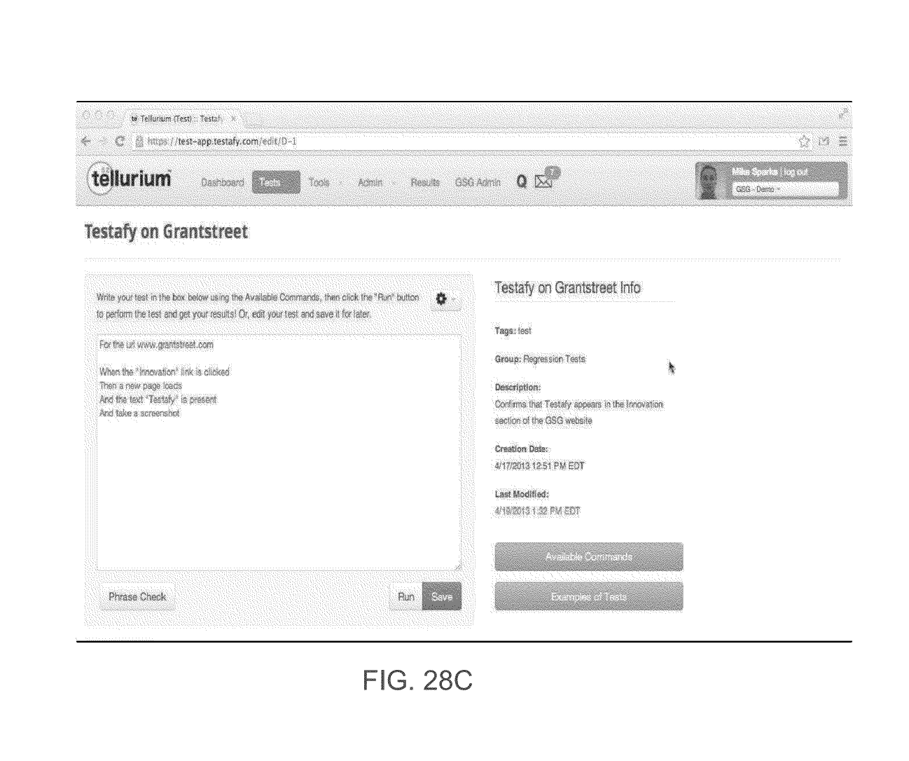

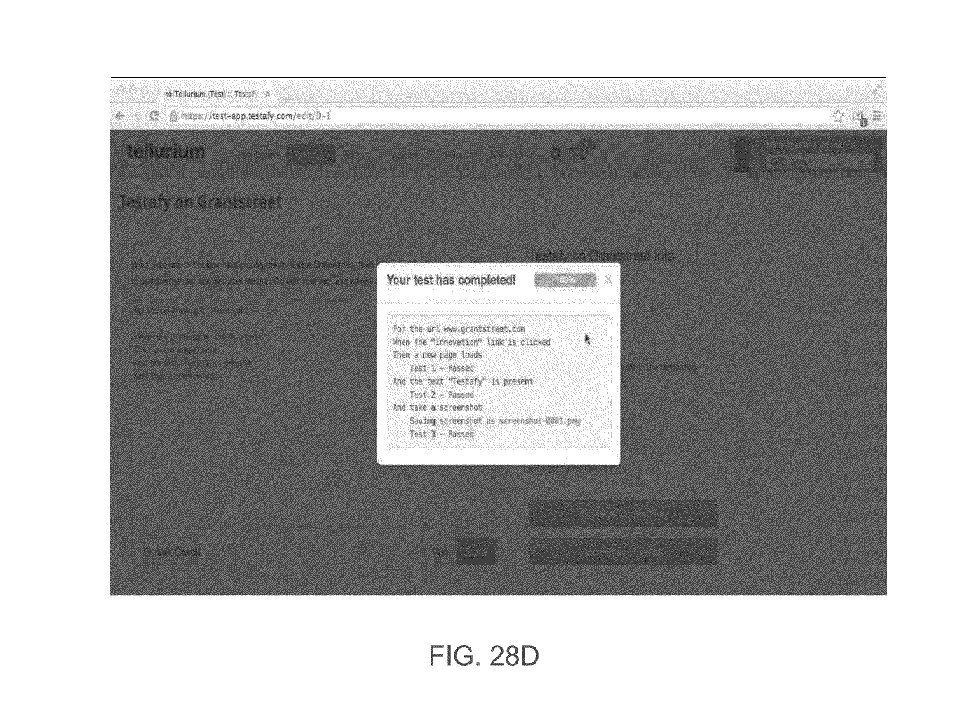

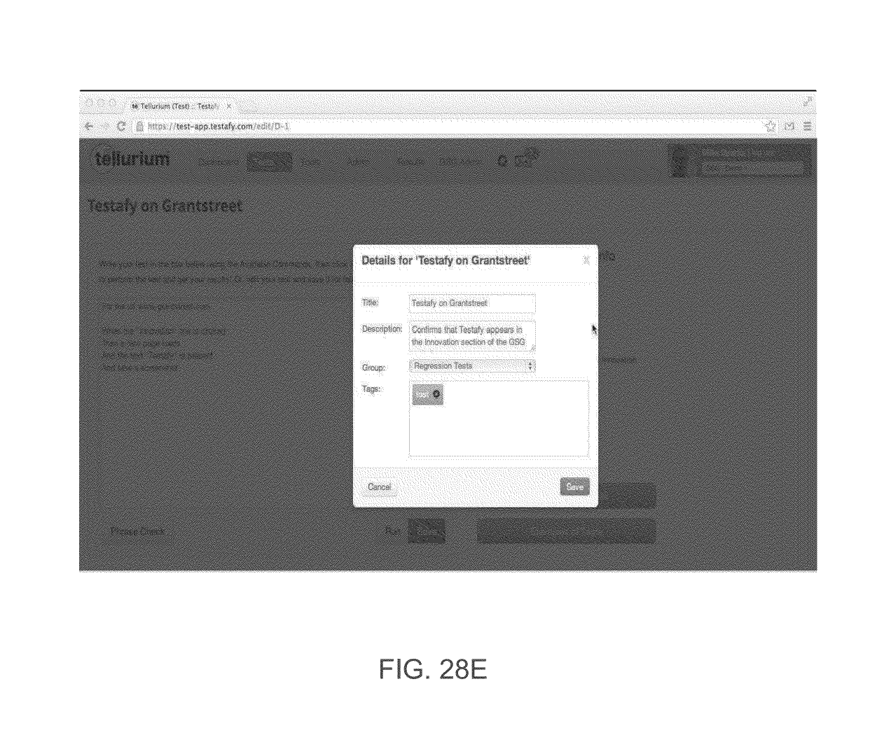

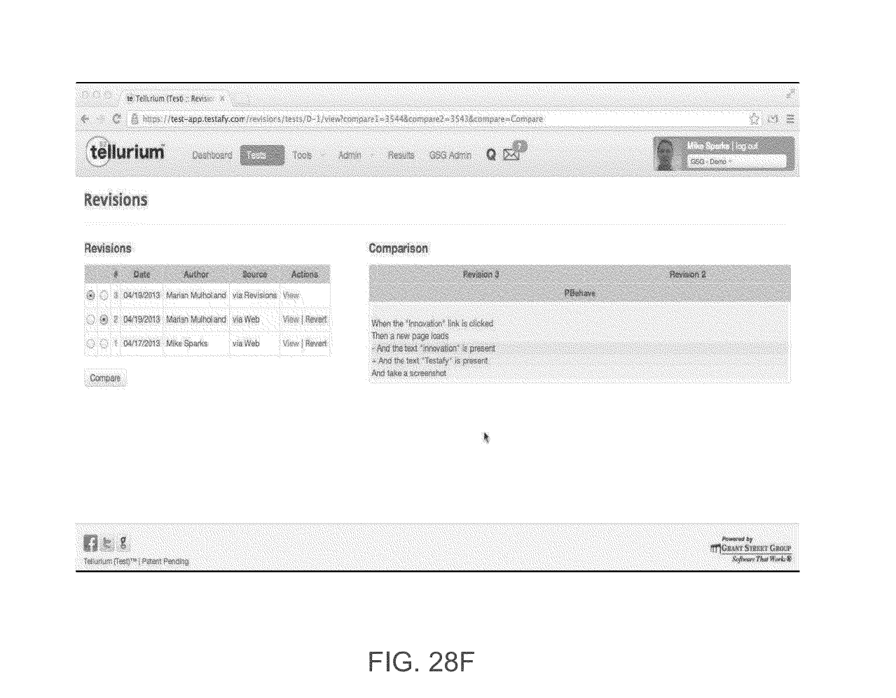

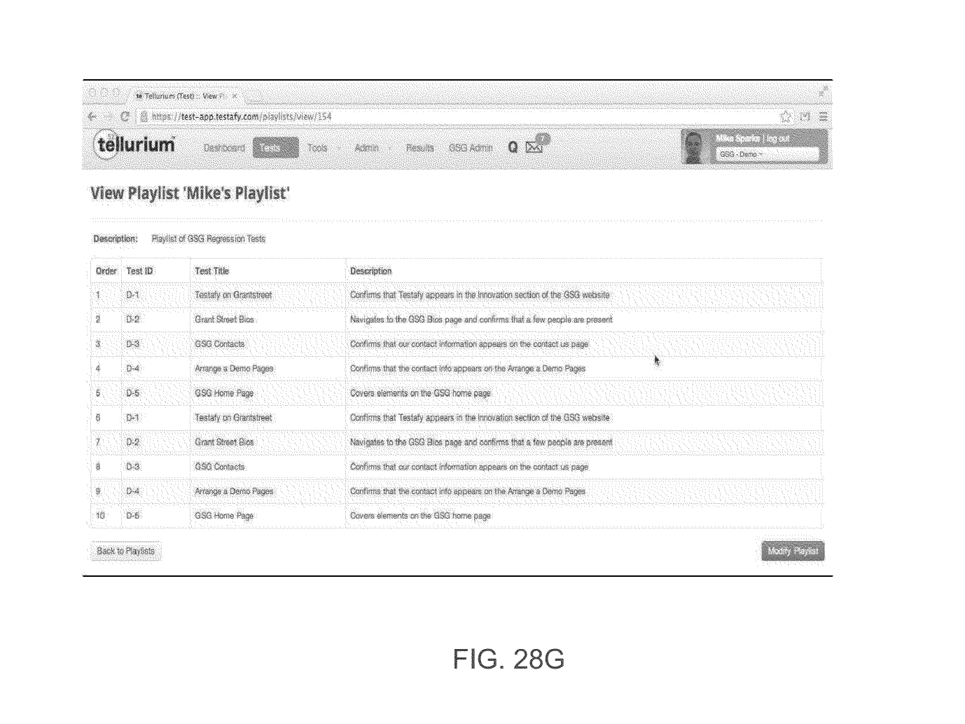

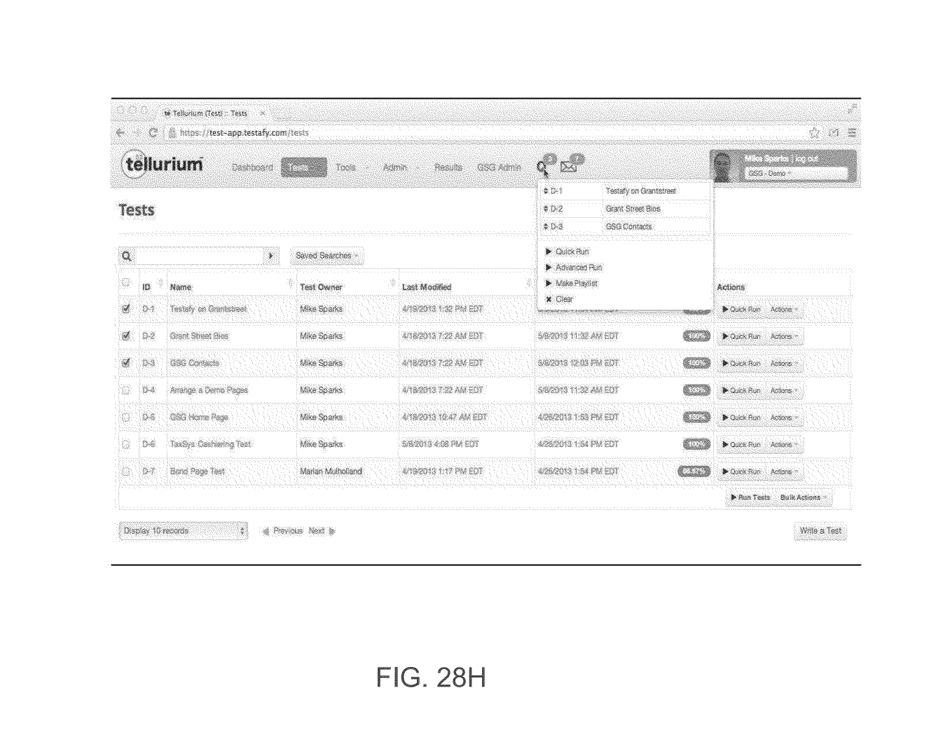

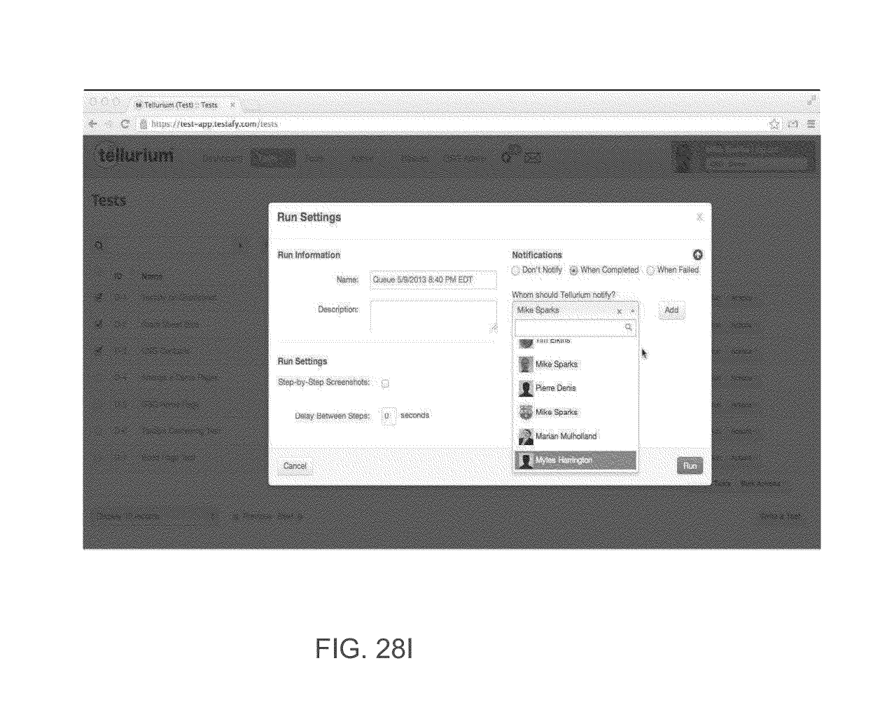

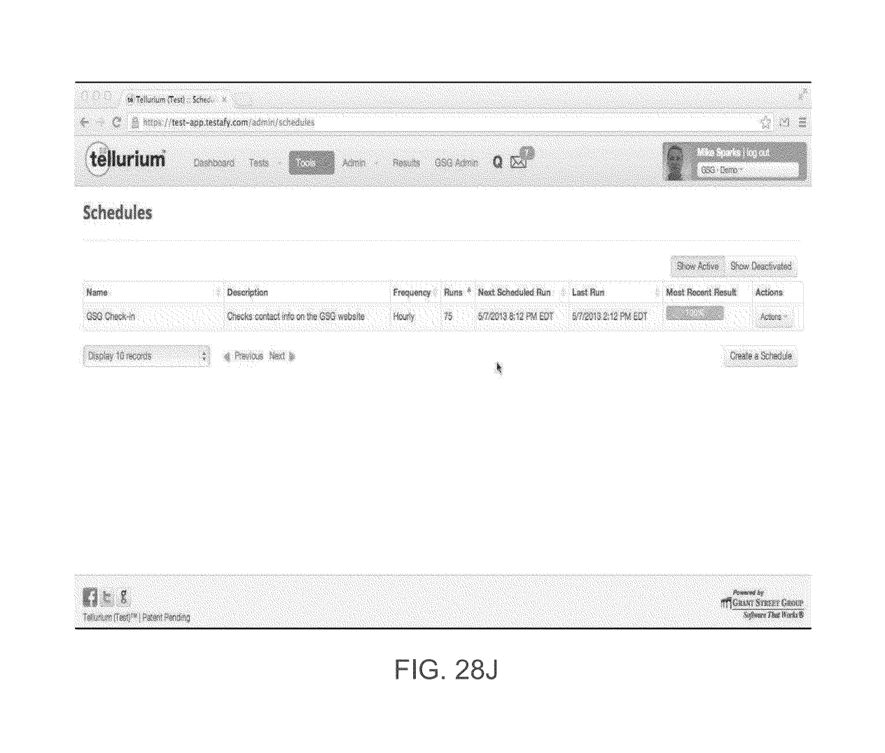

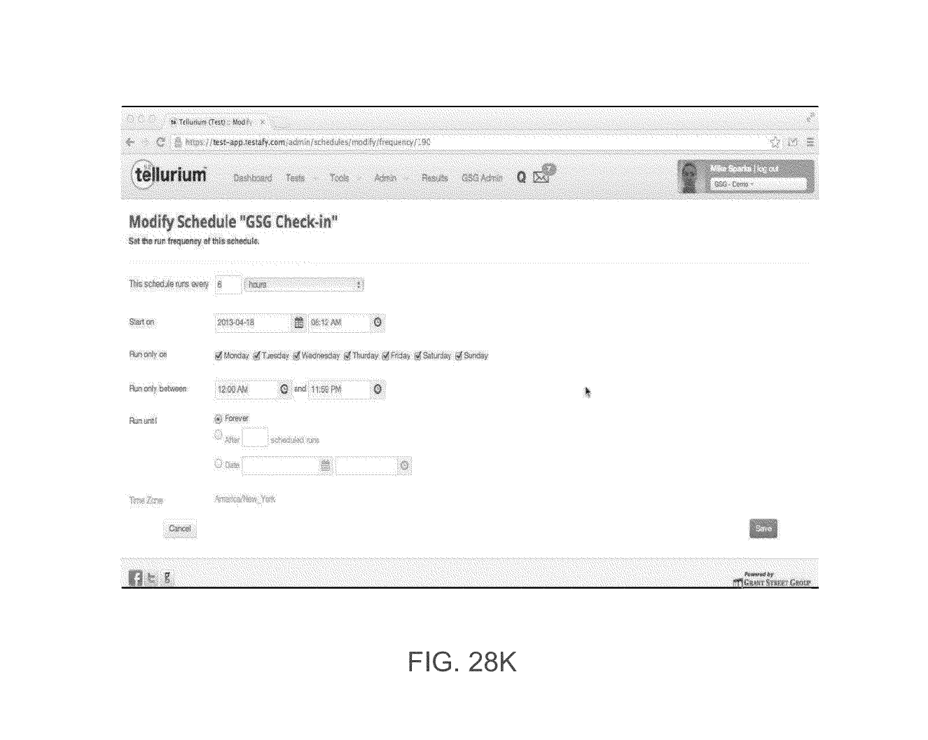

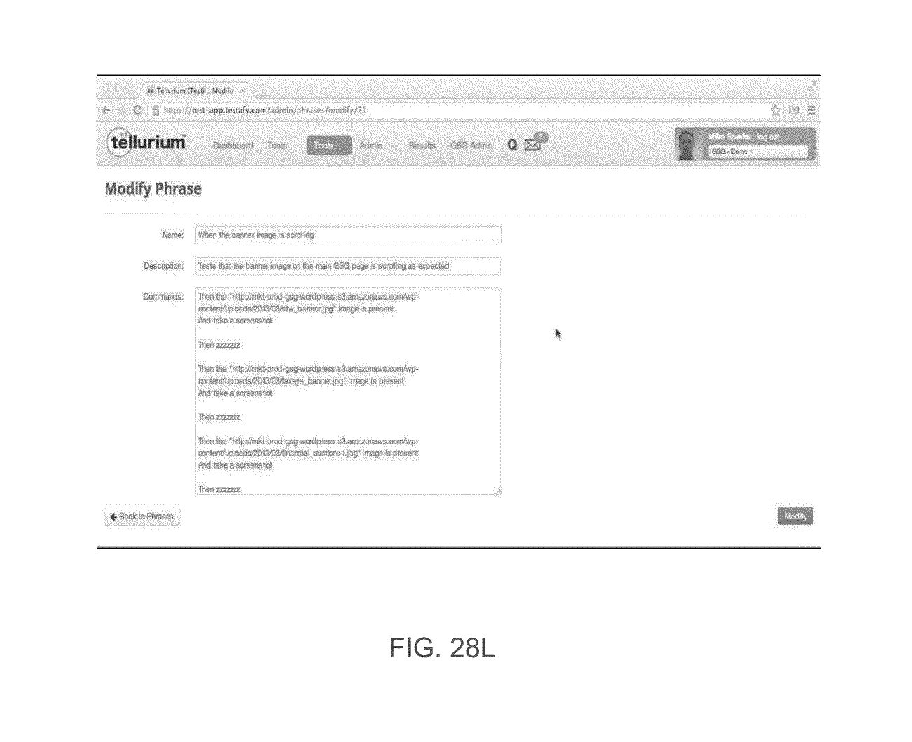

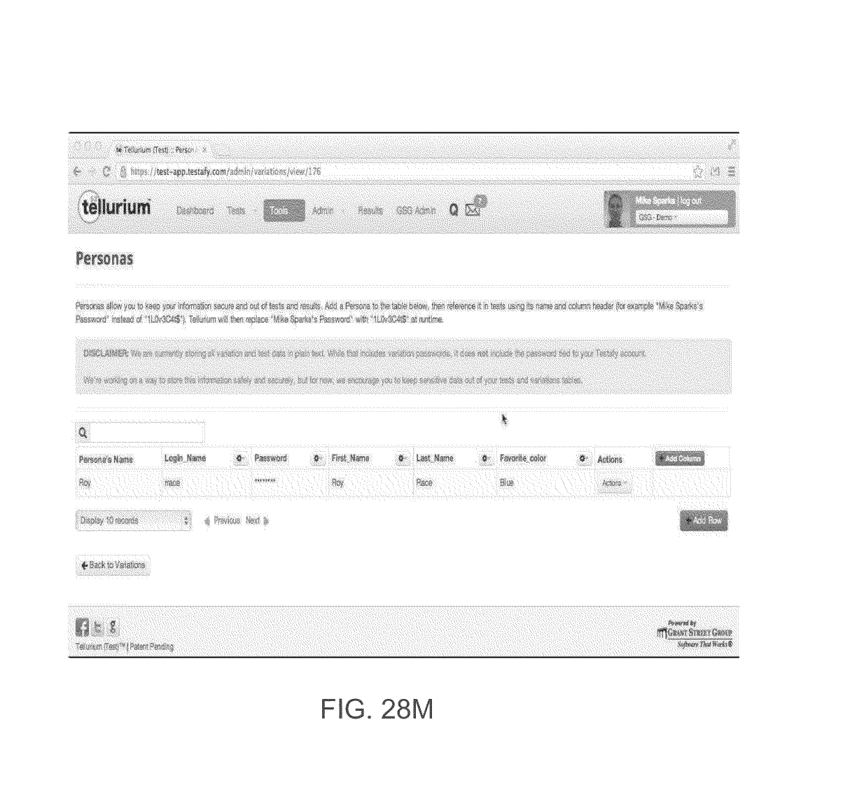

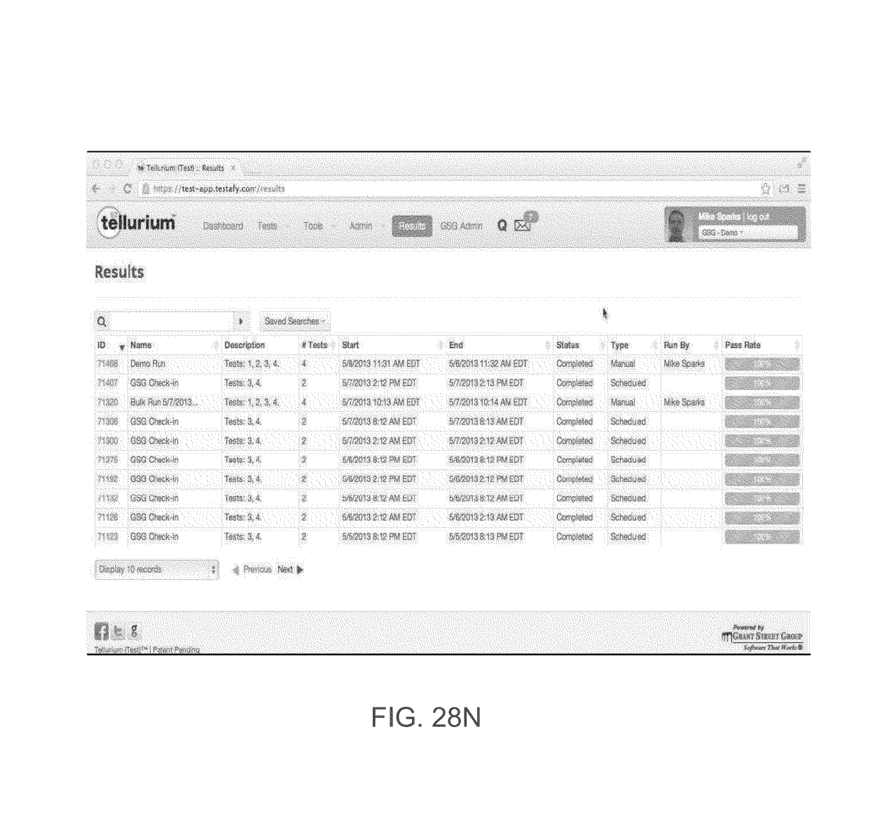

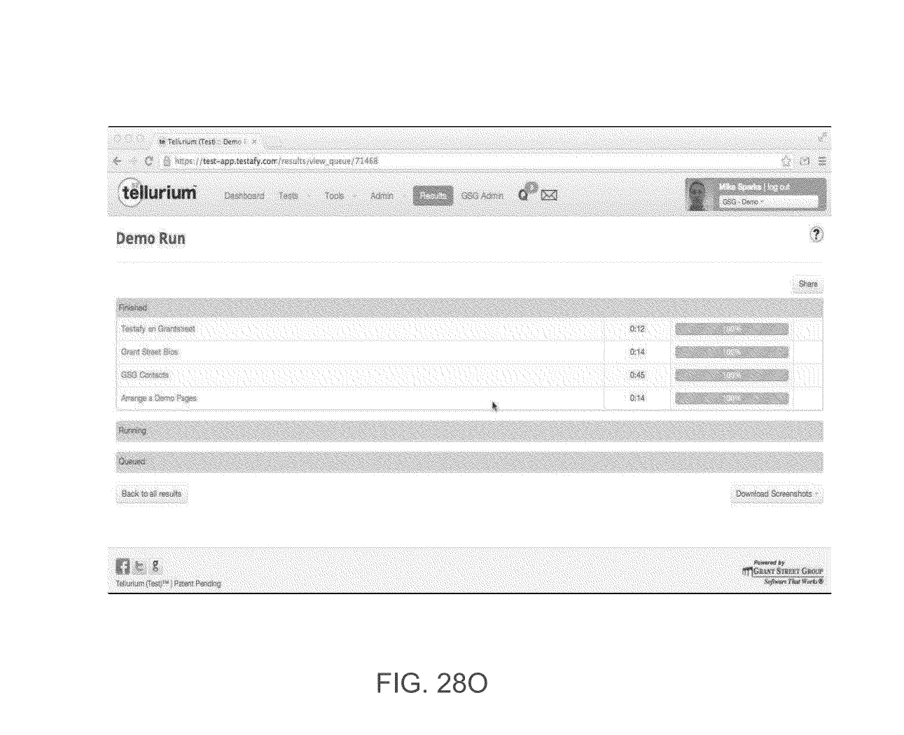

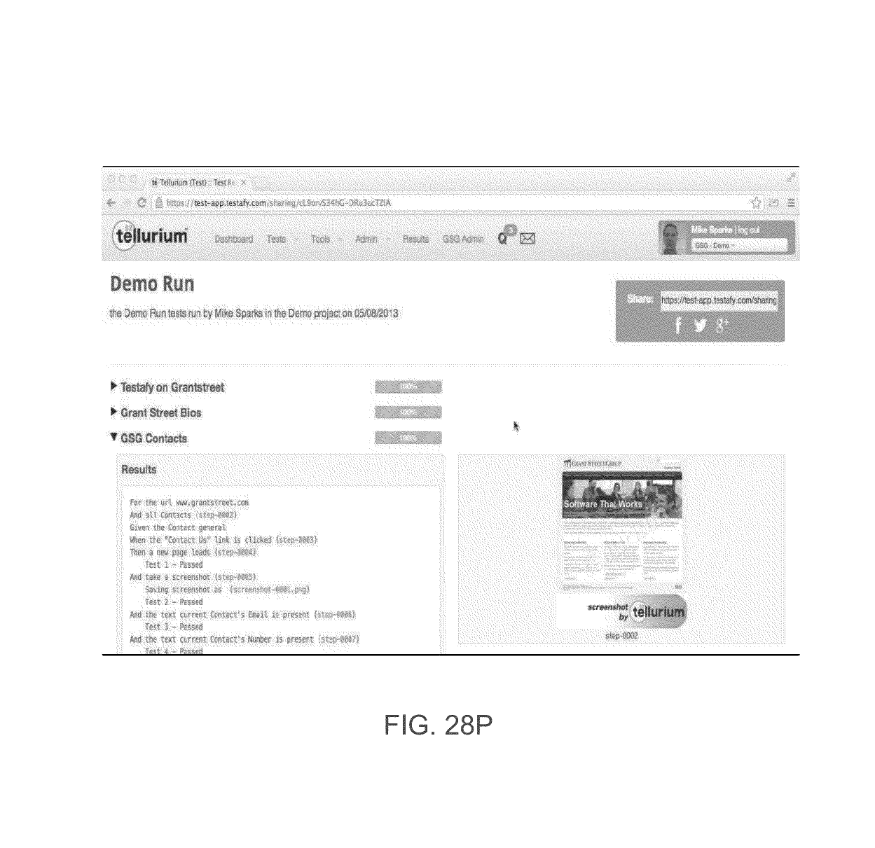

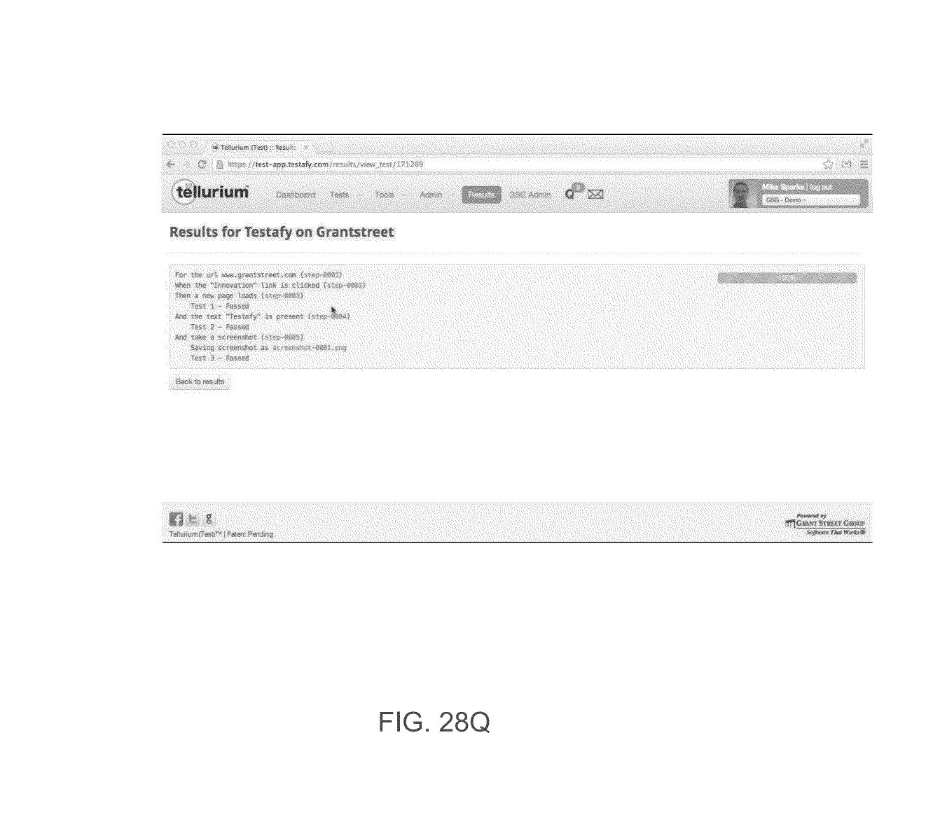

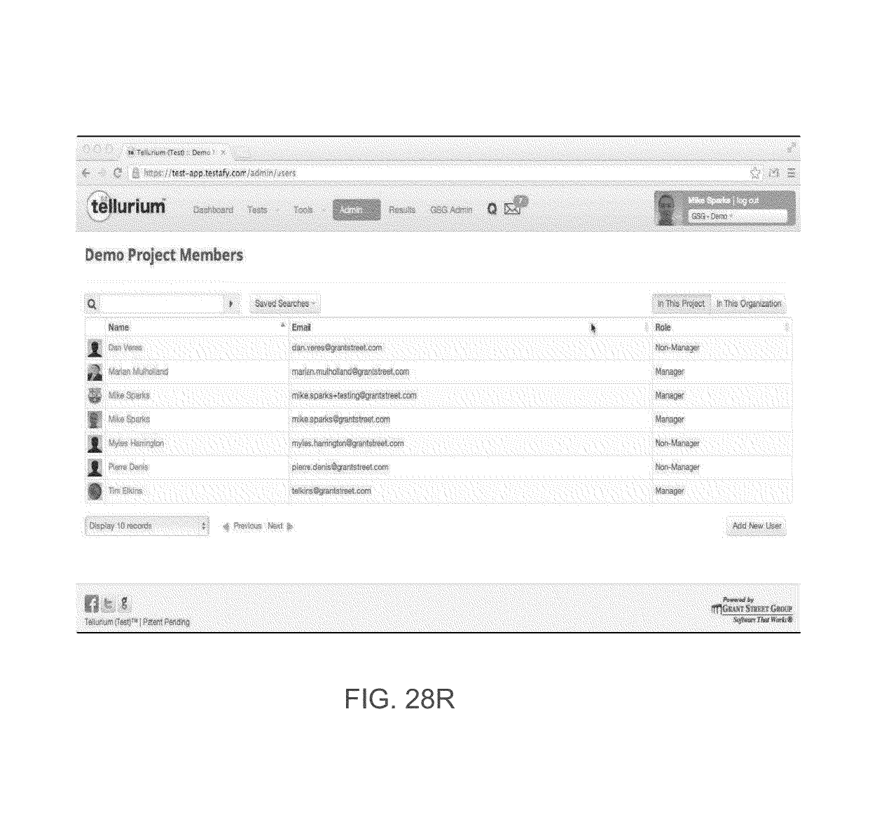

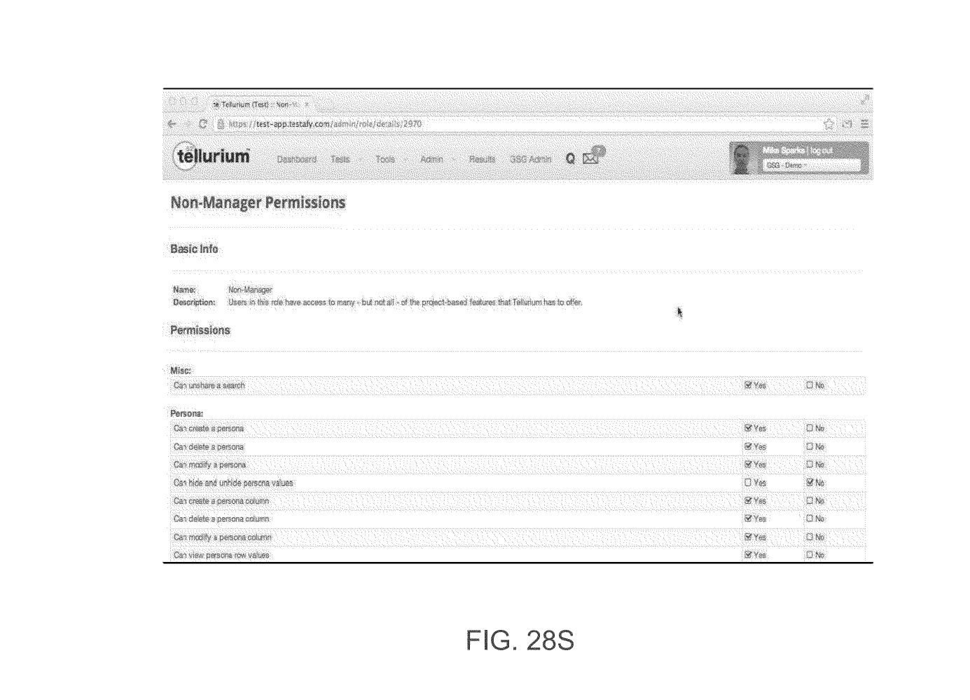

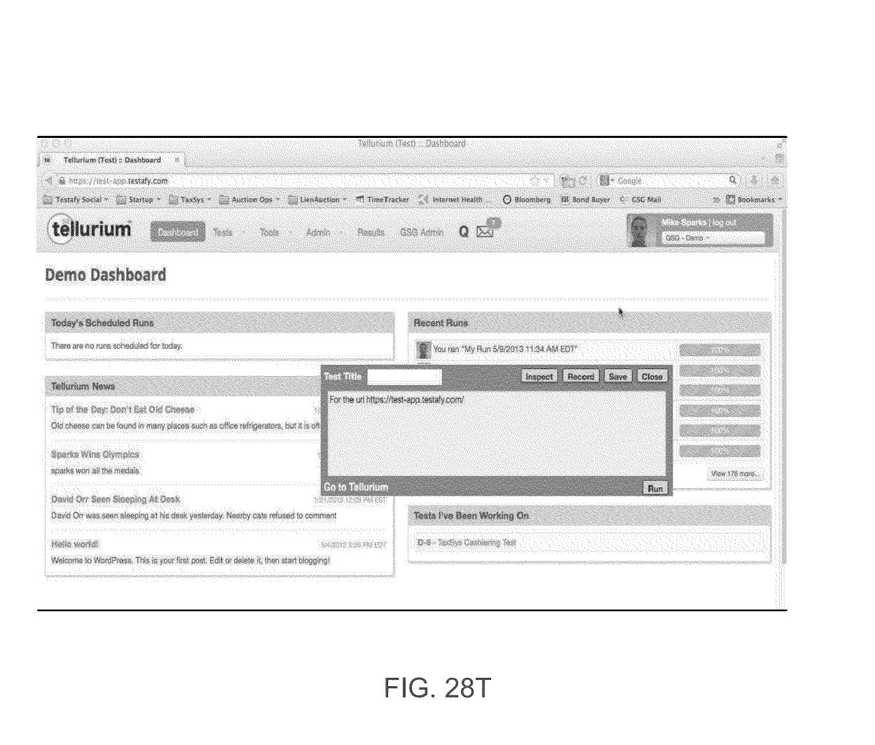

1. Specifying test logins/passwords for each test (see FIG. 28M)

### 14. Restrictions

1. Blocking someone from running tests in a certain website or environment

Example Non-Limiting Application Programming Interface (API):

Write commands

Write Phrases

Run commands and phrases
Run individual and multiple tests

Results generation
Retrieving results

Projects—sharing tests/phrases/results with a team

Sharing—sharing tests/phrases/results outside of your team
Scheduling—setting tests/commands to run at a scheduled time or interval

Notifications—getting notified when a test run is complete, or only when something fails

Administration—Managing permissions/access to tests/phrases/etc., billing, etc.

Billing
Website:

Everything the API does

Shared tests/phrases/results/users between the API and website

Advanced searching for shared tests/phrases

Ranking of tests/phrases

Grouping or tagging tests/phrases

Advanced reports—customizable result detail, analyzing the history of results, comparing performance to industry standards, etc.

User monitoring—tracking user progress, assigning tests to users, assigning tests for review

Example Non-Limiting Application Programming Interface(s)

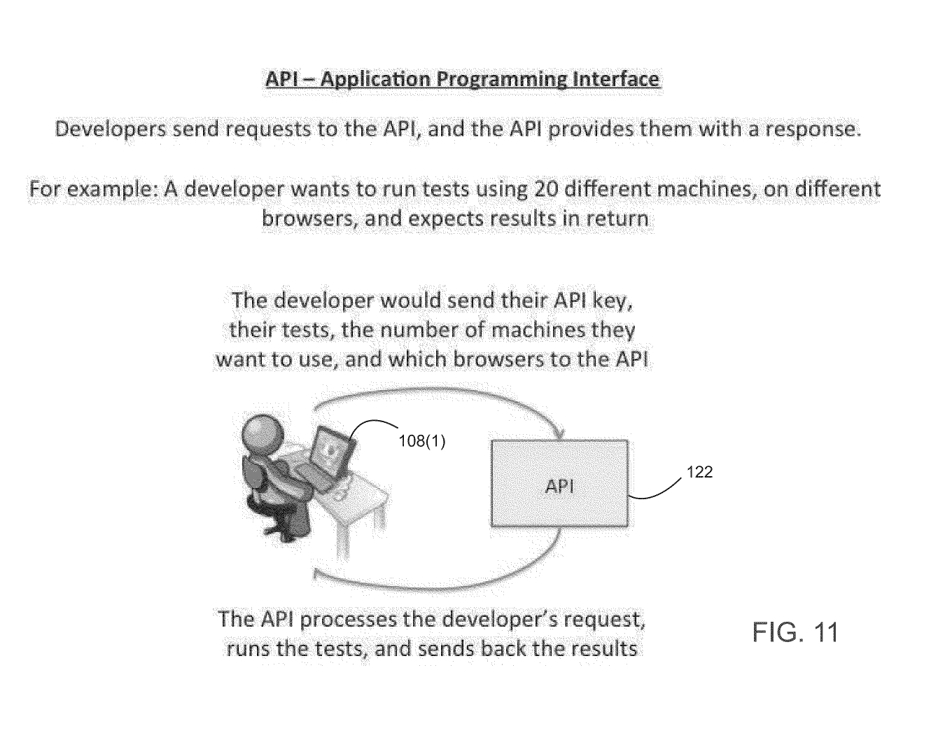

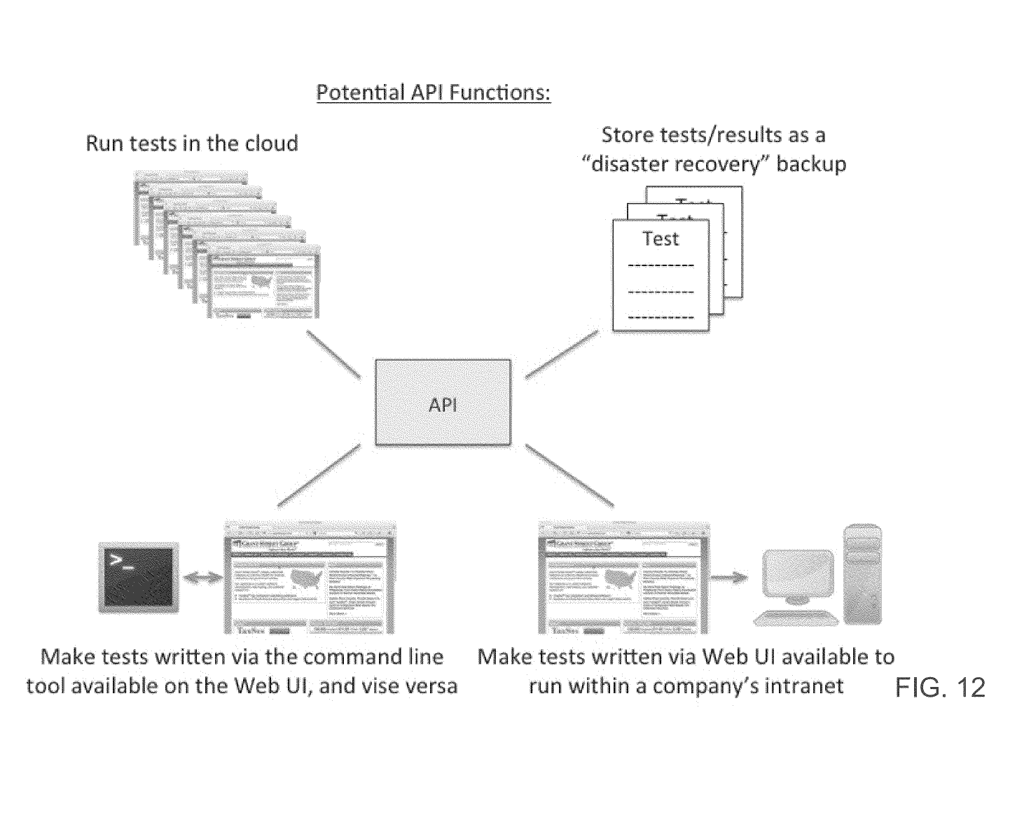

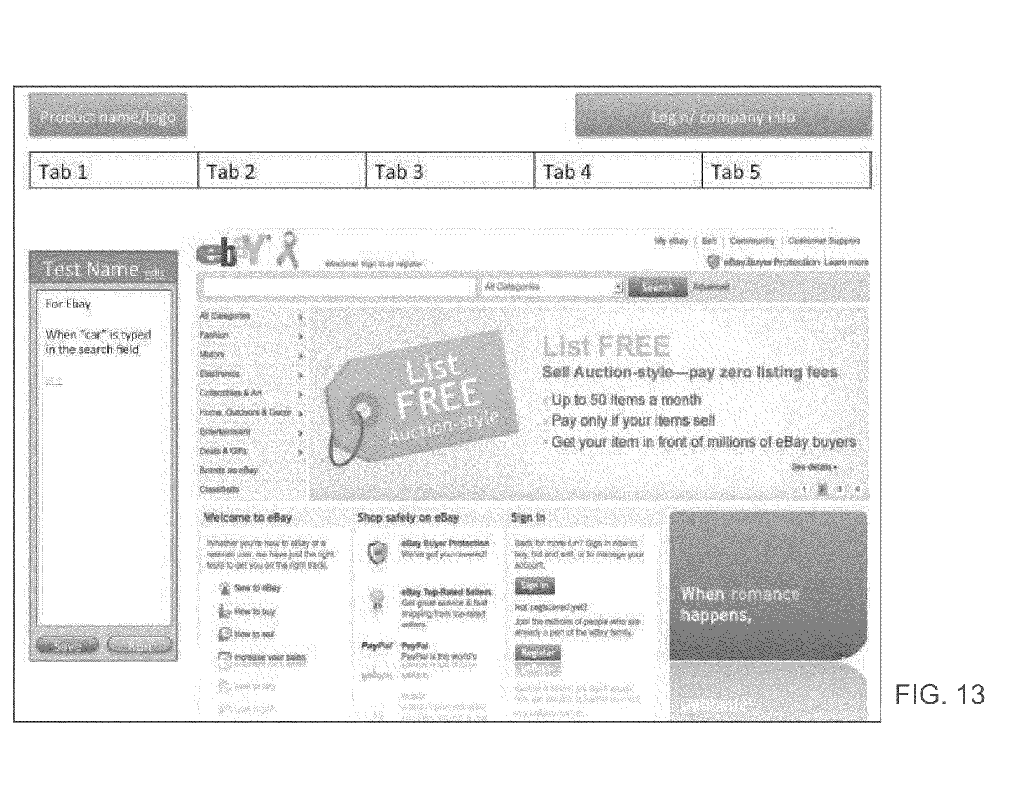

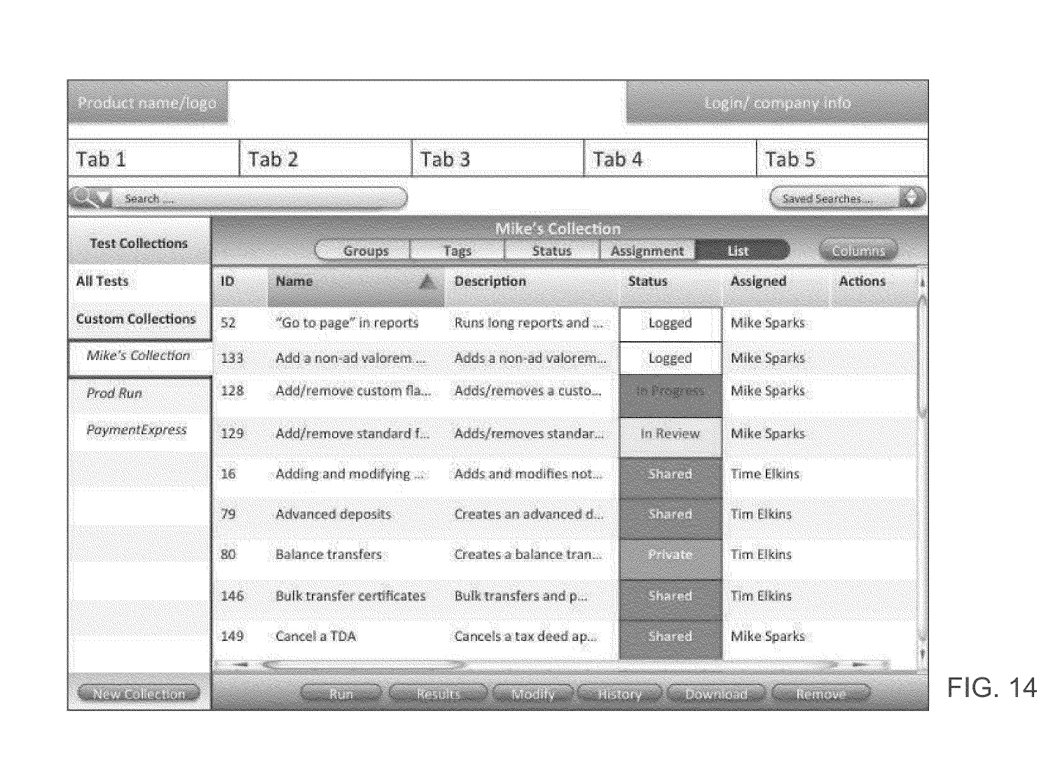

In the example shown, computer 102 provides one or more application programming interface(s) (APIs) 122 that input devices 108 can use to access the functions provided by computer 102. In this example non-limiting implementation or mode, developers need not run tests on their desktop but instead write tests and phrases, and send them to the API to be run (see FIG. 11, 12, 15). Since they may not have access to the source code, the system provides them with documentation on how to do at least two things:

1. Write tests and save them locally on their computer, smart phone or other device
2. Write custom phrases which can be used in their tests

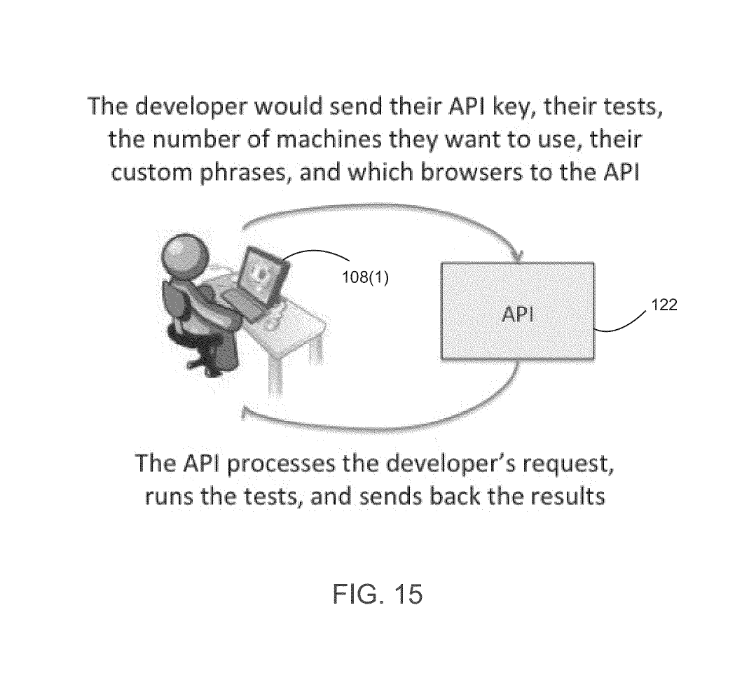

FIG. 11 shows that developers can send requests to the API and the API provides them with a response. For example: A developer wants to run automations using 20 different machines, on different browsers, and expects results in return. The developer would send her API key, automations, the number of machines she wants to use, and which browsers to the API 122. The API processes the developer's request, runs the automations, and sends back the results. If developers want to run automations including but not limited to tests, they send it to the API 122. That way, none of the code that is used to run tests needs to be made visible to the public in such an example non-limiting implementation. See FIG. 15 which shows how a developer can send her API key, automations, the number of machines she wants to use, her custom Phrases, and which browsers to the API. The API processes the developer's request, runs the automations and sends back the results.

This non-limiting example approach provides the following example advantages and features:

Speed to use. Rather than needing to download all of the source code, installing it, reading through documentation, setting up local servers, etc., the developer can sign up for an API key (e.g., from a website), write a test, and send it to the API. It decreases the time to their first completed test from hours to minutes.

The only things a developer needs are an API Key, an “API Passport”, their tests (written, for example, as commands in a scripting language referred to herein as “PBehave”), and custom phrases they have written, if any.

The ability to run tests is available to all developers, regardless of the language they use (Ruby, Python, Java, C, etc.). An “API Passport” can be provided in all languages so all developers can access the API.

An API 122 can be thought of as a digital mail order catalog:

The customer (in this example non-limiting embodiment: a developer) knows what it is that they'd like to order.

Before the mail order company (in this case: The example non-limiting embodiment's API) can fulfill the order, it requires some details such as: what is being ordered? Who is placing the order? Are all of the prerequisites provided so that the order can be completed properly?

Assuming that the customer (developer) provides all of their information correctly, the mail order company (API) takes the information, completes the order, and sends the customer what they're expecting. The API serves multiple purposes in the example non-limiting implementation:

It provides services to the developers who are using the code, such as:
Running tests in the “cloud”
Storing tests and results as backups
Performing load testing (running x instances of the same test at the same time using, for example, different browsers or different versions of the same browser)

It allows developers to write and run “plain English” or other human language tests and automations in the “cloud”

It provides a basis from which to build or provide the example non-limiting embodiment Web UI.

It allows tests that are written in the Web UI to be run locally within a company's secure intranet, rather than in the “cloud”. This alone is helpful for companies and users concerned about security.

It allows other applications to utilize the testing and web automation framework.

One example non-limiting implementation provides a basic API where developers run a single test remotely. Such an API provides developers with the option of running tests on pre-setup servers, as opposed to having to go through the trouble of setting up local servers in their own environment.

Example Non-Limiting Automation Commands

A feature that makes the example non-limiting embodiment useable by anyone is that tests can be written in “plain vernacular” such as “Plain English”, “Plain German”, “Plain Spanish”, lingua franca or other plain natural language. Such a plain vernacular language may for example observe a grammar, follow a syntax, and constitute a natural language that humans use to communicate with one another. The “plain English” or other plain language text that is included in tests or other automations and is executable, is called a “command”. Such a Plain English or vernacular command can be for example a sentence fragment or a complete sentence. Ultimately, the example non-limiting embodiment allows users to go beyond “plain English” and gives them the ability to write tests in their own vernacular or any other language constructs the user wishes or desires (see “Phrases” in section below).

In example non-limiting contexts, every application has a standard set of objects with which the user can interact. For example, in one non-limiting context, every web-based application can consist of a unique combination of the following objects:

Links

Buttons

Checkboxes

Drop-down menus

Multi-select fields

Textboxes

Text Areas

Data

Other

Each of these objects has a limited number of ways that the user can interact with them. For example, the interactions for a Button include:

Click the button

Confirm that the button appears on the page

Confirm that the button does not appear on the page

Confirm that the name of the button is what you would expect it to be.

Therefore, considering that the example non-limiting system knows all objects that can be included in a web-based application, and also knows all the different ways that a user can interact with each of those objects, the system can build a list or library of Commands that could be used to test or otherwise automate any web-based application.

Example Non-Limiting PBehave Vernacular Testing/Automation Language

In one example non-limiting implementation, this capability is provided by a custom testing/automation language referred to herein as “PBehave”. PBehave is a set of “plain English” or vernacular commands that can be used to automatically control or automate any application. Whether the user realizes it or not, all commands can be written in PBehave.

Some non-limiting examples of “plain English” PBehave commands include:

When the “Search” button is clicked . . . .

If the “Search” button appears on the page . . . .

If the text of the button is “Search” . . . .

While “plain English” tests are a benefit, it still does not provide users with commands in their own vernacular. For this purpose, the example non-limiting embodiment includes a unique, custom phrase generator.

Simple events like “click the Search button” or “check that certain text is on the page” can be translated. In this specification we use them for reference because they're easy to understand. However, the example non-limiting PBehave commands can complete tasks that are far more complex. For example: “When a random “View” link is clicked If the “Search” button is present in the top right section of the page When the “View More” link in the “News” section is clicked”.

Most record/playback tools may associate actions with specific elements on a page, typically by looking for the element within the HTML code or other application interface. If the specific element isn't found, then the test fails. If there are multiple elements on a page that are similar (like multiple “View” links) or if it is desired to test based on the location of something on the page, then record/playback tools may fail. However, the example non-limiting PBehave allows far more general expression since it doesn't interact with elements based purely on their HTML or other computer-readable expression, but also by comparing elements to the rest of the HTML or other computer-readable expression in the page or other application interface. This allows the example non-limiting implementation to do things such as interact with elements based on their proximity to other elements on the page (e.g., “When the View More link in the News section is clicked”) or allows the example non-limiting implementation to use things like ordinals (like “When the first/second/last/random View link is clicked”).

It also allows the example non-limiting implementation to combine all of these different pieces of PBehave so that people can flexibly utilize commands that expand on this capability. For example, let's look at the following command: “When the first “View” link in the “News” Section is clicked.” That Phrase consists of a few different PBehave “segments” that are concatenated to form one automation command: “first” is an ordinal that can be used to select a “specific” element if there are multiple on the page; “View link” references an element; “in the News section” looks for “News” on the page, then tries to find the closest “View” link; “is clicked” performs the action. This can be expanded even further to provide commands such as: “If a random blue “View” button in the “News” section has a dead link”.

An even simpler example is: When the “First Name” field is “Roy”. If the HTML of the field where the user types or otherwise inputs “Roy” doesn't reference “First Name” in any way, then a simple command like that may not work for record/playback tools. The example non-limiting PBehave is different in that it not only checks the HTML element for “First Name”, but will also check to see if “First Name” appears on page BEFORE the field. Thus, the example non-limiting technology herein “translates” so that people can combine different “segments” of PBehave to build commands that accomplish exactly what they want.

Example Non-Limiting Phrases

In more detail, in one non-limiting implementation, a “phrase” is a series of (PBehave) commands that can be identified by a single string. Phrases are essentially command shortcuts in the example non-limiting implementation.

The example non-limiting embodiment includes a phrase generator that will allow users to create and share phrases (for more on sharing, see section below). For example, a user could create a phrase named “Log me in”, which would consist of the following commands:

When you type a user identifier such as “MSparks” in the “Login” textbox

And you type “password1” in the “Password” textbox

And you click the “Login” button

Then a new page should appear

And the text “Welcome MSparks” should be displayed.

In such an example non-limiting automation converted into commands, an automation may be designed to check account information, then logout of a web application. The Phrase “Check my account info” can be a custom Phrase that represents the following Commands:
When you click the “Logout” link
Then a new page should appear
And the text “You have successfully logged out.” should be displayed.

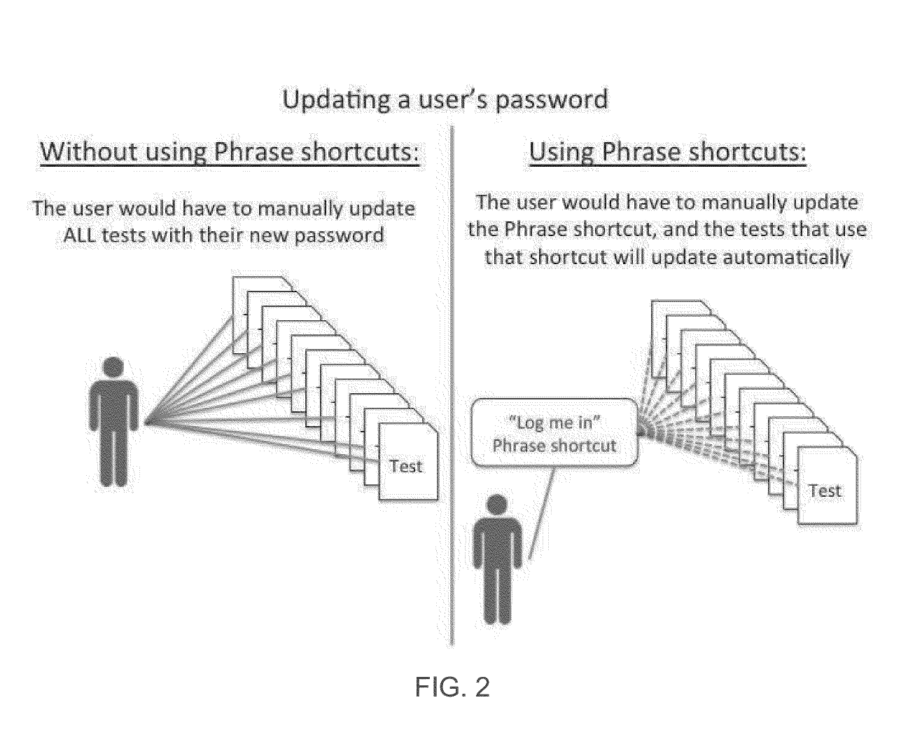

Every time a user wants to create a test where logging in is involved, they can use the phrase “Log me in”, rather than typing the five commands that are listed above. See FIG. 2 as an example.

Users can create as many phrases as they like. They can even create phrases that use other phrases (i.e., phrases can be nested) in the form of subroutines or other iterative or callup process structures. For example, the same user could create another phrase called “Check my account info” Phrase that consists of the “Log me in” custom Phrase above and a list of Commands. It may thus include the following Commands:

Log me in

When you click the “My account” link

Then a new page should appear

And the “Username” field should be “MSparks”

And the “Email” field should be “test@tester.com”

And the “Phone” field should be “412-391-5555”

When you click the “Logout” link

Then a new page should appear

And the text “You have successfully logged out.” should be displayed.

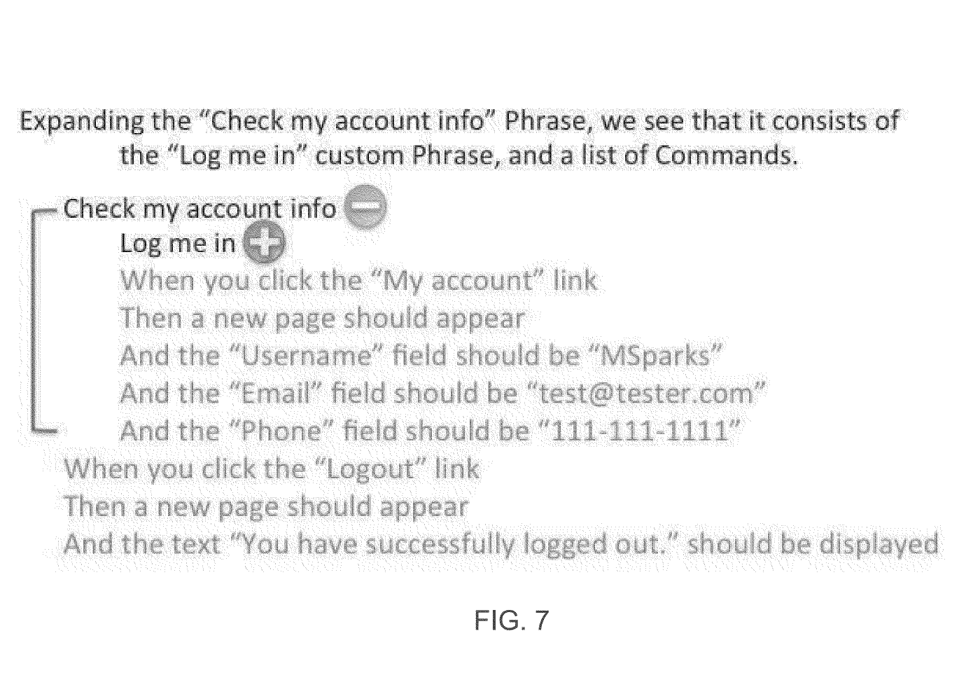

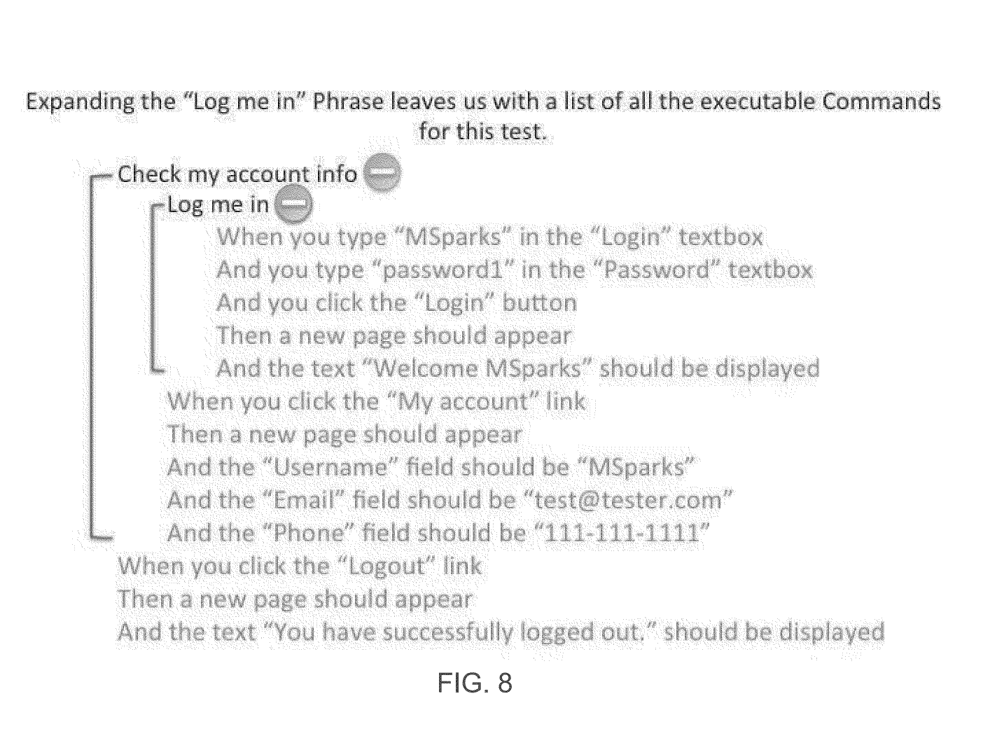

See FIG. 7. As shown in FIG. 8, expanding the “Log me in” Phrase provides a list of all executable Commands for this automation.

Notice that in line #1, the “Log me in” phrase is included as part of the “Check my account info” phrase.

Using phrase shortcuts has a number of benefits, including:

It will take users less time to write tests. Commonly used operations (like logging in) can be written once as a phrase, and then used over and over again anywhere (i.e., in multiple automations) that logging in is required.

It will be easier to modify tests and other automations. Continuing with the “Log me in” example, if the user does NOT use phrase shortcuts, and their password changes, they will have to update ALL tests or automations where they are required to login. On the other hand, if they DO create a “Log me in” phrase, and use it in any test or automation where logging in is required, then the user would only have to update the “Log me in” phrase with the new password, and all of the tests or automations that use the phrase will update automatically. See FIG. 2 (in this context the “Must” applies only for one non-limiting implementation where users use commands from the command libraries that are associated with the applications they are testing or automated to that the system can execute their automations).

Generally speaking, in one non-limiting implementation a command may comprise a string of base level text that, when inputted, is used to control an external application. For example:

When you click the “button” button . . . .

When you type “text” in the “text” field . . . .

If the “link” link is available . . . .

For a non-limiting example of a “command shortcut”, see “Phrase” above. Note that phrases can be written in a vernacular lingo that is easily understandable to humans without need for specialized knowledge.

“PBehave” in the preferred non-limiting implementation comprises a custom automation language that allows “plain language” Commands to be used to automatically control an application. In one example non-limiting implementations, Commands are written in PBehave. Of course, other non-limiting implementations can employ other representations.

In one non-limiting example implementation, a Command Library may comprise a collection of Commands, organized based on the application where the Commands are being used. An example non-limiting command library includes a set of rules for matching nouns, commands, and phrases. These rules include the type of statement (For, Given, When, Then, etc.), the pattern to be matched, the code to be executed after a statement has been matched, any arguments to extract from the pattern, an optional weight, and optional accept and reject clauses. A non-limiting example Phrase Library comprises a collection of Phrases, organized based on the application where the Phrases are being used. In one example non-limiting context, Sharing gives other users access to tests or Phrases a user has written, and receiving access to other users' tests and Phrases. Communities in one example non-limiting implementation comprise Groups that would be interested in using the technology herein.

In one non-limiting example, Objects are specific elements that users can interact with via Commands. Example objects include:

Buttons

Links

Text fields

In one particular example, as detailed elsewhere herein, the “API” (Application Programming Interface) in the example non-limiting implementation provides a variety of functions, including:

The user could send their tests to the API, the API would run them, then the API would send them the results

The users could save their tests and results in the “cloud” (see Cloud below) by sending them to the API

The API could run multiple tests at the same time for a given user, saving them from setting up a network internally. The above are just examples of what an API could do.

In one example non-limiting implementation, the “API Passport” may comprise the few lines of code that will allow a developer to connect their local computer to the API. A version of API Passport is made available in various development languages (Perl, Java, Ruby, Python, etc.) to maximize the number of developers that can access the API.

In the example non-limiting implementation, the cloud is a group of servers, either housed internally or leased from a service, where users can run tests, save results, or perform other actions. The cloud can comprise various different configurations. In one particular non-limiting example, part of the cloud can comprise a third party service such as Amazon EC2 or other arrangements that provides on-demand or other “cloud” server instances. Such a third party cloud service could be utilized for activity. In one particular non-limiting example, an Amazon Machine Image (“AMI”) server “image” that can be used to create server instances with a pre-configured operating system and virtual application software used to create a virtual machine. An AMI or other cloud-based server facility can be set up so that only one user can access it, which may be appealing to clients concerned about security (banks, government, etc.). Other alternative configurations using other third party providers or other cloud-based arrangements are possible.

Example Non-Limiting Libraries

Considering that the example non-limiting embodiment can be used to test or automate multiple applications, and that different applications could have similar looking commands or phrases, it is useful to keep the commands and phrases organized per application. For example, a web browser command could be:

“When the “Cancel” button is clicked.”

Likewise, an Excel command could be:

“When the “Cancel” button is clicked.”

On the surface, the commands appear to be the same. But clicking the “Cancel” button in a web browser will allow the example non-limiting embodiment to use its web controls, while clicking “Cancel” in Excel allows it to use its Excel controls.

Therefore, in one example non-limiting embodiment, each application can have its own command library and phrase library. Separating the commands and phrases into individual libraries has additional benefits:

Users can subscribe to libraries for the applications that they will be testing.

Users can create custom libraries that consist of their own phrase shortcuts.

Command libraries will contain PBehave commands or an alternative library of vernacular commands that users need to interact with an application.

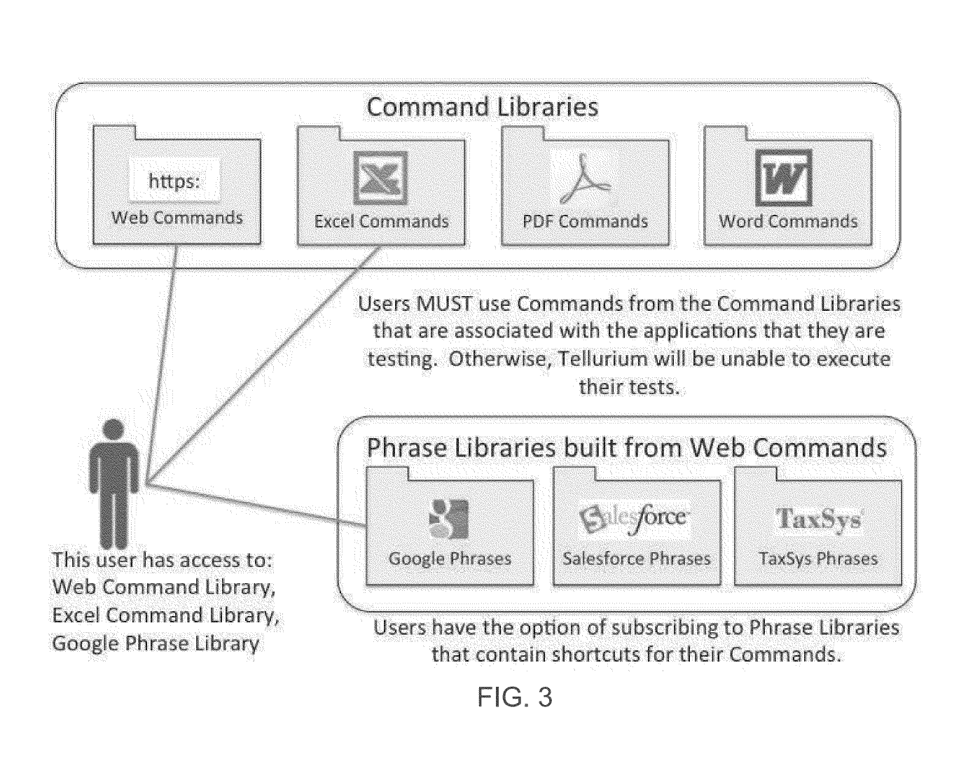

Phrase libraries will contain phrases that have been written using the commands, and are organized by application. See FIG. 3. For example, in one example non-limiting implementation, the user has access to a web Command library, an Excel Command library, a pdf Command library, a Word Command library, etc. Users use Commands from the Command libraries that are associated with the applications that they are automating. The user may also have access to a Google Phrase library, a Salesforce Phrase library, a TaxSys Phrase library, etc. Such Phrase libraries are built from web commands. Users have the option of subscribing to Phrase libraries that contain shortcuts for their Commands.

Each test will need to specify which library it is using (command, phrase, or a combination of commands and phrases) so that the example non-limiting embodiment knows which PBehave to execute.

Example Non-Limiting Sharing

Sharing is a useful feature for the example non-limiting embodiment. It allows users to create “communities” which will ultimately make the product more valuable. Sharing can happen in a few ways:

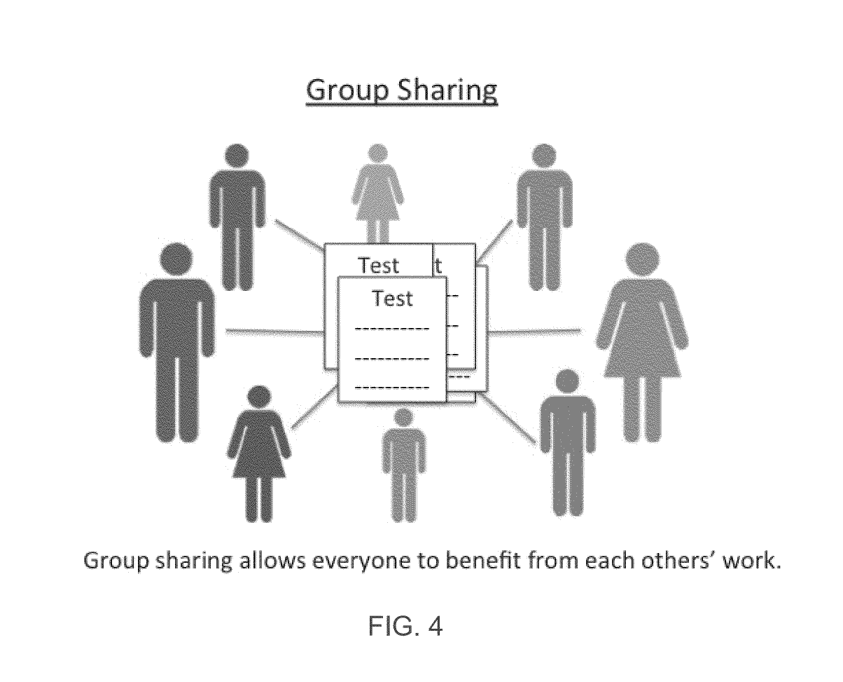

Group Sharing:
Users who work within the same company, or the same testing group, can share tests. This will lead to better coverage for their own application, and allow users from the group to modify, manage, run, and report on tests that were written by anyone else in their group. See FIG. 4 which shows how Group Sharing allows everyone in the group to benefit from each others' work.

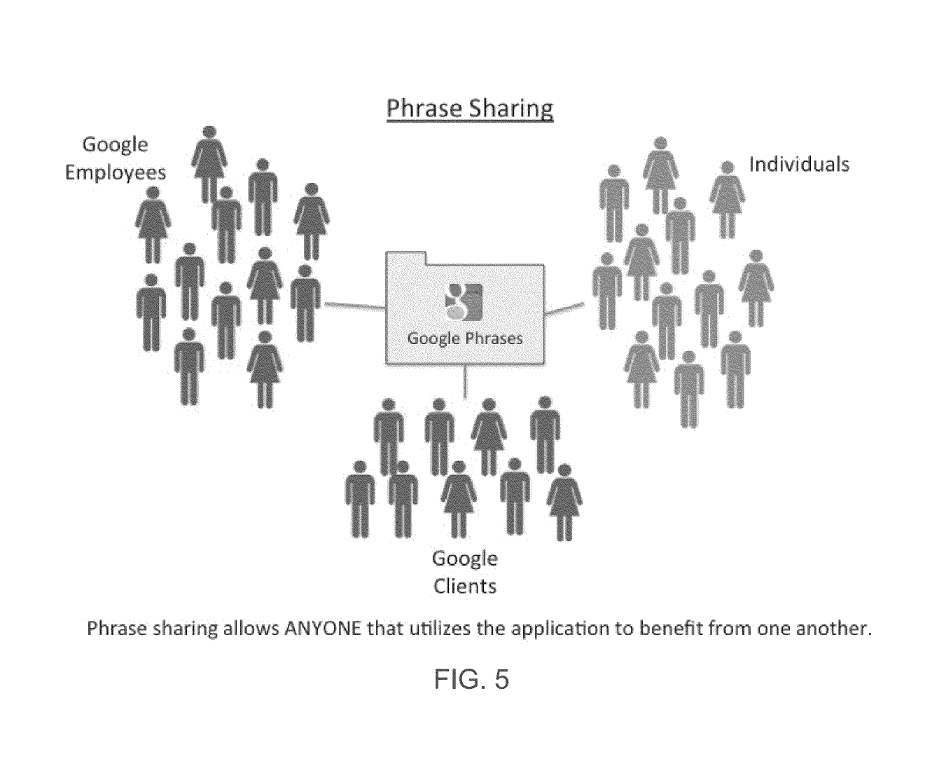

Phrase sharing:
Users that are testing the same application but are not in the same group (for example: a Software-as-a-Service company and their clients testing the same webpage independently of each other), can share their custom phrases via a phrase library. This allows all testers of the application to benefit from the work that the others are doing, and ultimately results in tests being written faster, and providing more coverage. See FIG. 5 which shows how Phrase sharing allows anyone that utilizes the application to benefit from one another.

Example Non-Limiting Public sharing:

Users may want to share tests and results with people outside of the application (for example clients, other testers, or other developers). This allows them to easily send tests or automations, results, screenshots, etc. to non-application users.

Example Non-Limiting Running Tests and Other Automations

Another feature of the example non-limiting embodiment is the ability to run tests and other automations. Since most tests and automations are comprised of phrases or commands, and all phrases comprise commands, all tests and automations can be converted into a series of executable commands. FIGS. 6-8 show an example using the phrases that are mentioned above.

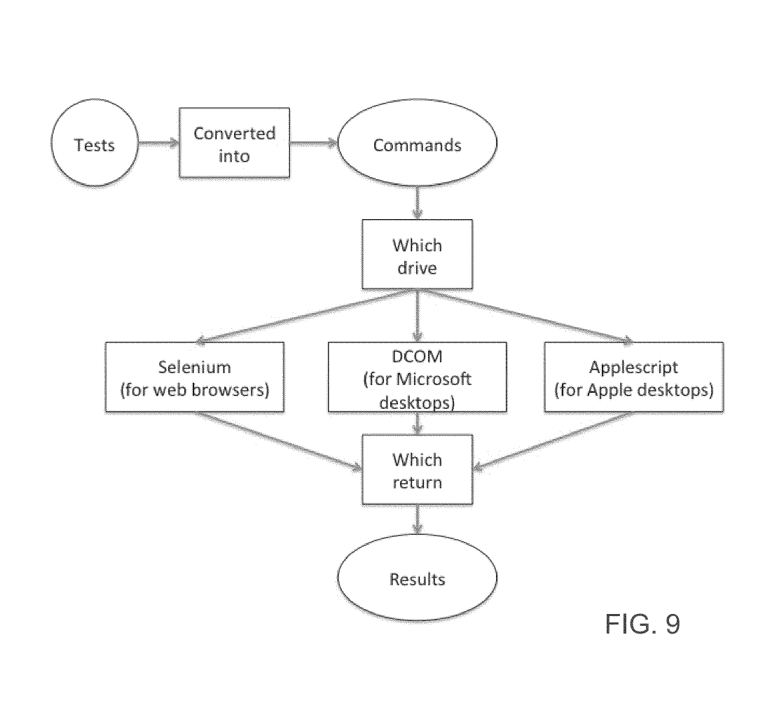

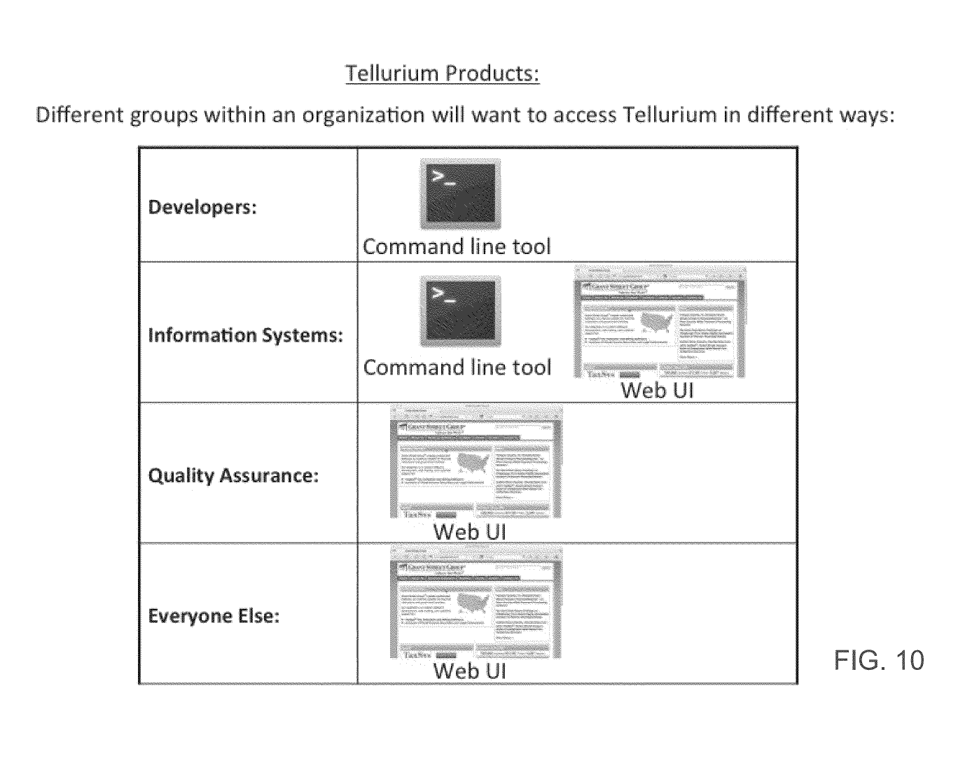

The example non-limiting embodiment takes the list of executable commands, runs them through a parser, and uses the output to control the type of application that is being tested. See FIG. 9 which shows an example non-limiting process that converts tests into commands which drive any of various systems such as a web application based testing tool such as Selenium, DOOM for Microsoft Desktops, Applescript for Apple desktops, or other tools for these or other platforms. For example, the Selenium tool may be run on a windows-based or other server to manage opening up a web browser such as Firefox, Chrome or Internet Explorer; takes in commands from another source such as computer 102 that sends it commands in a language that the Selenium tool understands; and sends back responses or results based on interaction with a web-based application through the browser. The tools return such results so computer 102 can review, analyze and display them. Any desired tools or functions or libraries for actually interacting with the web based applications (including but not limited to mobile applications) can be used since PBehave is independent of any such tools.

Example Non-Limiting Program Controlled Operation

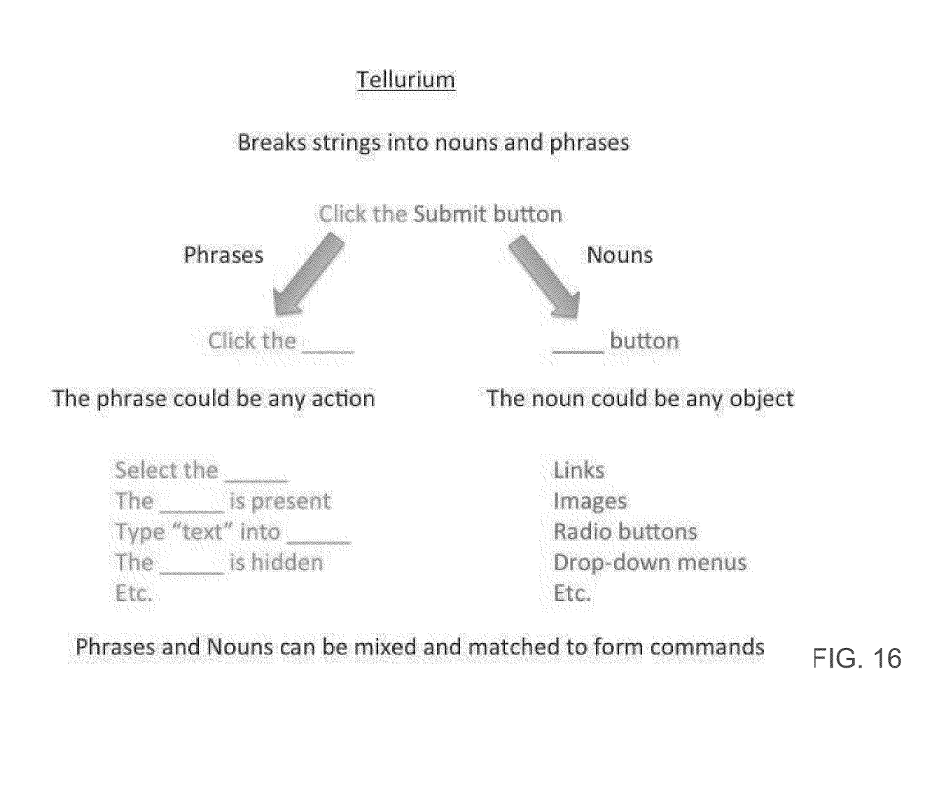

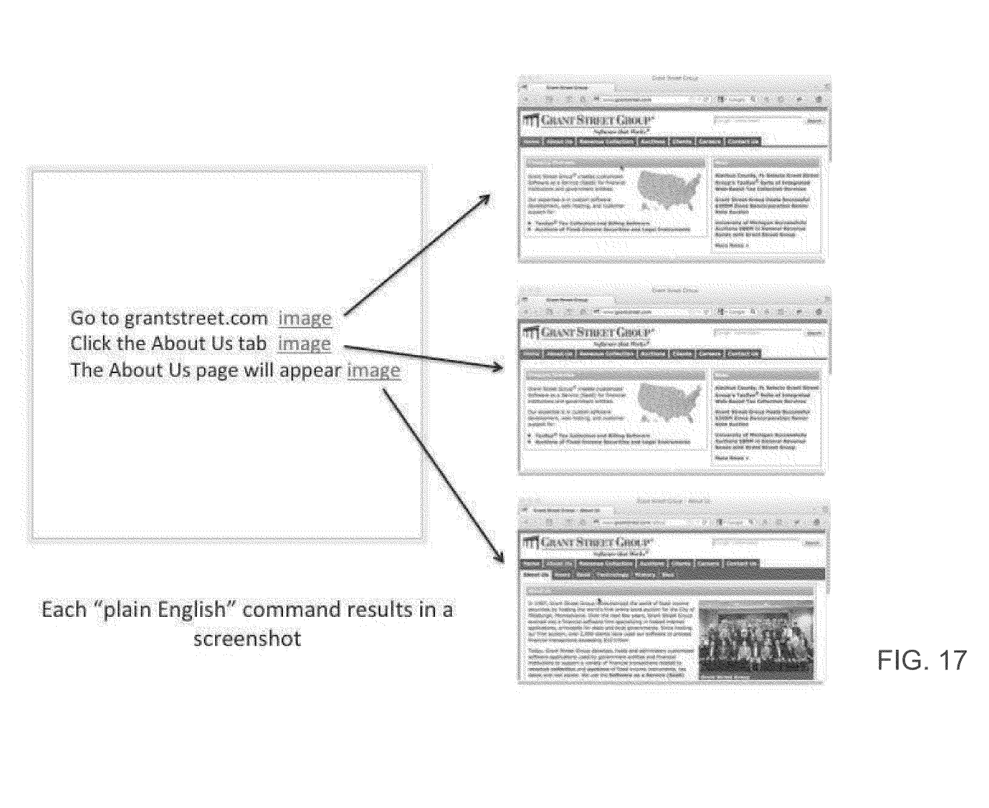

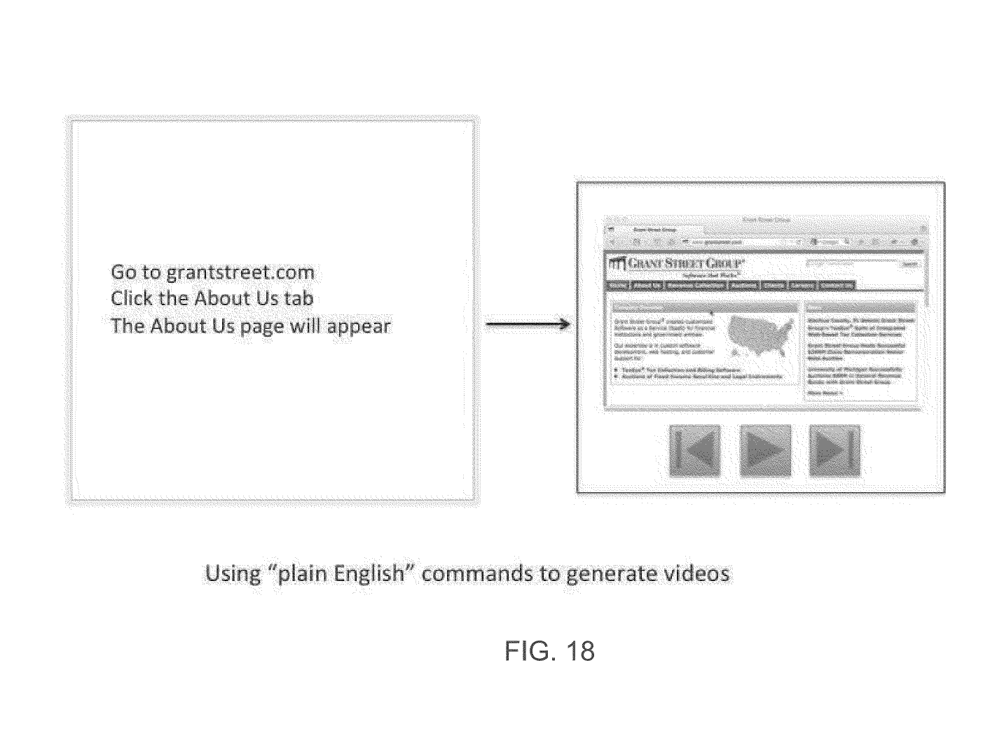

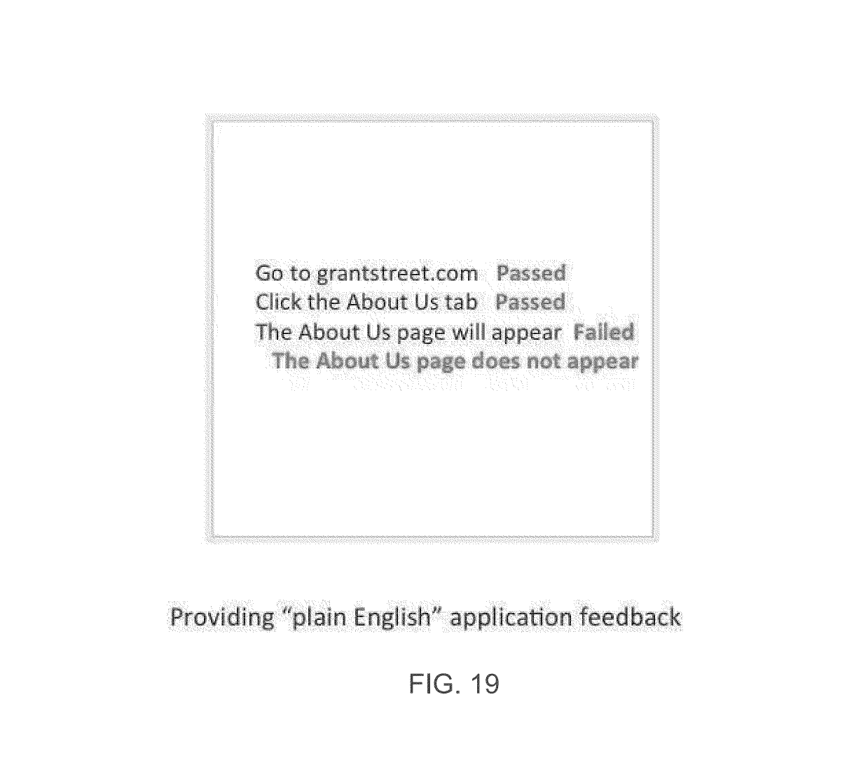

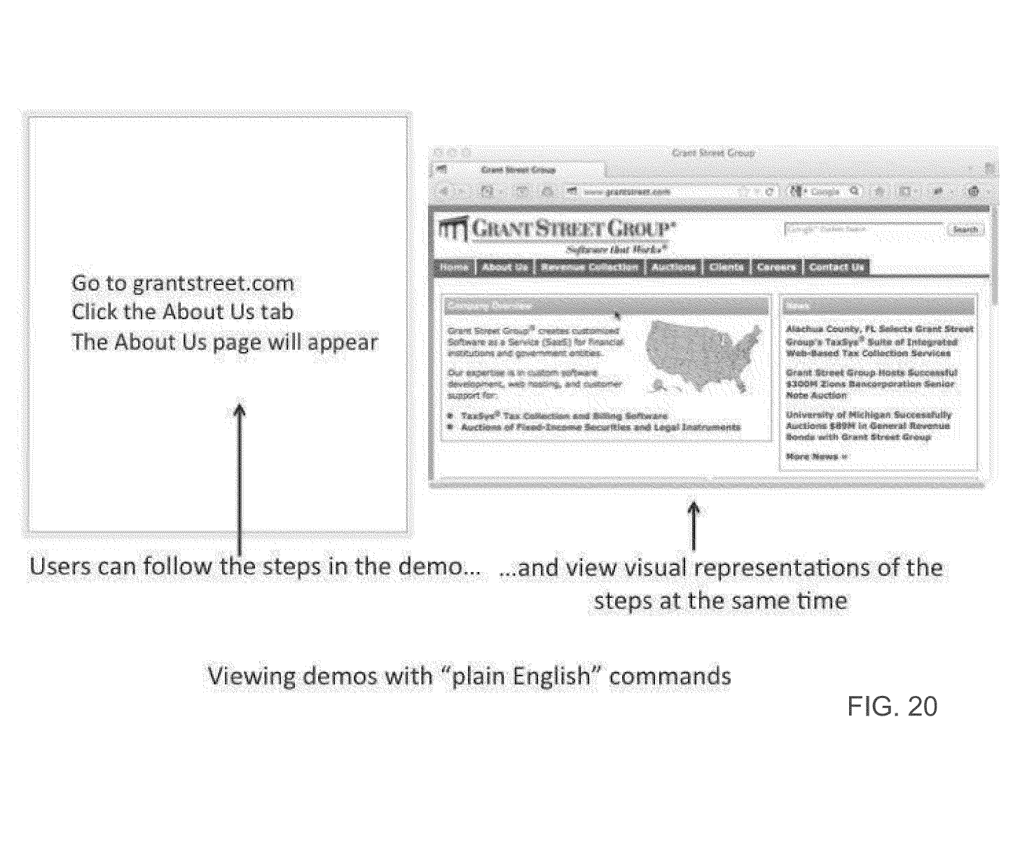

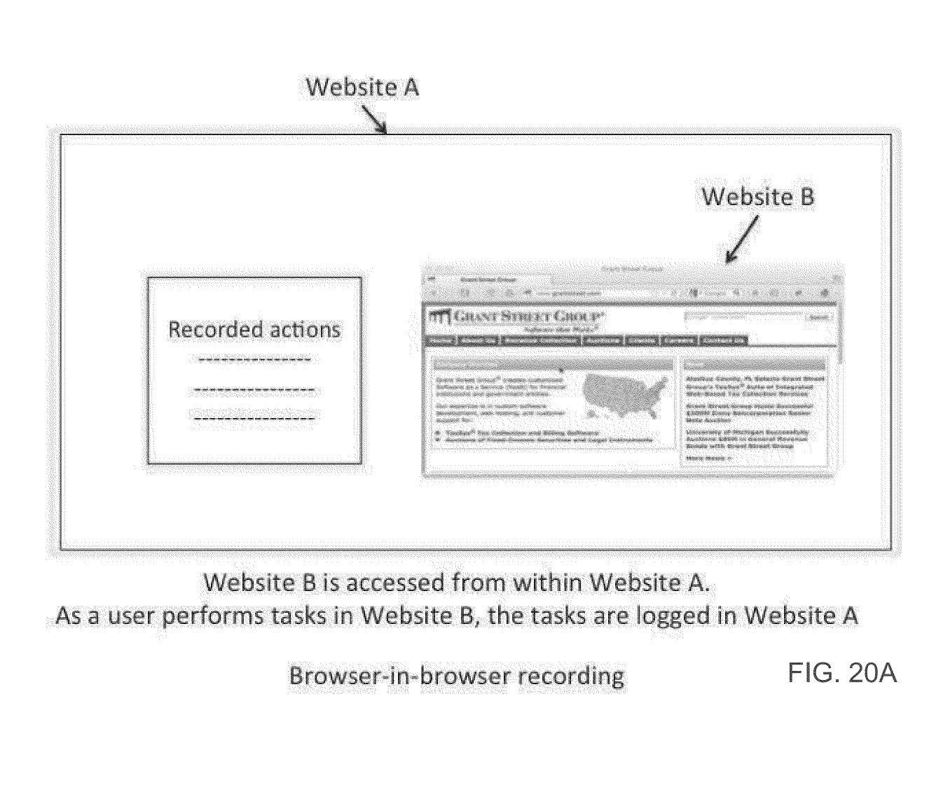

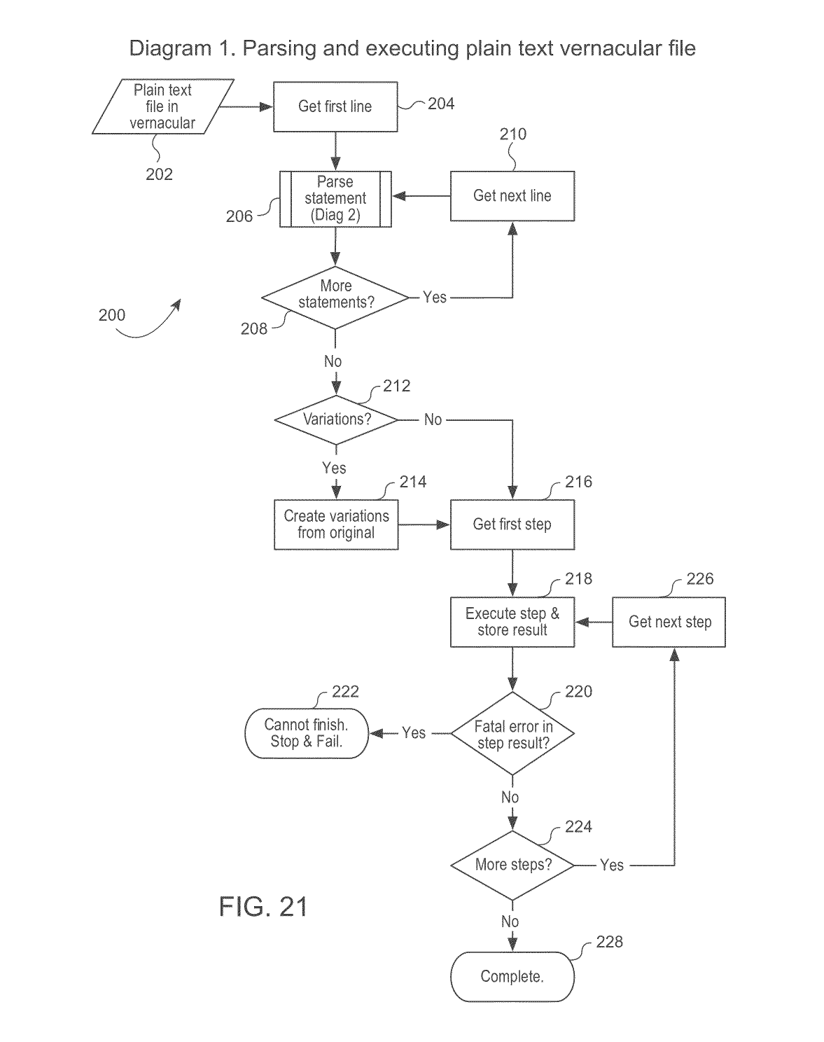

FIGS. 21-25 show example program control steps performed by computer 102 to provide example non-limiting parsing of an input automation program. In the example shown, the FIG. 21 routine accepts plain text file (or real time) input in vernacular such as may be written or represented in a plain English language such as PBehave (block 202), and gets the first line (204). The routine parses the statement (206) and determines if there are more (206). One example parser may for example break strings into nouns and Phrases. For example “Click the submit button” can be broken into the Phrase “Click the ______” and the Noun “button.” In this example, the Phrase could be any action such as “Select the ______”, “The ______ is present”, “Type ‘text’ into ______”, “The ______ is hidden”, or the like. The Noun could be any object such as Links, Images, Radio buttons, Drop-down menus, or the like. Phrases and Nouns can be mixed and matched to form Commands. See FIG. 16.

Once there are no more statements (208), the routine determines if there are variations (212). Such “variations” can for example be deviations from strict constructions of PBehave commands or “nouns” (or otherwise) and the system resolves what the user intended if there are, the routine creates variations from the original (214). For example, a persona table could be used to provide external global data that is stored securely and separately from the test itself. In this way, login IDs and passwords can be employed but stored securely in a separate secure storage that is not accessible simply by looking at the PBehave for the test or other automation. Updating the persona table can be done once and are resolved using “variations” whenever a test that accesses the table is run. Such variable tables can be used for any variables in PBehave to specify URLs, sites, IDs, users, passwords, contacts or other variable data. Many tests or automations can be resolved based on literals stored in a common variation table.

Otherwise, the routine gets the first step (216) and executes that step and stores the results (218). If a fatal error results (220), the routine cannot finish and will stop and fail (222). Otherwise, step 218 is performed repeatedly until there are no more steps (224, 226, 218).

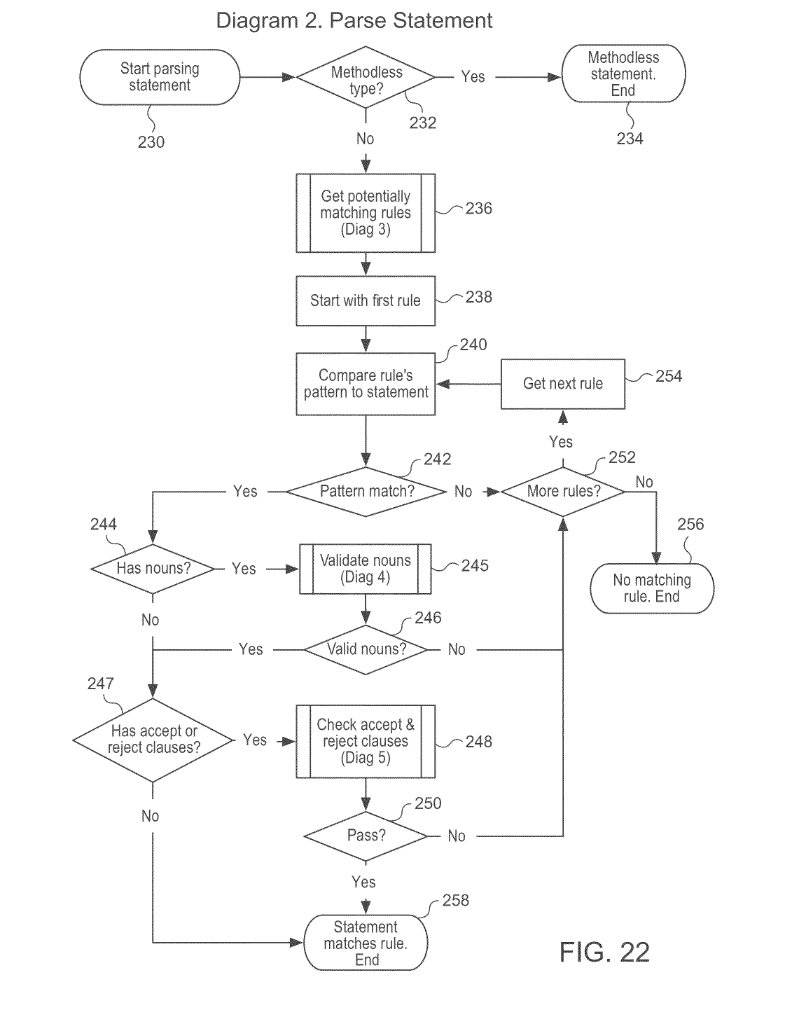

FIG. 22 is an example non-limiting routine to parse a statement. Once a statement is presented (230), the routine determines whether it is a methodless type (232). “Methodless” statements (232) are those that are placeholders and do not require any commands to be run, such as “End” indicating that an “If/Else” block has ended. If so, then the routine declares a methodless statement and ends (234).

Non-conforming statements are checked against alternative forms of the commands. For example, “Then . . . is visible” is an alternative to “Then . . . is not hidden.” If no alternatives can be matched, then an “unknown command” error (256) will be returned for the non-conforming statement. Otherwise, the routine gets potentially matching rules (236). Starting with the first rule (238), the routine compares the rule's pattern to a statement (240). If the patterns match (242), the nouns are validated (244, 246). If the nouns are valid, then the routine checks accept and reject clauses (248) to see if they pass (250). If they do, the statement matches the rule and the routine ends (258). Otherwise, the routine looks for more rules (252). If no more rules, then there is no matching rule and the routine ends (256). Otherwise, the routine continues to iterate until one of the execute points is reached.

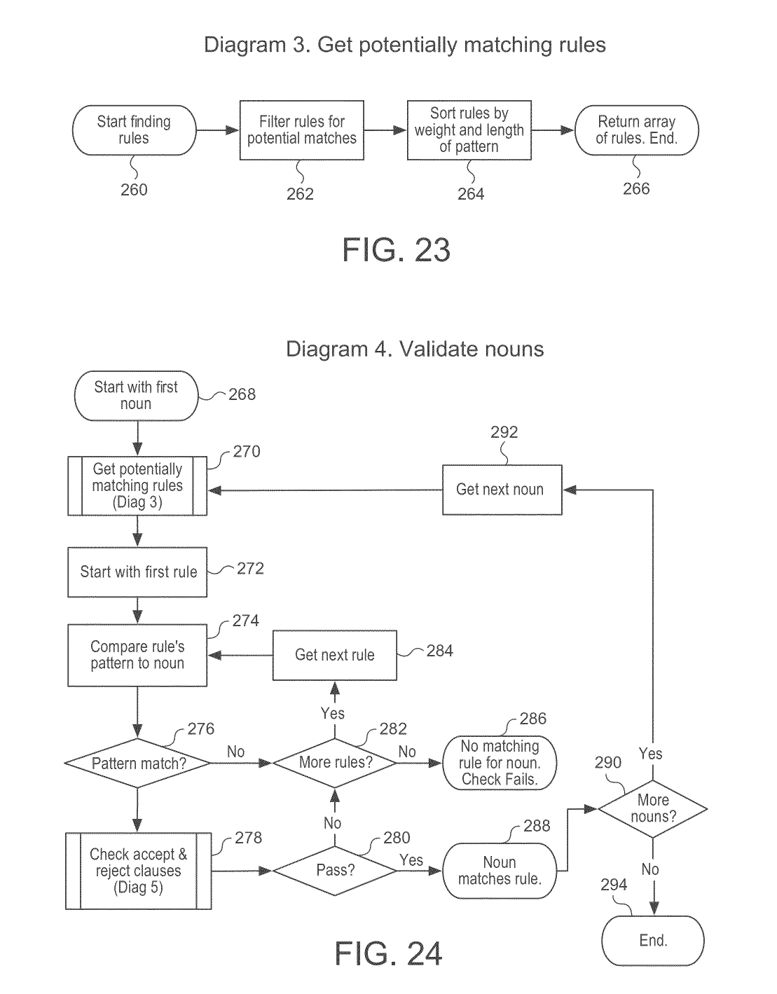

FIG. 23 shows an example non-limiting routine to get potentially matching rules. The routine starts finding rules (260) and then filters rules for potential matches (262) and sorts them by weight (higher weights having priority) and length of pattern (longest patterns having priority) (264). The optional weight parameter can force a rule to be evaluated before others to prevent mismatches. The routine returns an array of rules (266).

FIG. 24 shows an example non-limiting routine for validating nouns. In this example, the routine starts with the first noun (268). It gets potentially matching rules (270) and starting with the first rule (272) compares the rule's pattern to a noun (274). If the patterns match (276), the routine checks accept and reject clauses (278) and then determines whether there is a pass (280). If not, more rules are retrieved (282) and applied (284) or the routine fails (280). The iterations continue until there are no more nouns (290, 292).

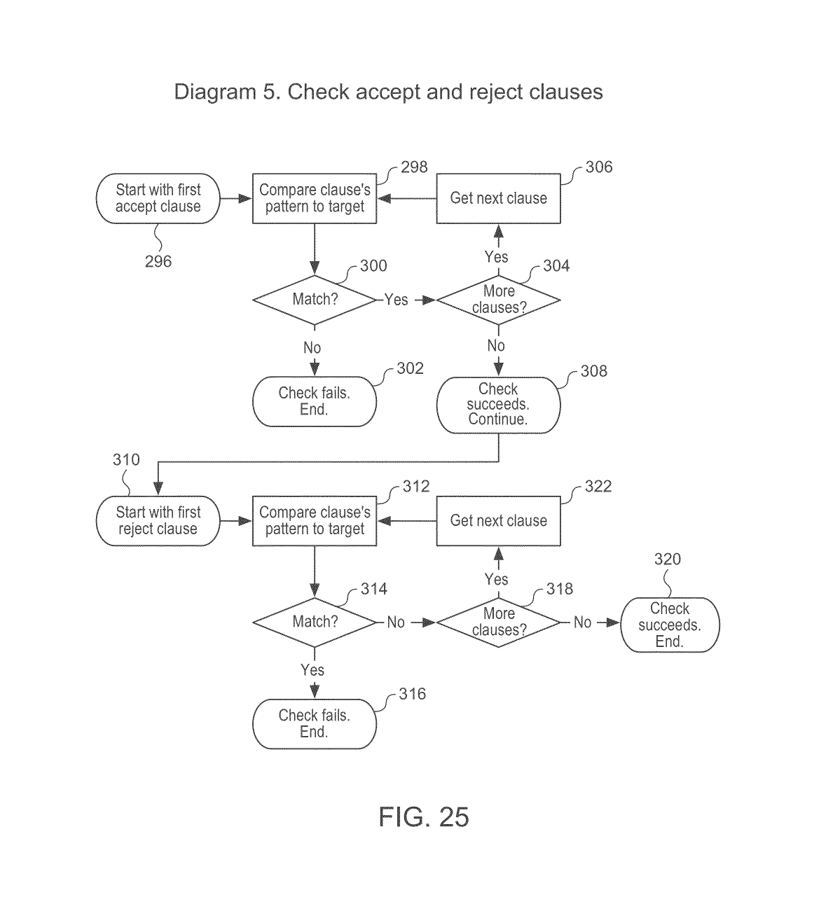

FIG. 25 shows an example non-limiting routine to check accept and reject clauses. In this routine, the clause's pattern is compared to a target (298). If there is a match (300), then more clauses are determined and retrieved (304, 306). Once there are no more clauses, then the check succeeds (308), and the routine starts with the first reject clause (310) and compares the clause's pattern to a target (312). If there is a match (314), then more clauses are retrieved and processed (318, 322). Otherwise, the check succeeds and ends (318, 320).

Example Non-Limiting Automation

To promote ease of use, the example non-limiting embodiment includes functionality that provides users with the ability to schedule tests or other automations to run automatically, and receive the results via email or other electronic means. Tests could be scheduled to run annually, monthly, weekly, daily, hourly, or various combinations of each. This allows close monitoring of a website or other application to exercise it in a desired manner on a desired prescheduled time.

The result of the test run is raw data. Such as:

What date/time were the tests run?

How long did it take for the tests to run?

Did the application produce the expected results?

If the expected results did not occur, what happened?

Who ran the tests?

What browser/OS was used for the tests?

Other

The result data is extremely useful if written in a way that makes sense to non-developers. Therefore, the example non-limiting embodiment includes functionality to display the results as reports.

In this example non-limiting embodiment, the parser is written in Perl. Other embodiments of the parser written in other languages are contemplated. Other embodiments of the parser have the ability to recognize phrases or part of phrases that are written in other languages and can be called from within or outside of Perl or another programming language.

Example Non-Limiting Reports

All work users put into writing Phrases and tests is so that they can get meaningful feedback about how the application is performing. This is handled through standard and custom reports.

Standard reports can contain basic information, such as:

Did the test pass or fail? Why?

How long did it take the test to run?

Who ran the test?

How does this test run compare to the previous test run? All previous test runs?

How long did it take each page to load? Where is the biggest lag in the application?

When is the next scheduled test run?

How did the test perform using various operating systems or browsers?

Additionally, the example non-limiting embodiment includes functionality so that users can create custom reports for things like:

What users are writing tests? How long does each test take to complete?

An audit log of all changes to each test, what the change was, who made the change, and when?

Any specific data that needs to be presented to auditors.

How often each test is being run, and the disk space and computing power each run requires. Projections of how much disk space will be required to run upcoming scheduled tests.

All reports are downloadable in Excel, PDF, RTF or other convenient formats in one example non-limiting implementation. They will also be customizable so that each user can create their own cover page, and format for the download.

Non-Limiting Example

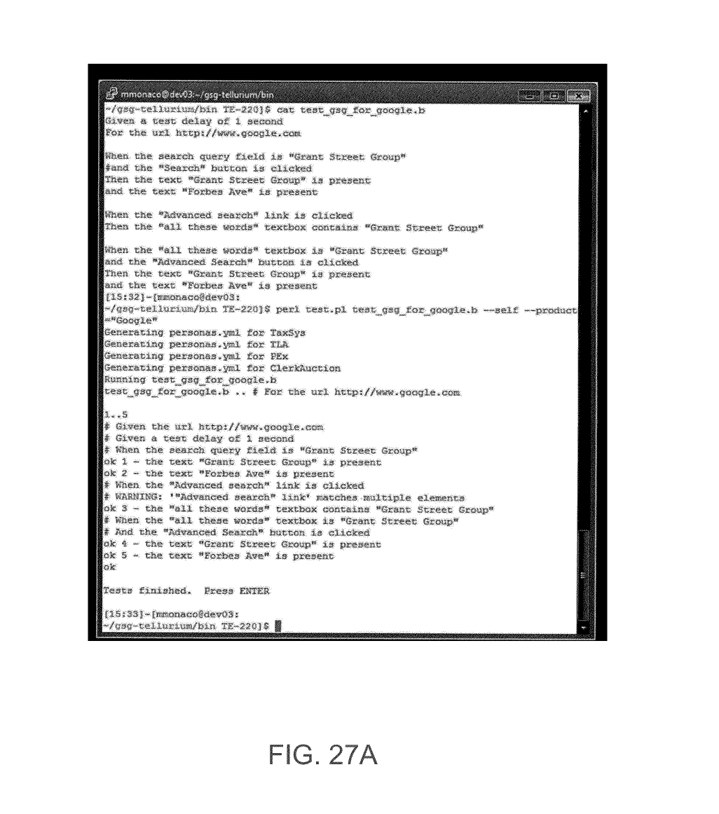

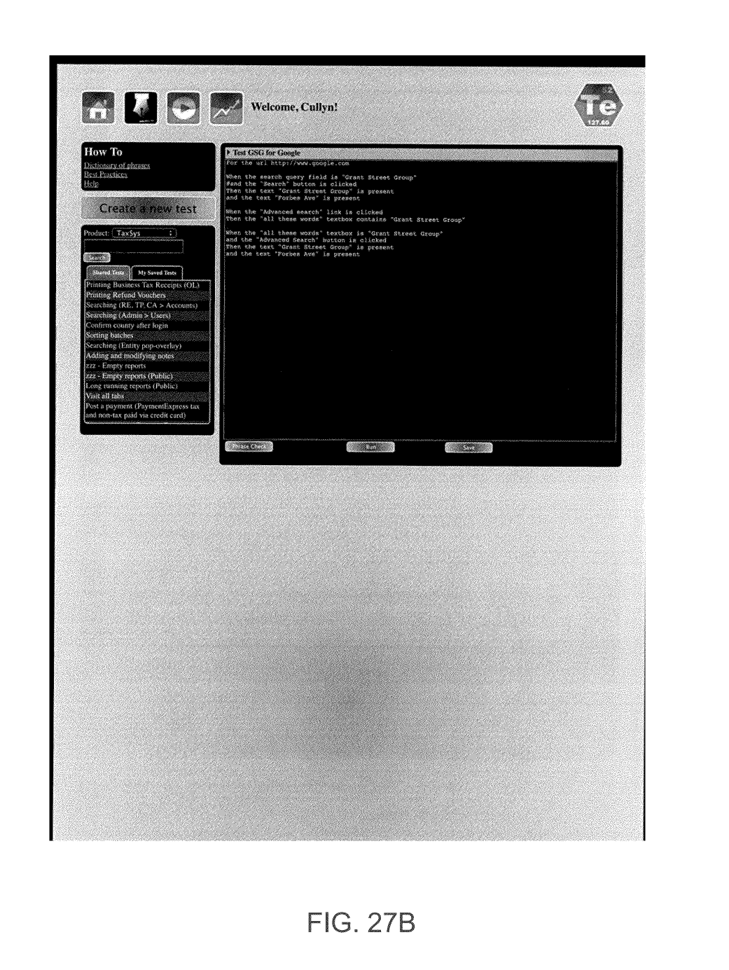

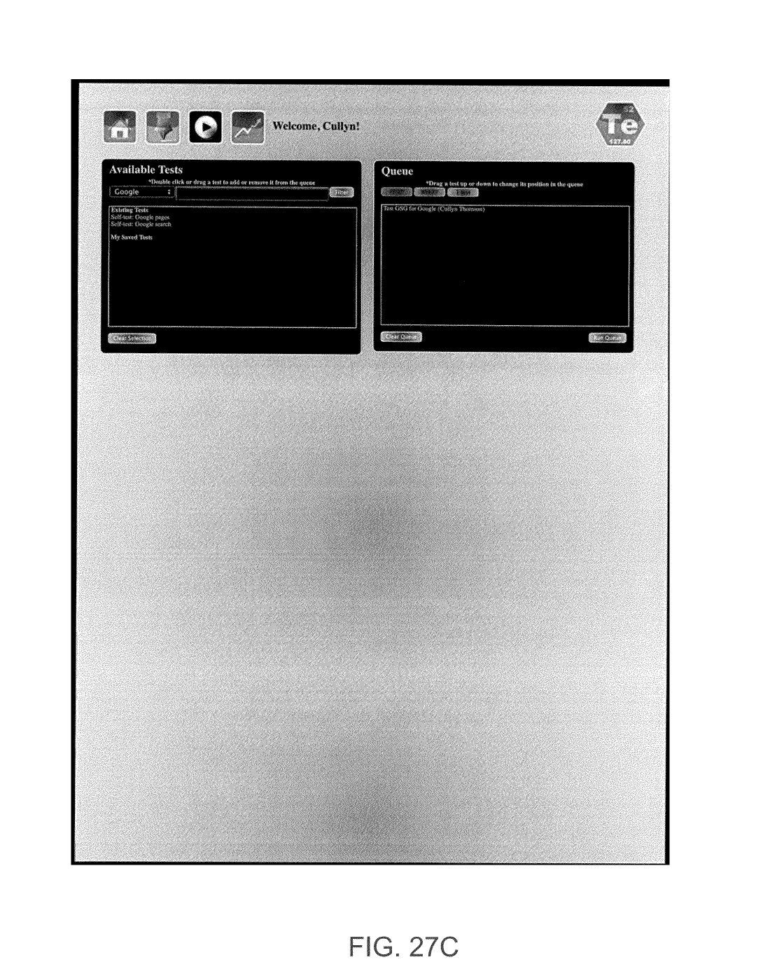

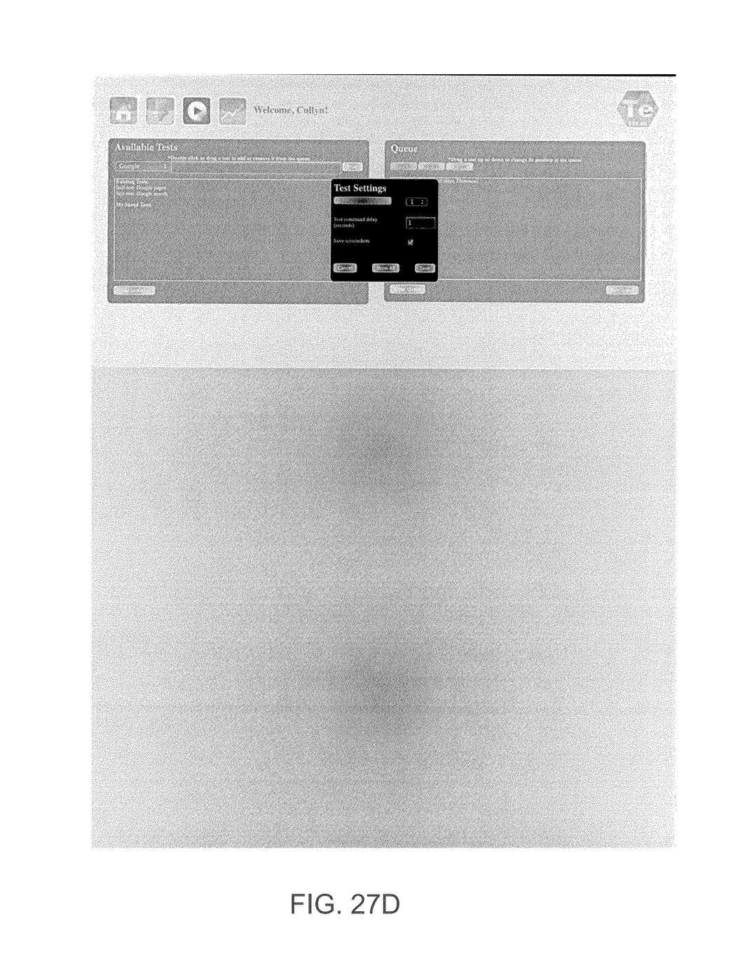

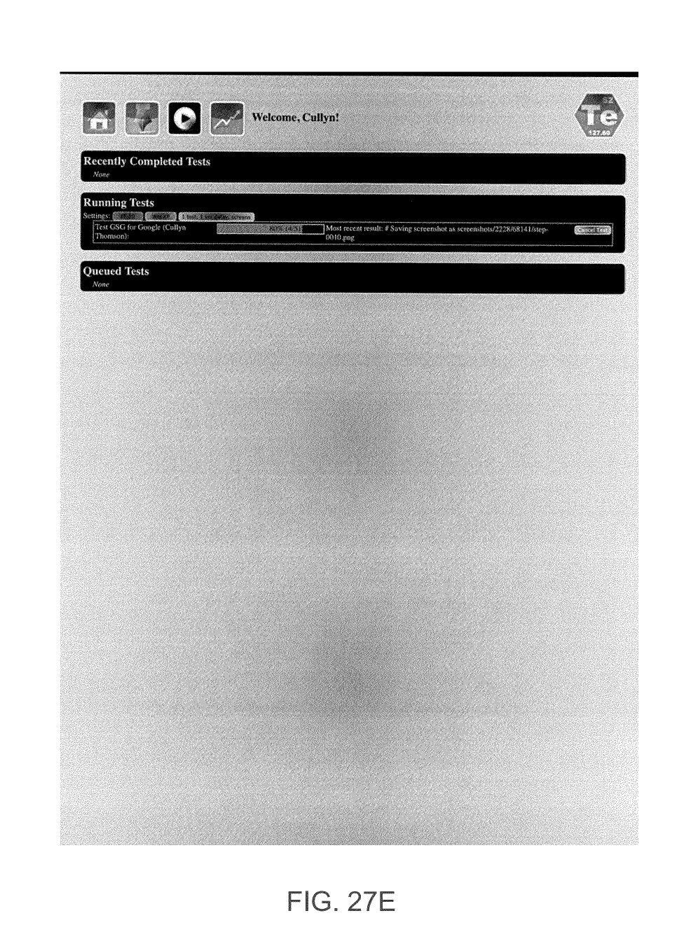

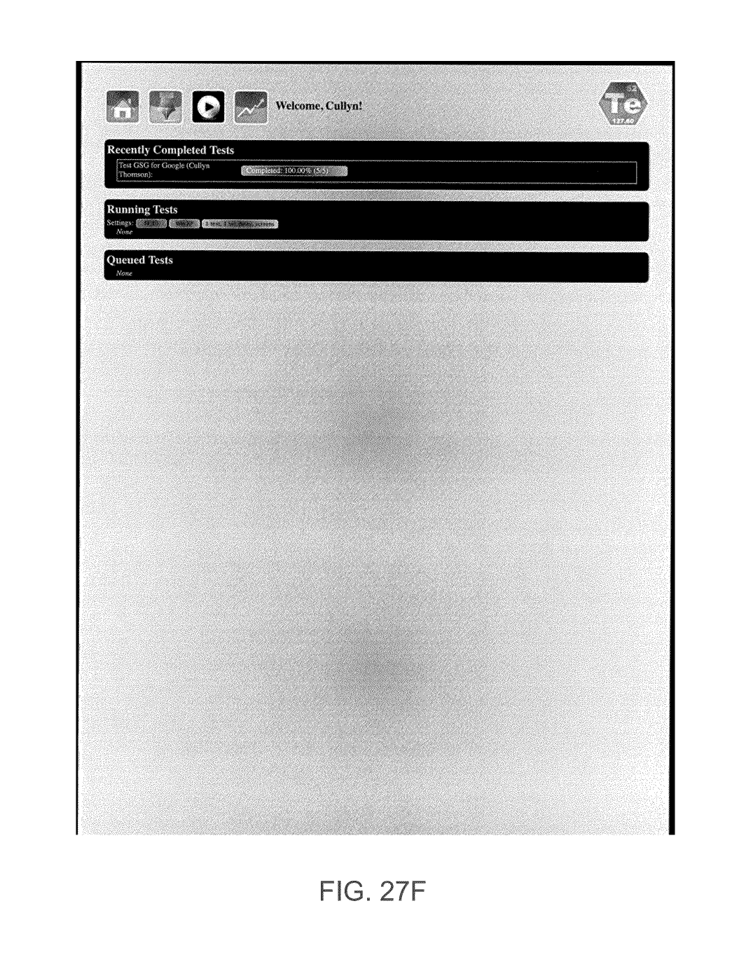

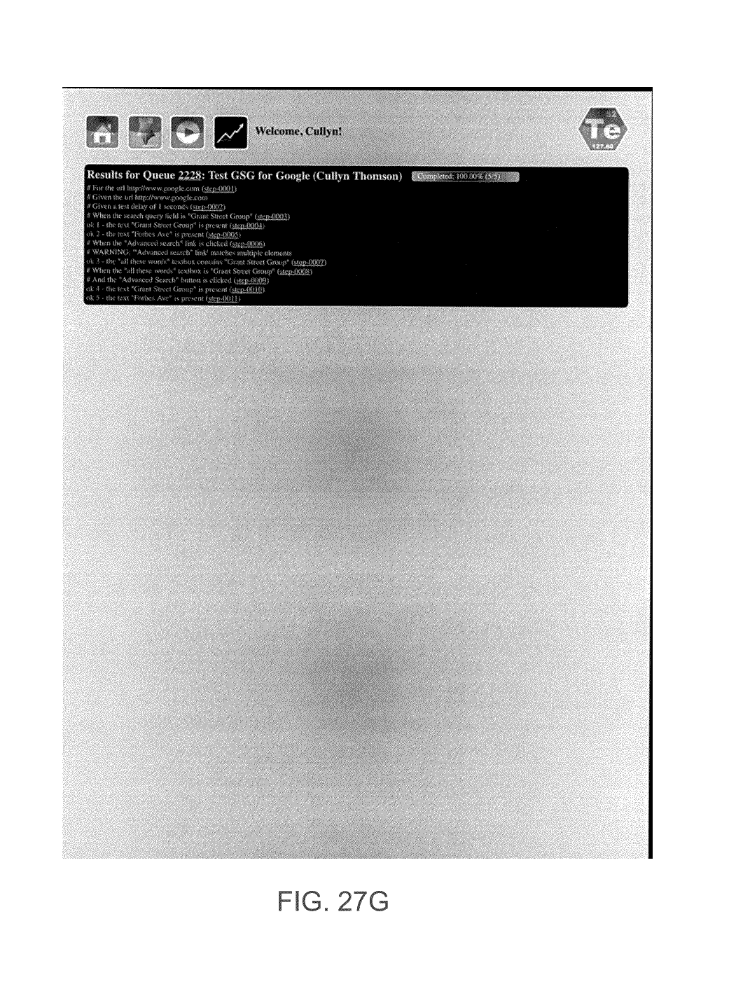

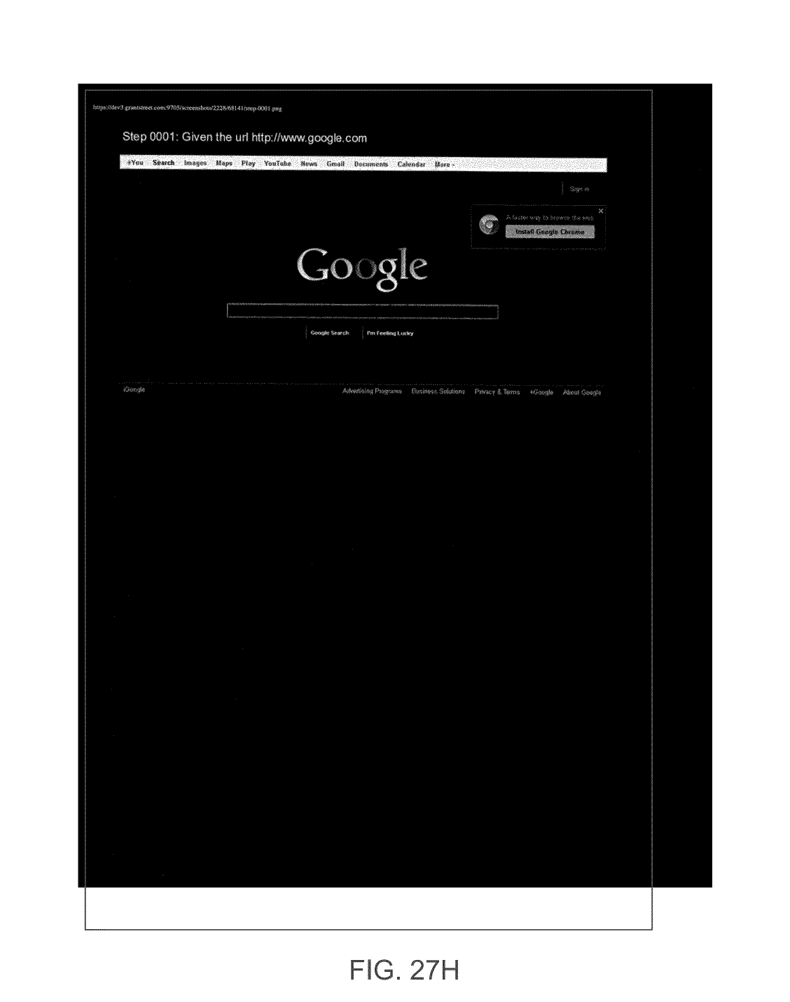

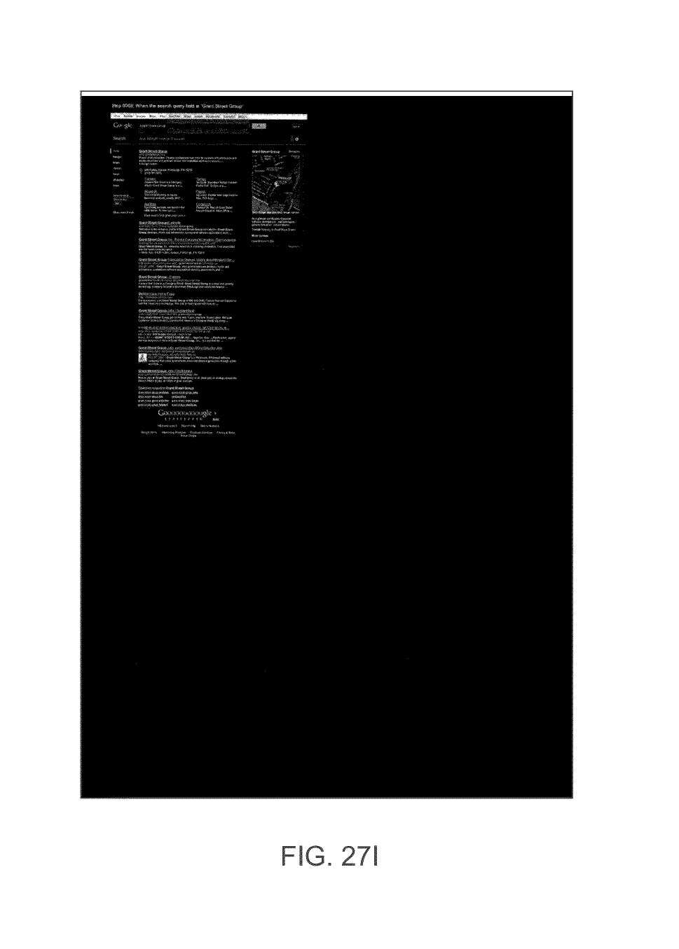

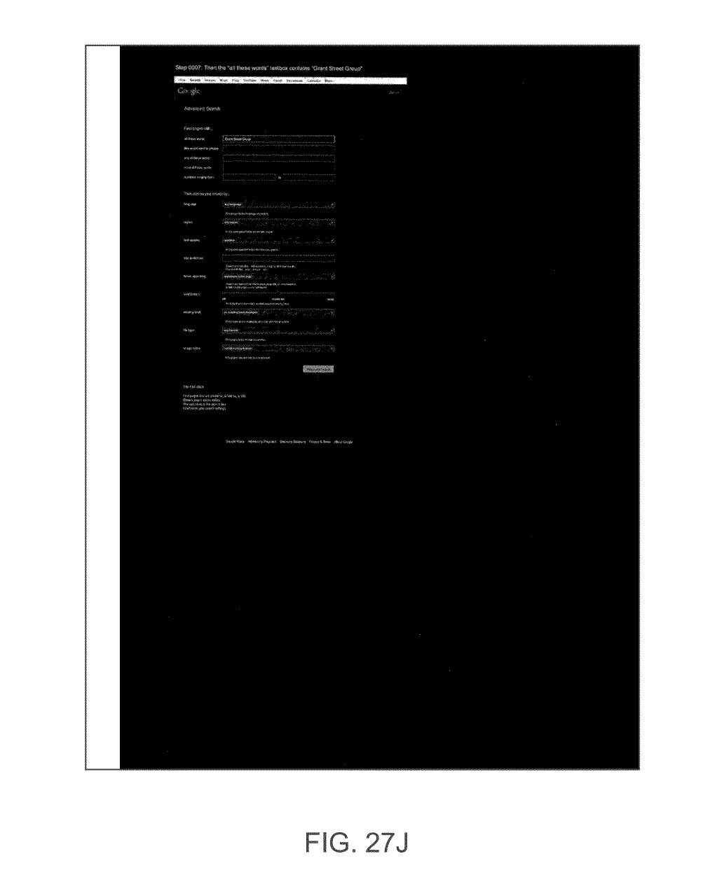

FIG. 27A is an example screenshot of a test, the running of the test, and the results from the API. In this particular instance, the example test is to provide input to a search field of the Google search engine website. Note the sequence of plain vernacular commands used to provide the automation. This particular example non-limiting screen output capture repeats the plain vernacular commands as the automation is being performed and provides status or feedback messages such as “generating personas . . . ”, “Running test_gsg_for_google.b” and “ok”. This provides an interactive feedback capability that can alert the user in real time as to the results of the automation. FIG. 27B is an example screenshot of the same test on an internal application such as a website. Note the “dictionary of phrases” on the upper left-hand corner that can be clicked to provide a dictionary of prestored phrases for possible use by the user.

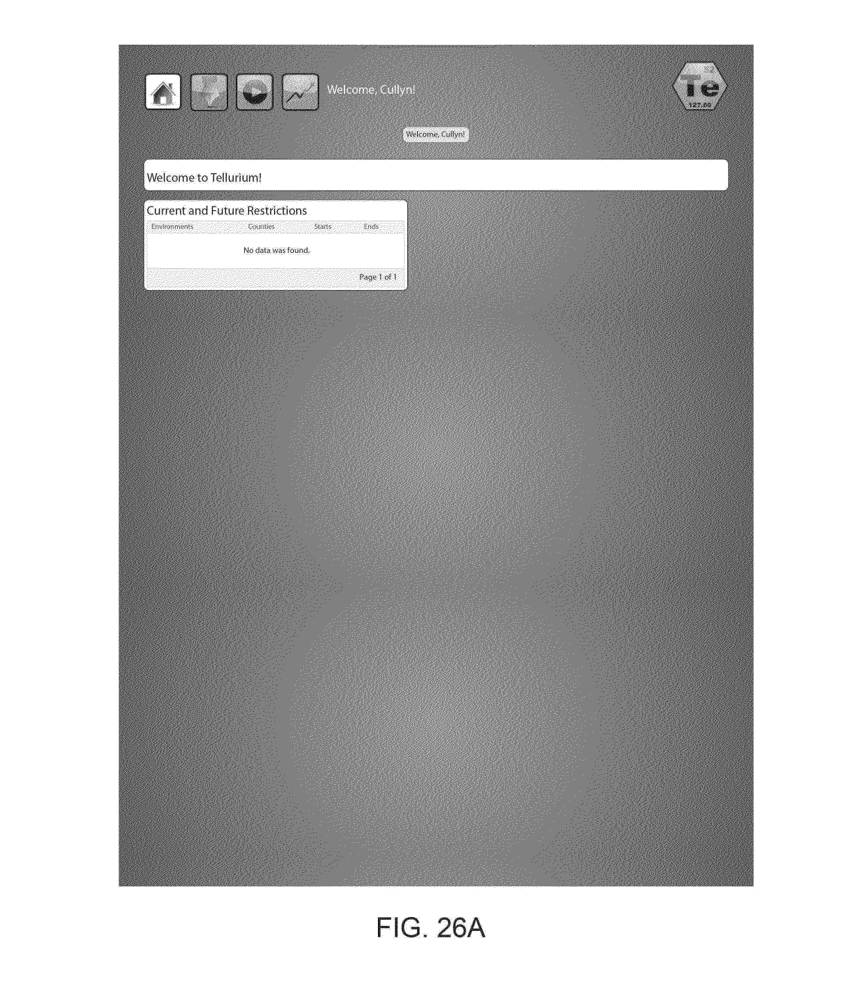

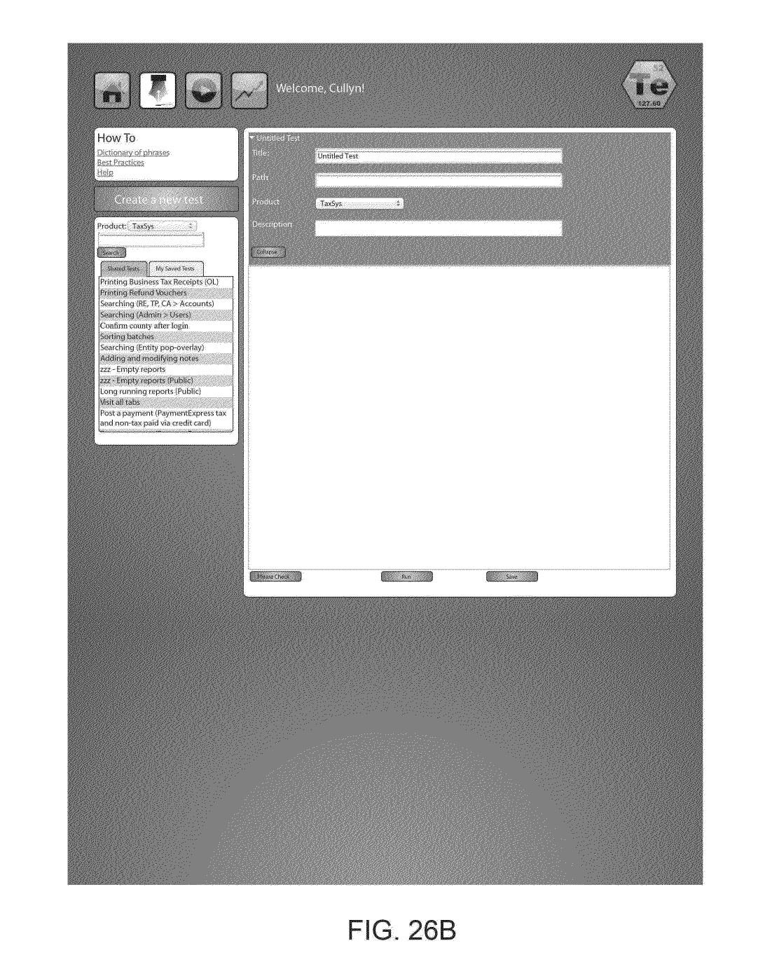

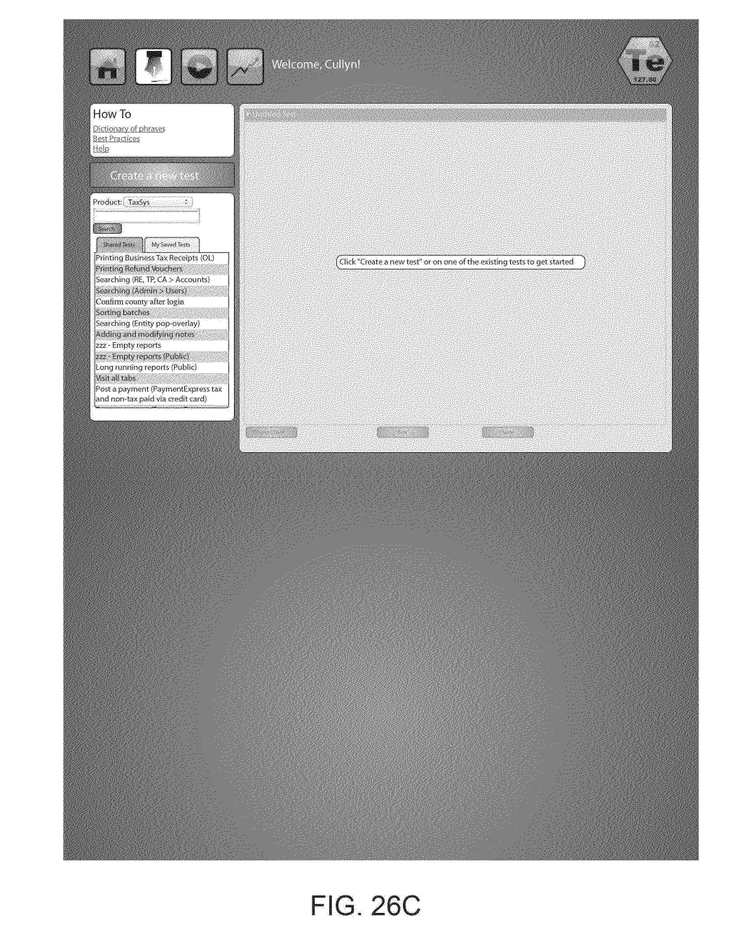

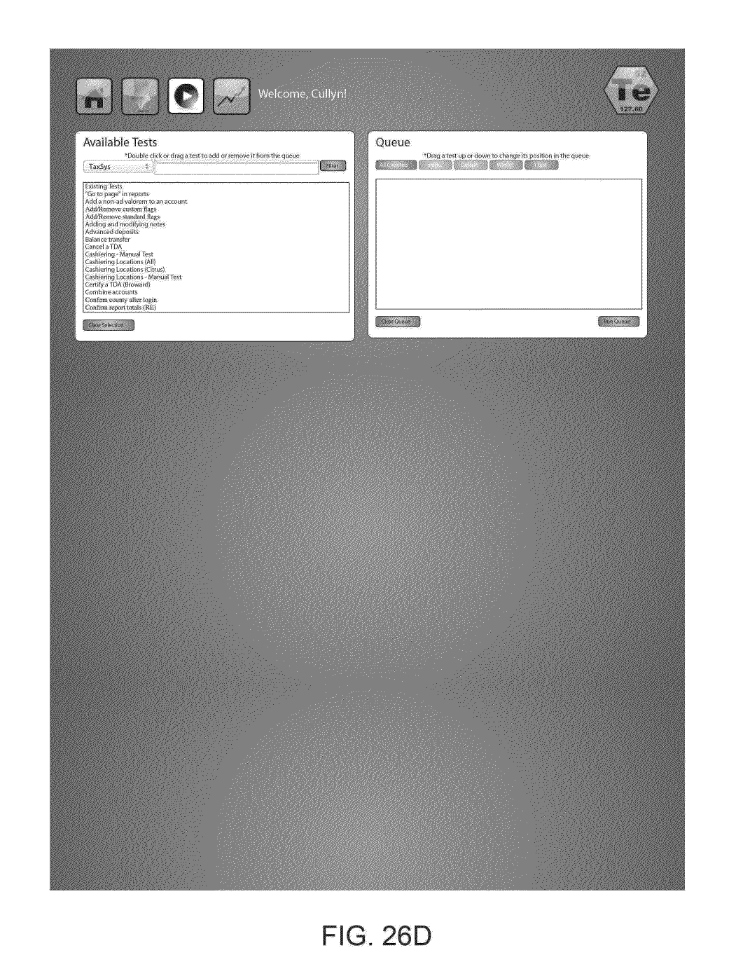

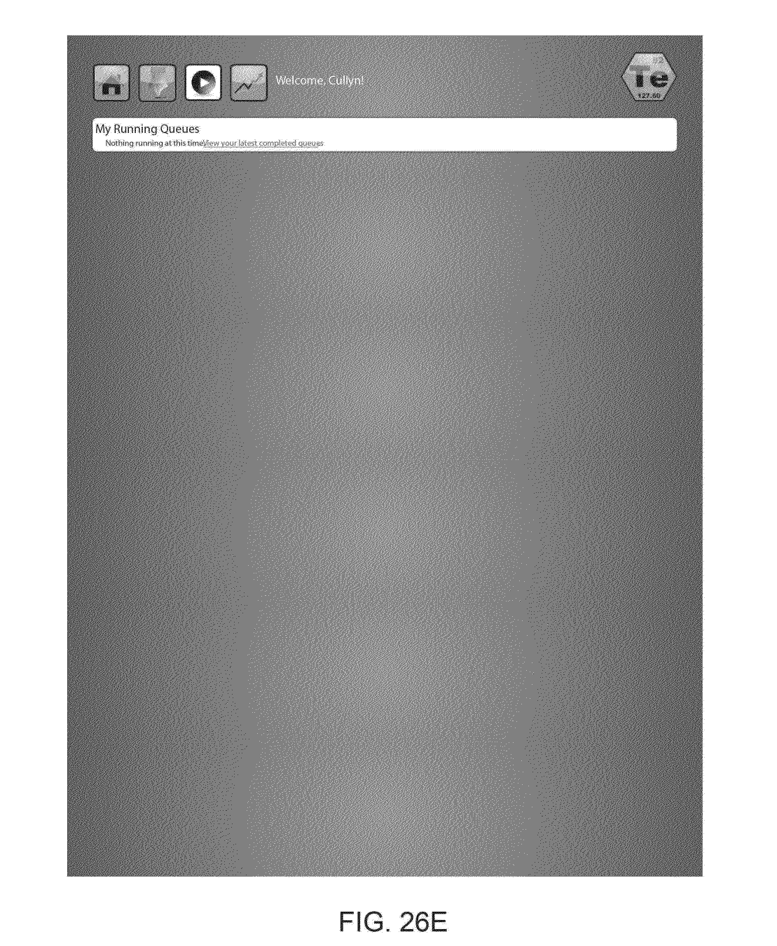

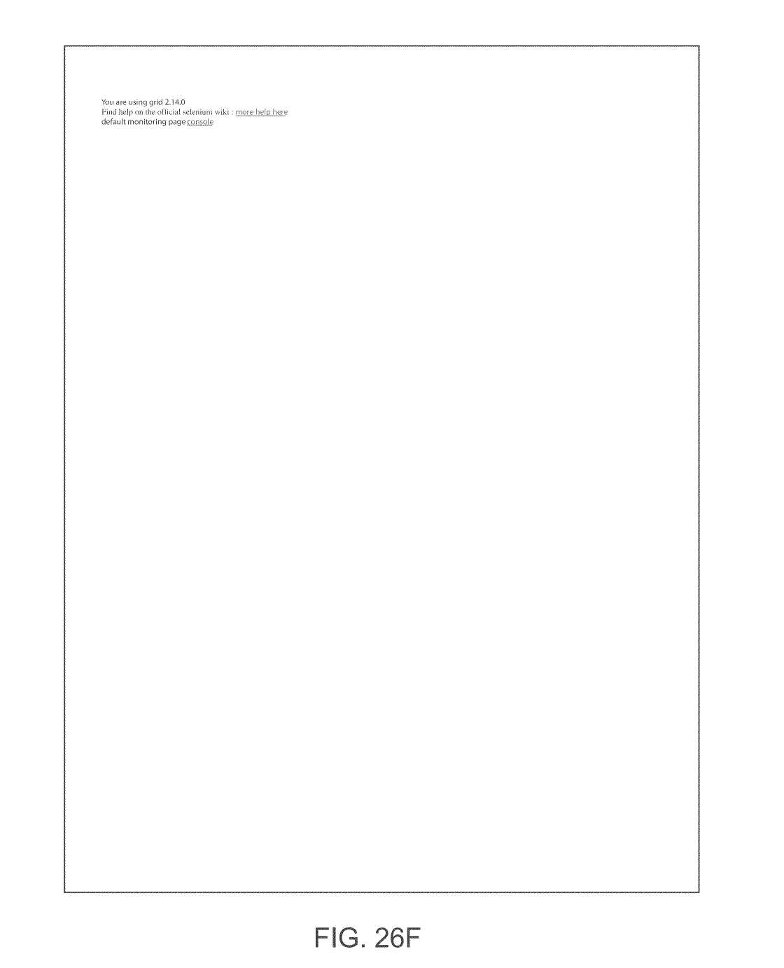

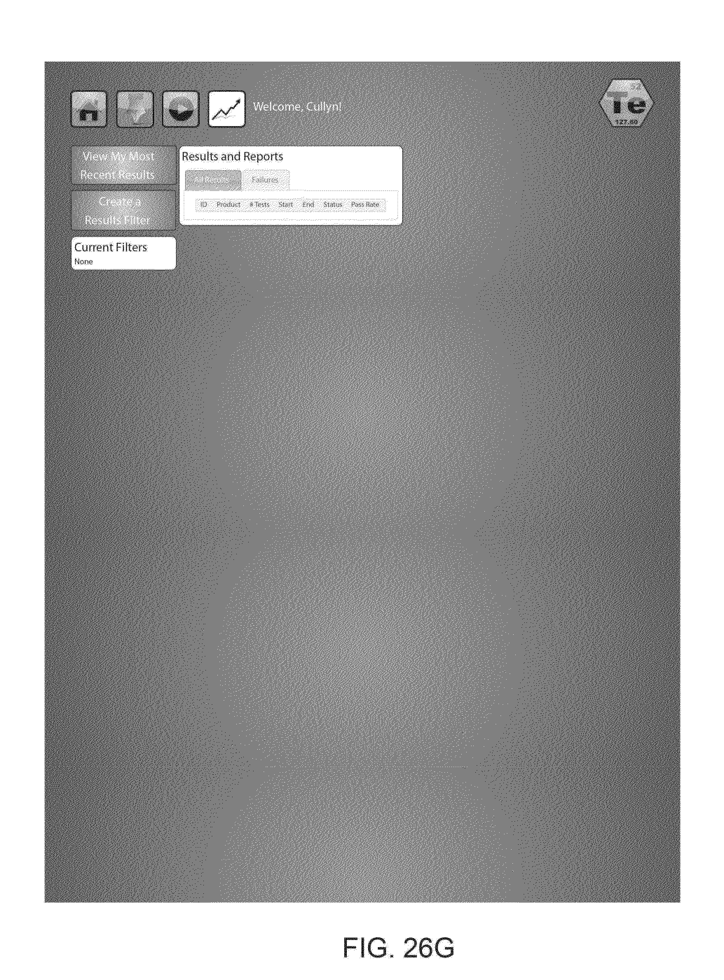

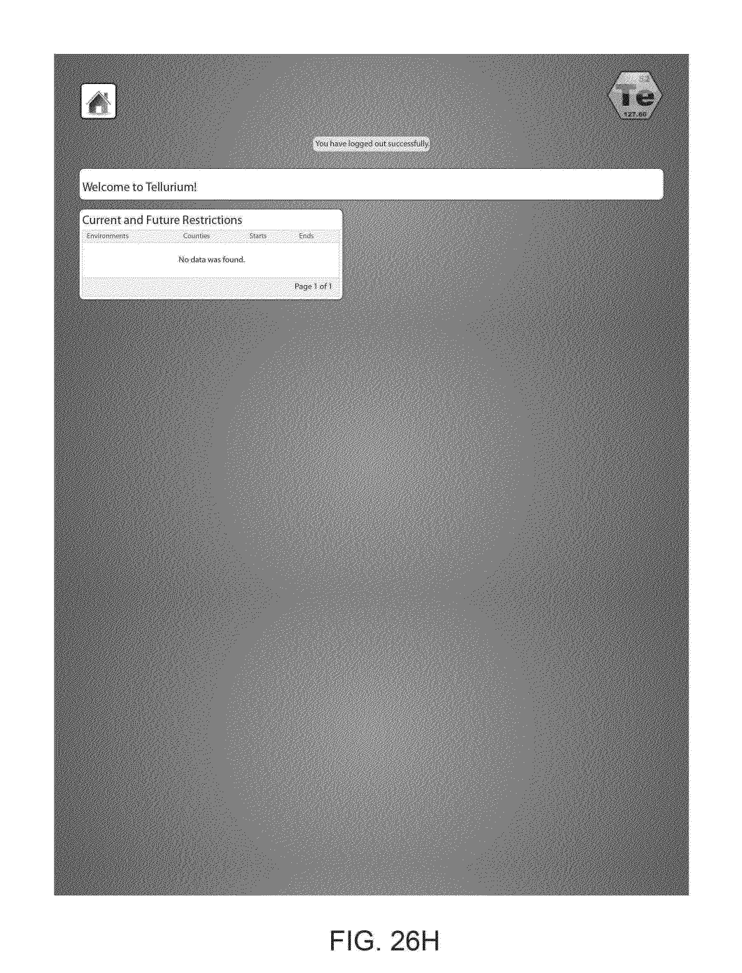

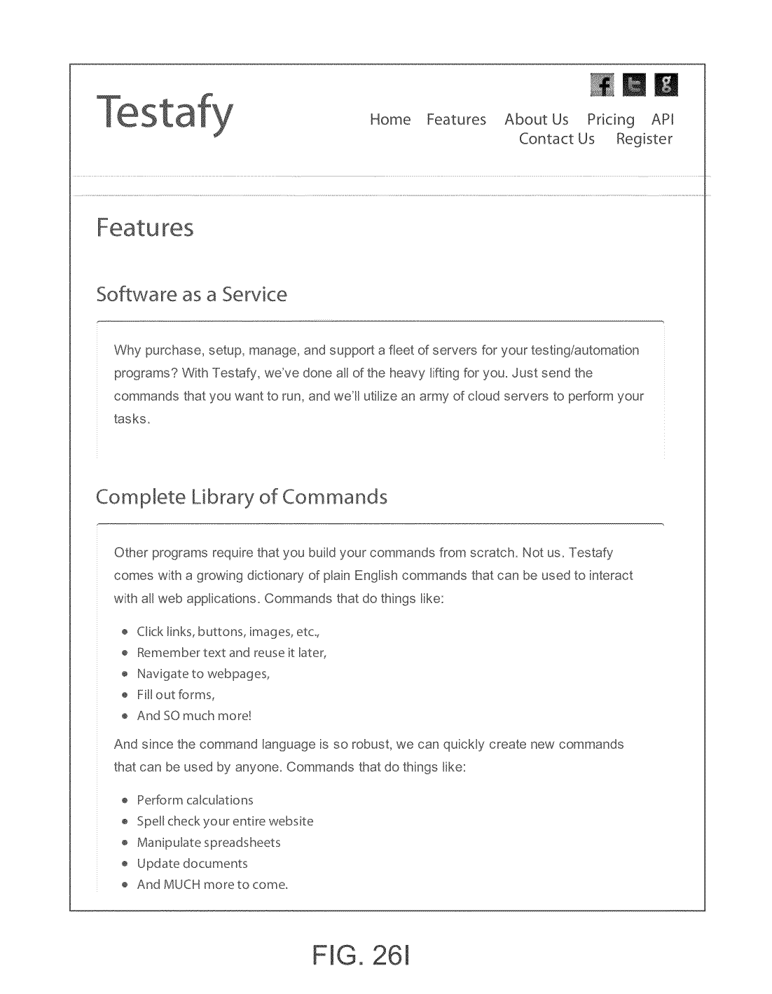

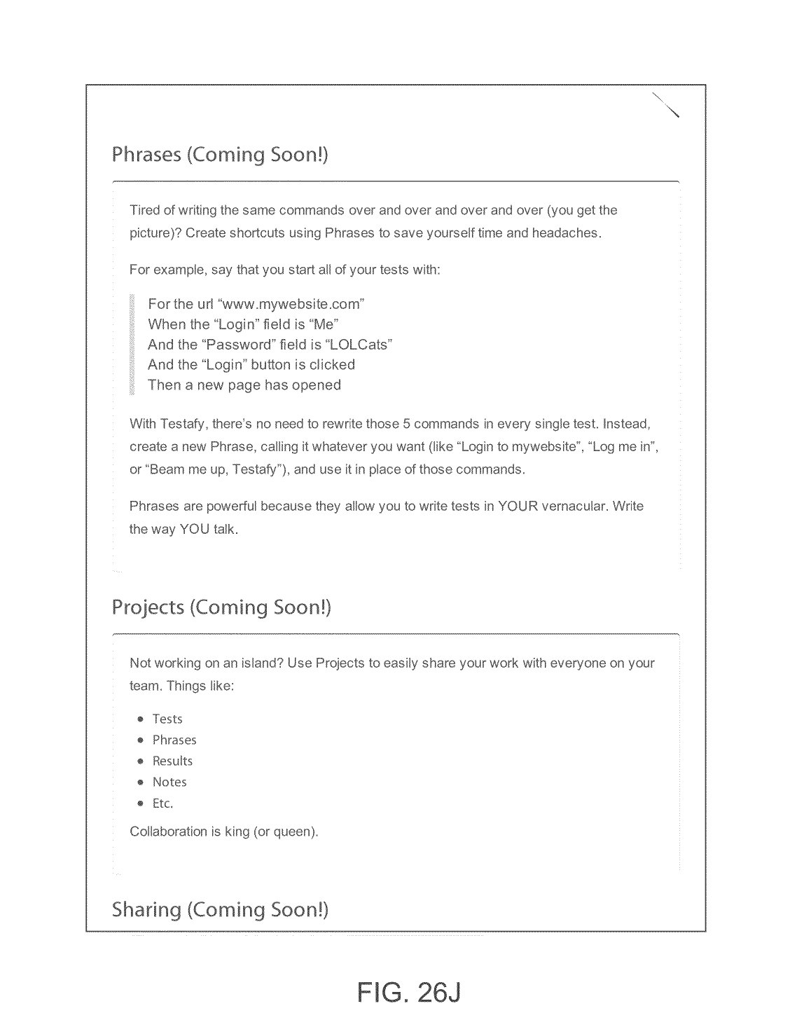

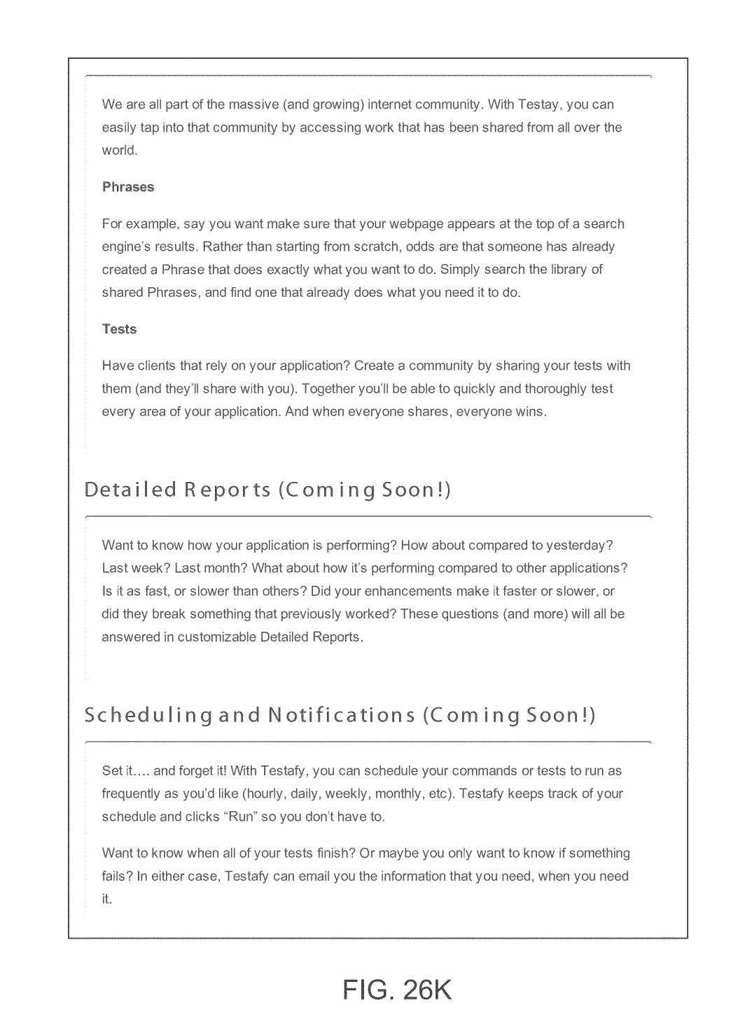

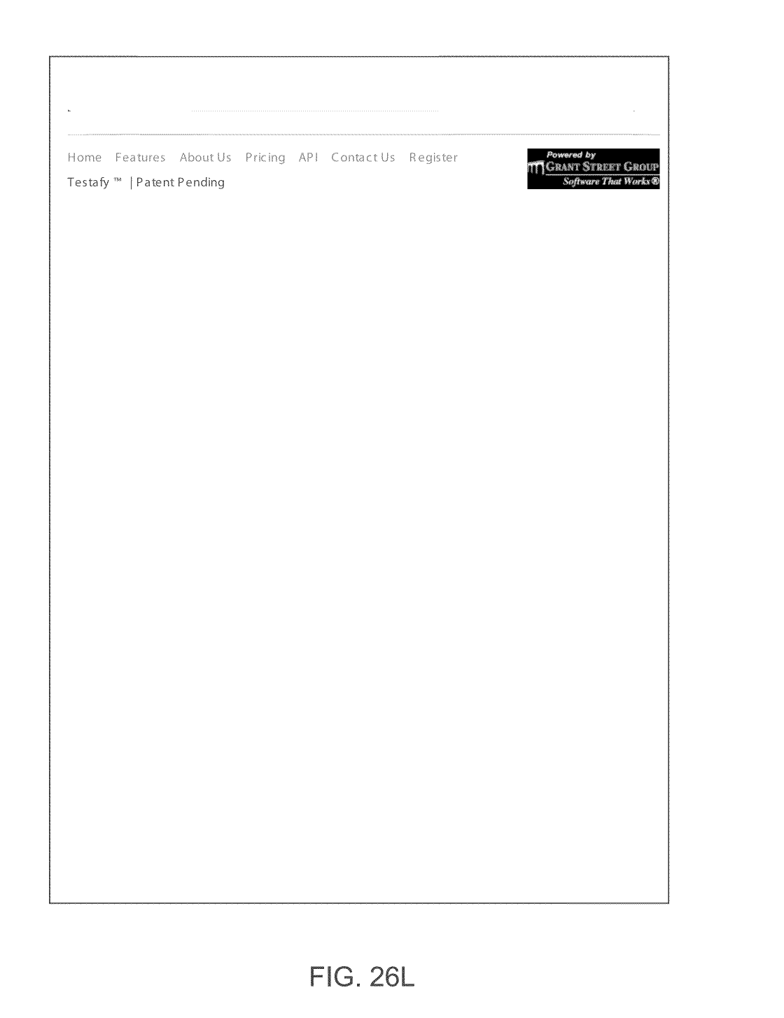

FIG. 27C is an example screenshot of the same test being added to the runner (on the right side of the page, in the “Queue” section). (Compare FIG. 26D).

FIG. 27D is an example screenshot of some example non-limiting options when running a test, permitting a user to choose to set a time delay for each step in the test, and save screenshots (both of which are selected in the screenshot).

FIG. 27E is an example screenshot of the test in progress (the bar indicates how far along the test is).

FIG. 27F is an example screenshot showing that the test has finished with a pass rating of 100% (everything worked as expected).

FIG. 27G is an example screenshot of the results of the test. Next to each step in the process is a link (step-00x). If you click the link, it opens a screenshot that was taken during that step in the process.

FIG. 27H is an example screenshot of the Google search engine website. Notice the top of the image lists what step in the test generated the image (in this case “Step 0001”).

FIG. 271 is an example additional screenshot taken at Step 0003 in the test, and FIG. 27J is an example additional screenshot taken at Step 0007 in the test.

Example Non-Limiting Data Structures

Example Phrase & Noun object data structure:

### Type (For, Given, When, Then, If, Noun) Text

### Pattern

### Argument Names Code Method Source File

Accept clauses Reject clauses Weight
A phrase book or dictionary is a collection of phrase and noun objects, keyed by source file, type and text.

Example Step object data structure:

### Phase (For, Given, When, Then, If, Noun) Compound

### Code Method Description Arguments Matching Rule

Example Noun object data structure:

Type (link, image, drop-drop, etc.) Description

### Arguments

### Code Method

### Example

### Commands for a Web Based Application

Below is a listing of illustrative commands for a web based application, organized by object.

Buttons:

If/Else if/Else:

the $button button is present

the $button button is not present

the $button button is hidden

the $button button is not hidden

the $field row contains a $button button

the $field row does not contain a $button button

### When:

the $button button is clicked

the $button button is remembered as $variable_name (i.e Remember

### “Search”

button as [Search Button])

### Then:

the $button button is present

the $button button is not present

the $button button is hidden

the $button button is not hidden

the $field row contains a $button button

the $field row does not contain a $button button

Checkboxes:

If/Else if/Else:

the $checkbox checkbox is present

the $checkbox checkbox is not present

the $checkbox checkbox is hidden

the $checkbox checkbox is not hidden

the $checkbox checkbox is checked

the $checkbox checkbox is not checked

the $field field contains the $checkbox checkbox

the $field field does not contain the $checkbox checkbox

### When:

the $checkbox checkbox is clicked

the $checkbox checkbox is remembered as $variable_name

### Then:

the $checkbox checkbox is present

the $checkbox checkbox is not present

the $checkbox checkbox is hidden

the $checkbox checkbox is not hidden

the $checkbox checkbox is checked

the $checkbox checkbox is not checked

the $field field contains the $checkbox checkbox

the $field field does not contain the $checkbox checkbox

Data (static text):

If/Else if/Else:

the $field field is $text

the $field field is not $text

the $field field is present

the $field field is not present

### When:

the $field text field is remembered as ‘$variable_name’ (has to be text)

### Then:

the $field field is $text

the $field field is not $text

the $field field is ‘$variable_name’

the $field field is not ‘$variable_name’

the $field field is present

the $field field is not present

Drop-Down Menus:

If/Else if/Else:

the $name drop-down menu is present

the $name drop-down menu is not present

$option is selected in the $name drop-down menu

$option is not selected in the $name drop-down menu

the $field field contains the $name drop-down menu

the $field field does not contain the $name drop-down menu

### When:

the $name drop-down menu is set to $option

the selected option in the $name drop-down menu is remembered as

$variable_name

the number of options in $name drop-down menu is remembered as

$variable_name

### Then:

the $name drop-down menu is present

the $name drop-down menu is not present

$option is selected in the $name drop-down menu

$option is not selected in the $name drop-down menu

the $field field contains the $name drop-down menu

the $field field does not contain the $name drop-down menu

Images:

If/Else if/Else:

the $image image is present

the $image image is not present

the $image image is hidden

the $image image is not hidden

the $image image is a link
that the $image image is not a link

the $image image is a link to $url

### When:

the $image image is clicked

the $image image is remembered as $variable_name

### Then:

the $image image is present

the $image image is not present

the $image image is hidden

the $image image is not hidden

the $image image is a link

the $image image is not a link

the $image image is a link to $url

Links:

If/Else if/Else:

the $element link is present

the $element link is not present

the $element link is hidden

the $element link is not hidden

the $field field contains the $element link

the $field field does not contain the $element link

the $element link has $text (multiple strings separated by “or” or “and”)

the $element link does not have $text (multiple strings separated by comma or “or” or “and”)

### When:

the $element link is clicked

the $text link is clicked

the $element link is remembered as $variable_name

the $text link is remembered as $variable_name

### Then:

the $element link is present

the $element link is not present

the $element link is hidden

the $element link is not hidden

the $field field contains a $element link

the $field field does not contain the $element link

the $element link has $text (multiple strings separated by “or” or “and”)

the $element link does not have $text (multiple strings separated by comma or “or” or “and”)

Multi-select Fields:

If/Else if/Then:

the $name multi-select field is present

the $name multi-select field is not present

the $name multi-select field has $option1, $option2, $option3 . . . selected (multiple strings separated by “or” or “and”)

the $name multi-select field does not have $option1, $option2, $option3 . . . selected (multiple strings separated by “or” or “and”)

the $name multi-select field has the following options: $option1, $option2, $option3 . . . (multiple strings separated by “or” or “and”)

the $name multi-select field does not have the following options: $option1, $option2, $option3 . . . (multiple strings separated by “or” or “and”)

the $field field contains the $name multi-select field

the $field field does not contain the $name multi-select field When:

$option1, $option2, $option3 . . . is/are selected from the $name multi-select field (multiple strings separated by “or” or “and”)

the existing selections are kept, but $option1, $option2, $option3 . . . is/are unselected from the $name multi-select field (multiple strings separated by “or” or “and”)

the $name multi-select field has no options selected

the number of available fields for the $name multi-select field is remembered as $variable_name

### Then:

the $name multi-select field is present

the $name multi-select field is not present

the $name multi-select field has $option1, $option2, $option3 . . . selected (multiple strings separated by “or” or “and”)

the $name multi-select field does not have $option1, $option2, $option3 . . . selected (multiple strings separated by “or” or “and”)

the $name multi-select field has the following options: $option1, $option2, $option3 . . . (multiple strings separated by “or” or “and”)

the $name multi-select field does not have the following options: $option1, $option2, $option3 . . . (multiple strings separated by “or” or “and”)

the $field field contains the $name multi-select field

the $field field does not contain the $name multi-select field

Pages:

If/Else if/Else:

a new page has opened

the page title has $title

the page title does not have $title

the page title is $title

the page title is not $title

### When:

the $page page is opened (URL)

the current page is remembered as $page (URL)

### Then:

a new page opens

the page title has $title

the page title does not have $title

the page title is $title

the page title is not $title

Radio Buttons:

If/Else if/Else:

the $radio radio is present

the $radio radio is not present

the $radio radio is hidden

the $radio radio is not hidden

the $radio radio is checked

the $radio radio is not checked

the $field field contains the $radio radio

the $field field does not contain the $radio radio

### When:

the $radio radio is clicked

the $radio radio in the $field field is clicked

the $radio radio is remembered as $variable_name

### Then:

the $radio radio is present

the $radio radio is not present

the $radio radio is hidden

the $radio radio is not hidden

the $radio radio is checked

the $radio radio is not checked

the $field contains the $radio radio

the $field field does not contain the $radio radio

Text Areas:

If/Else if/Else:

the $name text area field is present

the $name text area field is not present

the $name text area is hidden

the $name text area is not hidden

the $name text area is empty

the $name text area is not empty

the text in the $name text area is $text

the text in the $name text area is not $text

the text in the $name text area contains $text

the text in the $name text area does not contain $text

the $field field contains the $name text area

the $field field does not contain the $name text area

the $name text area field is $number rows tall

the $name text area field is $number characters wide

### When:

the $name text area is remembered as “$variable_name”

the text in the $name text area is remembered as $variable_name

the $name text area is cleared

$text is typed in the $name text area (if there is anything in there, clear textbox first)

### Then:

the $name text area field is present

the $name text area field is not present

the $name text area is hidden

the $name text area is not hidden

the $name text area is empty

the $name text area is not empty

the text in the $name text area is $text

the text in the $name text area is not $text

the text in the $name text area contains $text

the text in the $name text area does not contain $text

the $field field contains the $name text area

the $field field does not contain the $name text area

the $name text area field is $number rows tall

the $name text area field is $number characters wide

Textboxes:

If/Else if/Else:

the $textbox textbox is present

the $textbox textbox is not present

the $textbox textbox is hidden

the $textbox textbox is not hidden

the $textbox textbox is empty

the $textbox textbox is not empty

the text in the $textbox textbox is $text

the text in the $textbox textbox is not $text

the text in the $textbox textbox contains $text

the text in the $textbox textbox does not contain $text

the $field field contains the $textbox textbox

the $field field does not contain the $textbox textbox

### When:

the $textbox textbox is remembered as $variable_name

the text in the $textbox textbox is remembered as $variable_name

the $textbox textbox is cleared

$text is typed in the $textbox textbox (if there is anything in there, clear textbox first)

### Then:

the $textbox textbox is present

the $textbox textbox is not present

the $textbox textbox is hidden

the $textbox textbox is not hidden

the $textbox textbox is empty

the $textbox textbox is not empty

the text in the $textbox textbox is $text

the text in the $textbox textbox is not $text

the text in the $textbox textbox contains $text

the text in the $textbox textbox does not contain $text

the $field field contains the $textbox textbox

the $field field does not contain the $textbox textbox

Text Confirmation:

If/Else if/Else:

the text $text is present

the text $text is not present

### When: None

### Then:

the text $text is present

the text $text is not present

Example Non-Limiting User Interface Example

FIGS. 26A-27L show a non-limiting example automation user interface including login (FIG. 26A), automation generation (FIG. 26B-26C), listing of existing automations and an associated scheduling queue (FIG. 26D-26E), a monitoring page (FIG. 26F), a results and reports page (FIG. 26G), a logout page (FIG. 26H), Informational pages (FIGS. 26I-26L),

FIG. 28A-28T show an additional example non-limiting set of screenshots. The first screenshot of FIG. 28A shows an example “dashboard” indicating what tests or other automations are available and whether any automations are scheduled or pending. This provides a simple intuitive way to navigate across the example non-limiting application. To create a plain English or other vernacular automation, the user can select the “test” (or automation) section (FIG. 28B). Tests or automations that have previously been created may be indicated here. Clicking on one of these previously-created items reveals its contents—in this case (FIG. 28C) a plain English script or program comprising a sequence of instructions (see FIG. 28E). For example, the first instruction can specify a URL in the form of a Command “For the URL grantstreet.com”. Running this automation will cause system 100 to go to the specified website by accessing the same or different machine the application is running on (e.g., a remote server such as an Amazon server in the cloud), open a web browser, use the web browser to access the specified website or other device at the specified URL, and begin performing the actions specified in the vernacular script or program. For example, if the next instruction says “when the innovation link is clicked”, then a new page loads and the text “Testafy” is present, then take a screen shot. These operations (access the specified page, click on the “innovation” link, wait for a new page to load, test whether “Testafy” is present on the newly loaded page, and then take a screen show of the newly loaded page) will all be performed automatically in one example non-limiting implementation based on the plain English vernacular statements. The system may then report degree of completion of the automation and may also report the results of the automation operation (e.g., whether each step has performed successfully, and if a screenshot is requested, capture a screenshot to prove and document that the overall operation was a success) (see FIG. 28D).

FIG. 28F shows an example revision history for a test or automation. FIG. 28G shows a playlist of different automations that can be selected for execution. FIG. 28H shows selecting (by checking) various tests for running. FIG. 28I shows an example screen enabling the user to select what type of notification he or she desires when the test or automation completes. FIG. 28J shows an ability to schedule automations to run automatically at desires times or intervals. FIG. 28K shows an ability to modify such a schedule. FIG. 28S shows example user permissioning.

To build or modify such an automation (see FIG. 28C), the user has several options. If the user is familiar enough with the application to be automated, the user could simply write the commands in a plain English vernacular language such as PBehave comprising PBehave Commands. More often, the user can actually go to the website or webpage being automated and then exercise the web-based application by recording a test using a downloaded browser extension (a piece of Javascript software the user can download and store in the user's local machine browser for execution within the browser—see FIG. 28T). This browser extension can interact with computer 102 API 122 over the network 104. Clicking an icon in the user's browser may cause a test area to appear. It is possible for the user to directly type and compose a script in PBehave commands. If the user is very familiar with the application being automated, the user can compose a set of PBehave commands that adequately exercises the application or operates it in a desired automatic manner.

It is also possible to record the user's actions (“record” button in FIG. 28T) on the page as the user exercises the page. In one example non-limiting implementation, xpath literals from the web page or application can be translated into link names to make the Commands more easily readable. Each operation the user manually performs while in the “record” mode is converted into a plain English vernacular commands that is added to a test or other automation that is then runnable or repeatable. The resulting automation command file is shareable among a group of authorized user any of whom can run the test or automation.

The user can also activate an “inspect” link (see FIG. 28T). This causes the system to place a border or other indication over items the user is pointing to or hovering over with a cursor or pointing device. If the user then clicks to activate the item hovered over, a menu of options is automatically displayed. This example menu of operations provides a set of Commands that can be used to interact with the indicated element. For example, when the user clicks on a “Testafy” link, the system 100 can automatically generate a Command “When the Testafy link is clicked” or “When the Testafy link is present” or “If the Testafy link is present”. The user can then select a desired one of these options and this Command is added to the automation script. This allows the user to work her way through the web-based application by simply navigating to pages and then inspecting different elements.

To fill out forms for example, it is possible for the user to navigate to a field, manually input information and thereby control the browser extension to automatically update the test to include this operation. The plain meaning script Command that resulted could be “when ‘Harrington’ is typed into the ‘search’ text box and a click is entered, then a new page loads. A further inspect could be used to add to the automation an additional test to determine whether “harrington” appears on the newly loaded page. Such automation features removes the need for the user to be familiar with the PBehave language since they can create their test simply by navigating and clicking through their application and inspecting additional elements that are on the page. Inspection can be activated with or without recording—and the automation being generated takes actions the user selects from a dropdown menu.

In one non-limiting example implementation, when invoking the inspect operation to click on an element, the browser extension identifies the element on the page based on what kind of element it is and what the text is; sends a request to API 122 which then processes that element to identify it and then sends back a set of possible Commands that are relevant to that element for display by the browser extension and selection by the user. That commands that are returned can be tailored to the type of element (e.g., form element, etc.) to allow interaction with that element type or that particular element. Such commands could be to click or select the element, check to see if the element is present, compare the element to something else, calculate based on the element, or any other operation. For example, if the element is an input field, different phrases could be returned. If the element is a check box, the possible commands could be simpler (check or not check or determine whether the check box is present).

It is possible to rank Commands based on popularity or how much people are using them. It is also possible for the user to cause the browser extension to display a list of all possible commands so the user is not limited in this selection mode to a particular subset of commands in the Library (although it is always possible for the user to type in any desired Command or set of commands).

The user can also click on a “show more info” function that gives more details on the element and a fuller list of commands the user can select.

A “span parent” function can be used to zoom in or out of a logical view of a tree-based page structure to encompass more elements in a hierarchical arrangement of element in the tree.

While it is not necessary in this case for the user to write in PBehave, the resulting PBehave test script because it is in plain vernacular English is nevertheless understandable by a lay user and is therefore much more helpful than an incomprehensible set of instructions written in a totally unfamiliar artificial language such as PERL. Because it is plain English and is readable by a layman, it is possible to record a process using the tool as described above and then share the resulting commands to someone else—who can then readily understand them because the commands are written in plain English. Such expressions could be used in other contexts such as to prepare user documentation as one example.

It is also possible to take a hybrid approach of recording some operations, generate other Commands by inspection, and composing other Commands directly.

Once the test or automation code sequence is created, the user can then run it or schedule it to run at a particular time (FIGS. 28H-28K). The above-described system 100 is able to run tests and other automations in addition to allowing the user to compose such tests or automations. The user can simply click “run” and the system 100 will automatically run the automation. It is possible to add delays between steps that will cause the system 100 to wait a delay time between steps. The user can also program notifications that will cause system 100 to inform the user (e.g., by email or SMS) that the automation has run, it is failed, or other status information concerning the automation. A “run in progress” page is used to display automations in progress with step by step indications and/or progress bars. The user has the ability to halt automations in progress by clicking or otherwise selecting a control. Clicking on any of the automations can cause the system to display the PBehave plain English vernacular Commands in that particular automation. A logging feature is used to retain status and automation results (see FIG. 28N). Sharing functions are provided to post or publish automation results on the web for access by anyone without the need to access or control the underlying automation processes.

As used herein, “non-transitory” excludes only a transitory, propagating signal per se. Furthermore, the term “non-transitory storage medium” means any kind of non-transitory storage technology including but not limited to semiconductor memory of any form (including but not limited to read only memory, programmable read only memory, electrically erasable programmable read only memory, programmable gate arrays, random access memory, magnetic memory, bubble memory, etc., whether volatile or non-volatile); optical memory including but not limited to optical disks whether writable and/or erasable; magnetic storage; display storage; and storage of any kind of information on any kind of writable, erasable and/or readable carrier, device or medium of any form whatsoever.

While the technology herein has been described in connection with what is presently considered to be the most practical non-limiting embodiments and implementations, the invention is not to be limited to the disclosed embodiments, but on the contrary, is intended to cover various modifications and equivalent arrangements included within the spirit and scope of the claims.

We claim:

1. A computer-mediated method for automating software user activity comprising:
a. receiving an instruction having at least one predefined vernacular command that is derived from a popular human language;
b. using at least one computer processor, translating the predefined vernacular command into at least one corresponding programming command for controlling software;
c. using at least one processor, executing the at least one programming command; and
d. receiving results associated with the executed programming command.

2. The method of claim 1 wherein the predefined vernacular command is a sentence fragment.

3. The method of claim 1 wherein the human language has grammar or syntax.

4. The method of claim 1 wherein the translating is done via parsing.

5. The method of claim 1 wherein corresponding programming command performs the step of manipulating data in step b.

6. The method of claim 1 wherein the corresponding programming command performs the step of “reading” in step b.

7. The method of claim 1 wherein the software in step b is application software.

8. The method of claim 1 wherein the results are output.

9. The method of claim 1 wherein the programming command comprises a computer programming language command.

10. The method of claim 1 wherein the programming command conforms to a predetermined library.

11. The method of claim 10 wherein the library comprises phrases comprising multiple programming commands.

12. The method of claim 1 wherein the programming command is executed in a predetermined sequence.

13. The method of claim 1 further including accepting user input in the form of plain English commands and translating the plain English commands into the programming command.

14. The method of claim 1 further including processing the programming command to simulate the software user activity of another site.

15. The method of claim 1 further including automating software user activity using the programming command.

16. The method of claim 1 wherein the programming command comprises text.

17. The method of claim 1 wherein executing is performed on web and mobile applications.

18. The method of claim 1 wherein the programming command interacts with elements that perform web automation and sends instructions to software interacting with a web browser.

19. The method of claim 1 wherein the programming command performs operations based on recalled values.

20. The method of claim 1 wherein the programming command confirms elements on a page but does not activate a button.

21. The method of claim 1 wherein the programming command comprises stored or transmitted modifiable sequence instructions that permits modification and excerpting.

22. The method of claim 1 further including sharing results by posting to a publicly-accessible network location.

23. A computer-mediated system for automating software user activity comprising at least one processor configured to:
a. receive an instruction having at least one predefined vernacular command that is derived from a popular human language;
b. translate the predefined vernacular command into at least one corresponding programming command for controlling software;
c. execute the at least one programming command; and
d. receive results associated with the executed programming command.

24. The system of claim 23 wherein the predefined vernacular command is a sentence fragment.

25. The system of claim 23 wherein the human language has grammar or syntax.

26. The system of claim 23 wherein the processor translates via parsing.

27. The system of claim 23 wherein the corresponding programming command manipulates data.

28. The system of claim 23 wherein the corresponding programming command receives the instructions.

29. The system of claim 23 wherein the software comprises application software.

30. The system of claim 23 wherein the processor outputs results.

31. The system of claim 23 wherein the programming command comprises a computer programming language command.

32. The system of claim 23 wherein the programming command conforms to a predetermined library.

33. The system of claim 32 wherein the library comprises phrases comprising multiple programming commands.

34. The system of claim 23 wherein the programming command is executed in a predetermined sequence.

35. The system of claim 23 wherein the processor is further configured to accept user input in the form of plain language commands and translate the plain language commands into the programming command.

36. The system of claim 23 wherein the processor processes the programming command to simulate the software user activity of another site.

37. The system of claim 23 wherein the processor automates software user activity using the programming command.

38. The system of claim 23 wherein the programming command comprises text.

39. The system of claim 23 wherein the processor executes on web and mobile applications.

40. The system of claim 23 wherein the programming command interacts with elements that perform web automation and sends instructions to software interacting with a web browser.

41. The system of claim 23 wherein the programming command performs operations based on recalled values.

42. The system of claim 23 wherein the programming command confirms elements on a page but does not activate a button.

43. The system of claim 23 wherein the programming command comprises stored or transmitted modifiable sequence instructions that permits modification and excerpting.

44. The system of claim 23 wherein the processor shares results by posting to a publicly-accessible network location.
